(19) United States
(12) Patent Application Publication
(10) Pub. No.: US 2022/0329794 A1
(43) Pub. Date: Oct. 13, 2022

(54) Cross-Component Adaptive Loop Filtering for Video Coding

(71) Applicant: Huawei Technologies Co., Ltd., Shenzhen (CN)

(72) Inventors: Anand Meher Kotra, Munich (DE); Semih Esenlik, Munich (DE); Elena Alexandrovna Alshina, Munich (DE); Han Gao, Munich (DE); Biao Wang, Munich (DE)

(21) Appl. No.: 17/847,556

(22) Filed: Jun. 23, 2022

Related U.S. Application Data
(63) Continuation of application No. PCT/CN2020/138735, filed on Dec. 23, 2020.
(60) Provisional application No. 62/960,147, filed on Jan. 13, 2020.

(30) Foreign Application Priority Data
Dec. 23, 2019 (EP) PCT/EP2019/086984

(51) Int. Cl. H04N 19/117; H04N 19/70; H04N 19/186; H04N 19/174

(52) U.S. Cl. CPC H04N 19/117; H04N 19/70; H04N 19/186; H04N 19/174

(57) ABSTRACT

A method in an image encoding and/or an image decoding, in which picture header entries for a cross-component adaptive loop filter (CC-ALF) are introduced which defines the common CC-ALF data and all the slices inherit this common information. The signaling overhead, in particular, the overhead of the slice header (in terms of number of bits) is reduced.

### CROSS-REFERENCE TO RELATED APPLICATIONS

This application is a continuation of International Patent Application No. PCT/CN2020/138735 filed on Dec. 23, 2020, which claims priority to International Patent Application No. PCT/EP2019/086984 filed on Dec. 23, 2019 and U.S. Provisional Patent Application No. 62/960,147 filed on Jan. 13, 2020. All of the aforementioned patent applications are hereby incorporated by reference in their entireties.

### TECHNICAL FIELD

Embodiments of the present disclosure generally relate to the field of picture processing and in particularly to a cross-component adaptive loop filter (CC-ALF) as an in loop filter or as a post loop filter and high level syntax for CC-ALF.

### BACKGROUND

Image coding (encoding and decoding) is used in a wide range of digital image applications, for example broadcast digital television (TV), video transmission over internet and mobile networks, real-time conversational applications such as video chat, video conferencing, DIGITAL VERSATILE DISC (DVD) and BLU-RAY discs, video content acquisition and editing systems, and camcorders of security applications.

Since the development of the block-based hybrid video coding approach in the H.261 standard in 1990, new video coding techniques and tools were developed and formed the basis for new video coding standards. One of the goals of most of the video coding standards was to achieve a bitrate reduction compared to its predecessor without sacrificing picture quality. Further video coding standards comprise Moving Picture Experts Group (MPEG)-1 video, MPEG-2 video, International Telecommunication Union (ITU) Telecommunication Standardization Sector (ITU-T) H.262/MPEG-2, ITU-T H.263, ITU-T H.264/MPEG-4, Part 10, Advanced Video Coding (AVC), ITU-T H.265, High Efficiency Video Coding (HEVC), ITU-T H.266/Versatile Video Coding (VVC) and extensions, e.g. scalability and/or three-dimensional (3D) extensions, of these standards.

Block-based image coding schemes have in common that along the block edges, edge artifacts can appear. These artifacts are due to the independent coding of the coding blocks. These edge artifacts are often readily visible to a user. A goal in block-based image coding is to reduce edge artifacts below a visibility threshold. This is done by performing loop filtering, such as deblocking filter, sample adaptive offset (SAO), and ALF. The order of the filtering process is the deblocking filter, then SAO, and then ALF. Furthermore, CC-ALF is further used.

Especially for CC-ALF, luma sample values are used to refine each chroma component. Process needs to be done both in Cb and Cr components, the cross-component adaptive loop filtering can be computationally complex and therefore might add additional pipelining latency especially for hardware implementations.

### SUMMARY

In view of the above-mentioned challenges, the present disclosure aims to improve the cross-component adaptive loop filtering and the syntax elements for CC-ALF. The present disclosure may, among others, pertain to the objective to provide an apparatus, an encoder, a decoder and corresponding methods that can perform cross-component adaptive loop filtering with reduced signaling overhead, particularly, the overhead of the slice header (in terms of number of bits) may be reduced, thus the filtering may be more efficient.

Examples of the present disclosure provide apparatuses and methods for encoding and decoding an image which can improve the coding performance, thereby improving the coding efficiency of a video signal. The disclosure is elaborated in the examples and claims contained in this file.

Embodiments of the present application provide apparatuses and methods for encoding and decoding according to the independent claims, thus the complexity of CC-ALF can be reduced, and the performance of the CC-ALF as an in-loop filter or as a post-loop filter, respectively can be improved.

The foregoing and other objects may be achieved by the subject matter of the independent claims. Further implementation forms are apparent from the dependent claims, the description and the figures.

Particular embodiments are outlined in the attached independent claims, with other embodiments in the dependent claims.

According to a first aspect, the disclosure relates to a method of encoding implemented by an encoding device, comprising performing a filtering process (such as a cross-component filtering process) by applying a CC-ALF, generating a bitstream including a plurality of CC-ALF related syntax elements (such as M CC-ALF related syntax elements and M>=1 and M is an integer), wherein the plurality of CC-ALF related syntax elements indicate the CC-ALF related information, wherein the plurality of CC-ALF related syntax elements is signaled at any one or more of a video parameter set (VPS) level, a sequence parameter set (SPS) level, a picture parameter set (PPS) level, a picture header, a slice header or a tile header, or wherein the plurality of CC-ALF related syntax elements is signaled at an SPS level and/or a picture header.

This bitstream may be reduced in size while providing relevant information in the structure of the bitstream for those levels where this disclosure is actually applied or to which it pertains, and it allows to perform cross-component adaptive loop filtering with reduced signaling overhead, thus the filtering may be more efficient, and the coding efficiency improvement is achieved.

According to a second aspect, the disclosure relates to a method of decoding implemented by a decoding device, comprising parsing one or more syntax elements from a bitstream of a video signal, wherein the syntax elements indicate CC-ALF related information, wherein the syntax elements are obtained from any one or more of a VPS level, an SPS level, a PPS level, a picture header, a slice header or a tile header of the bitstream, or wherein the syntax elements are obtained from an SPS level and/or a picture header, and performing a filtering process (such as a cross-component filtering process) by applying a CC-ALF based on the syntax elements or based on value of the syntax elements. This method may allow obtaining relevant information from the bitstream during decoding where the bitstream is reduced in size, allowing for improved compression of data, and it allows to perform cross-component adaptive loop filtering with reduced signaling overhead, thus the filtering may be more efficient, and the coding efficiency improvement is achieved.

According to a third aspect the disclosure relates to an apparatus for decoding video data. The apparatus comprises processing circuitry for carrying out the method according to the first aspect of the disclosure.

According to a fourth aspect the disclosure relates to an apparatus for encoding video data. The apparatus comprises processing circuitry for carrying out the method according to the second aspect of the disclosure.

The method according to the first aspect of the present disclosure can be performed by the apparatus according to the third aspect of the disclosure. Further features and implementation forms of the method according to the third aspect of the disclosure correspond to the features and implementation forms of the apparatus according to the first aspect of the disclosure.

The method according to the second aspect of the disclosure can be performed by the apparatus according to the fourth aspect of the disclosure. Further features and implementation forms of the method according to the fourth aspect of the disclosure correspond to the features and implementation forms of the apparatus according to the second aspect of the disclosure.

According to a fifth aspect, the disclosure relates to an apparatus for decoding a video stream includes a processor and a memory. The memory is storing instructions that cause the processor to perform the method according to the first aspect.

According to a sixth aspect, the disclosure relates to an apparatus for encoding a video stream includes a processor and a memory. The memory is storing instructions that cause the processor to perform the method according to the second aspect.

According to a seventh aspect, a computer-readable storage medium having stored thereon instructions that, when executed, cause one or more processors configured to code video data is proposed. The instructions cause the one or more processors to perform a method according to the first or second aspect or any possible embodiment of the first or second aspect.

According to an eighth aspect, the disclosure relates to a computer program comprising program code for performing the method according to the first or second aspect or any possible embodiment of the first or second aspect when executed on a computer.

The present disclosure provides a method of encoding implemented by an encoding device, the method comprising applying a CC-ALF to refine a chroma component, generating a bitstream including a plurality of ALF related syntax elements (CC-ALF related syntax elements), wherein the plurality of CC-ALF related syntax elements indicate ALF related information (CC-ALF related information), wherein the plurality of CC-ALF related syntax elements is signaled at any one or more of an SPS level, a picture header, or a slice header, wherein the plurality of CC-ALF related syntax elements comprises a first syntax element that indicates whether an ALF comprising the CC-ALF is enabled or not at a sequence level and the first syntax element is signaled at the SPS level, and a second syntax element that indicates whether the CC-ALF is enabled or not at a sequence level and the second syntax element is signaled at the SPS level.

While it is generally specified here that a first and second syntax element are signaled at the SPS level, this does not mean that the signaling of at least the second syntax element is unconditional. Rather, this embodiment also encompasses realizations where the second syntax element is signaled, for example, based on a value of the first syntax element and/or depending on a value of another syntax element as will be described further below.

The first syntax element may be called sps_alf_enabled_flag in the following while the second syntax element may be referred to as sps_ccalf_enabled_flag. This is, however, just a naming used herein. The disclosure is not limited to a specific name of the first or second syntax element or any other syntax element referred to herein.

It can be understood that CC-ALF is a special kind of ALF, CC-ALF may depend on whether ALF is enabled or not, therefore the first syntax element, i.e. sps_alf_enabled_flag is also related to CC-ALF, and therefore CC-ALF related syntax elements may be used below. Similarly, the information indicated by the first syntax element, i.e. sps_alf_enabled_flag is also related to CC-ALF, so CC-ALF related information may be used below.

Information that can be used for example for all pictures in a sequence can thereby be signaled efficiently in the SPS level, reducing the size of the bitstream by reducing the amount of redundant information, and it allows to perform cross-component adaptive loop filtering with reduced signaling overhead, thus the filtering may be more efficient, and the coding efficiency improvement is achieved.

In one embodiment, the plurality of CC-ALF related syntax elements comprises a third syntax element when the second syntax element indicates that CC-ALF is enabled, wherein the third syntax element is signaled in the picture header and the third syntax element indicates whether CC-ALF is enabled for a current picture comprising a plurality of slices.

This third syntax element may also be referred to as pic_ccalf_enabled_flag. With this embodiment, relevant CC-ALF information pertaining to a full picture can be signaled while keeping the size of the bitstream small. In an example, Slice 1 . . . Slice N share the same CC-ALF information, therefore the common information can be directly inherited from the picture header instead of each slice header transmitting them redundantly.

In a further embodiment, the plurality of CC-ALF related syntax elements comprises a fourth syntax element when the second syntax element indicates that CC-ALF is enabled, wherein the fourth syntax element is signaled in the picture header and the fourth syntax element indicates whether CC-ALF for a Cb color component is enabled for a current picture of a video sequence associated with the bitstream.

The fourth syntax element may, for example, be denoted with pic_cross_component_alf_cb_enabled_flag. However, this is not mandatory. The fourth syntax element can efficiently signal CC-ALF for a Cb color component while keeping the amount of redundant information, for example in a slice header, small.

It can further be provided that, if the fourth syntax element has a value of 1, it indicates that CC-ALF for the Cb color component is enabled for the current picture and/or if the fourth syntax element has a value of 0, it indicates that CC-ALF for the Cb color component is disabled for the current picture.

In one embodiment, the plurality of CC-ALF related syntax elements comprises a fifth syntax element when the fourth syntax element indicates that CC-ALF for the Cb color component is enabled for the current picture, wherein the fifth syntax element is signaled in the picture header and the fifth syntax element indicates a parameter set that the Cb colour component of all the slices in the current picture refers to. This syntax element may be denoted with pic_cross_component_alf_cb_aps_id. This, however, is just a naming and is not construed to limit the present disclosure. This embodiment may allow for signalling parameter sets that are provided for all slices of a picture already at a picture level, thereby reducing the amount of redundant information.

It can further be provided that the plurality of CC-ALF associated syntax elements comprises a seventh syntax element when the second syntax element indicates that CC-ALF is enabled, wherein the seventh syntax element is signaled in the picture header and the seventh syntax element specifies whether CC-ALF for a Cr colour component is enabled for a current picture of a video sequence associated with the bitstream. This syntax element may, for example, be denoted with pic_cross_component_alf_cr_enabled_flag without this limiting the present disclosure. With this syntax element, CC-ALF enabling for Cr colour components can reliably be signaled.

It may further be provided that, if the seventh syntax element has a value of 1, it indicates that CC-ALF for the Cr color component is enabled for the current picture and/or if the seventh syntax element has a value of 0, it indicates that CC-ALF for the Cr color component is disabled for the current picture.

In one embodiment, the plurality of CC-ALF associated syntax elements comprises an eighth syntax element when the seventh syntax element indicates that CC-ALF for the Cr color component is enabled for the current picture, wherein the eighth syntax element is signaled in the picture header and the eighth syntax element indicates a parameter set that is associated with the Cr colour component of all the slices in the current picture. The eighth syntax element may be denoted with pic_cross_component_alf_cr_aps_id, though this is only but one example. This syntax element can provide information on relevant parameters to be used during the filtering.

It can further be provided that the fourth syntax element, the fifth syntax element, the sixth syntax element, the seventh syntax element, the eighth syntax element and the ninth syntax element are signaled when the third syntax element indicates that CC-ALF is enabled for the current picture of a video sequence associated with the bitstream. If CC-ALF is disabled, these elements may be set to a default value and still signaled in the bitstream. In an alternative, if CC-ALF is disabled, these syntax elements may not be signaled in the bitstream, thereby reducing its size as information that is not used is excluded from the bitstream.

In a further embodiment, the plurality of CC-ALF related syntax element comprises a tenth syntax element when the second syntax element indicates that CC-ALF is enabled, wherein the tenth syntax element is signaled in a slice header and the tenth syntax element indicates whether CC-ALF for a Cb colour component is enabled for a current slice of a current picture of a video sequence associated with the bitstream. This syntax element may, without this being intended to limit the present disclosure, be referred to as slice_cross_component_alf_cb_enabled_flag. Thereby, efficient signaling of whether CC-ALF is to be enabled for Cb colour components may be provided.

It can further be provided that, if the tenth syntax element has a value of 1, it indicates that CC-ALF for the Cb colour component is enabled for the current slice and/or of the tenth syntax element has a value of 0, it indicates that CC-ALF for the Cb colour component is disabled for the current slice.

In a further embodiment, the plurality of CC-ALF related syntax elements comprises an eleventh syntax element when the tenth syntax element indicates that CC-ALF for the Cb color component is enabled for the current slice, wherein the tenth syntax element is signaled in a slice header and the tenth syntax element specifies a parameter set that the Cb color component of the current slice refers to. This syntax element may be denoted with pic_cross_component_alf_cb_aps_id, though this is not intended to limit the present disclosure.

In a further embodiment, the plurality of CC-ALF related syntax element comprises a twelfth syntax element when the second syntax element indicates that CC-ALF is enabled, wherein the twelfth syntax element is signaled in a slice header and the twelfth syntax element indicates whether CC-ALF for a Cr colour component is enabled for a current slice of a current picture of a video sequence associated with the bitstream. The twelfth syntax element may, for example, be denoted with slice_cross_component_alf_cr_enabled_flag.

In a further embodiment, it is provided that, if the twelfth syntax element has a value of 1, it indicates that CC-ALF for the Cr colour component is enabled for the current slice and/or if the twelfth syntax element has a value of 0, it indicates that CC-ALF for the Cr colour component is disabled for the current slice.

It can also be provided that the plurality of CC-ALF related syntax elements comprises a thirteenth syntax element when the twelfth syntax element indicates that CC-ALF for the Cr color component is enabled for the current slice, wherein the thirteenth syntax element is signaled in a slice header and the thirteenth syntax element specifies a parameter set that the Cr color component of the current slice refers to. The thirteenth syntax element may, for example, be denoted with slice_cross_component_alf_cr_aps_id. This can efficiently provide information on the parameter to be used for the filtering associated with the Cr color component.

It may be provided that the second syntax element is signaled if the first syntax element has a first value, or the second syntax element is conditionally signaled at least based on a value of the first syntax element. If ALF is not enabled (which is signaled by the first syntax element), CC-ALF will also not be enabled. By not providing the second syntax element in this case, the size of the bitstream may be reduced further.

In one embodiment, the plurality of CC-ALF related syntax elements comprises a fourteenth syntax element that is signaled in at the SPS level, wherein the fourteenth syntax element indicates the type of the input to the CC-ALF. The fourteenth syntax element may be denoted with ChromaArrayType, though this is not limiting the present disclosure.

Furthermore, the second syntax element is signaled when the first syntax element has a first value and the fourteenth syntax element has a second value. The second value may be any value different from a specific value that would indicate that CC-ALF is not to be enabled.

In a further specific embodiment, the second syntax element is signaled when the first syntax element has a value that is equal to 1 and the fourteenth syntax element has a value that is not equal to 0.

For any of the above embodiments, it can be provided that the CC-ALF operates as part of the adaptive loop filter process and makes use of luma sample values to refine at least one chroma component.

The present disclosure further provides a method of decoding implemented by a decoding device, the method comprising parsing a plurality of CC-ALF, related syntax elements from a bitstream, wherein the plurality of syntax elements, wherein the plurality of CC-ALF related syntax elements is obtained from any one or more of an SPS level, a picture header, or a slice header, wherein the plurality of CC-ALF related syntax elements comprises a first syntax element that indicates whether an ALF comprising the CC-ALF is enabled or not at a sequence level and the first syntax element is signaled at the SPS level, and a second syntax element that indicates whether the CC-ALF is enabled or not at a sequence level and the second syntax element is signaled at the SPS level, performing a CC-ALF process using at least one of the plurality of CC-ALF related syntax elements.

While it is generally specified here that a first and second syntax element are provided at the SPS level, this does not mean that at least the second syntax element is provided in the bitstream in an unconditional way. Rather, this embodiment also encompasses realizations where the second syntax element is part of the bitstream, for example, based on a value of the first syntax element and/or depending on a value of another syntax element as will be described further below.

The first syntax element may be called sps_alf_enabled_flag in the following while the second syntax element may be referred to as sps_ccalf_enabled_flag. This is, however, just a naming used herein. The disclosure is not limited to a specific name of the first or second syntax element or any other syntax element referred to herein.

Information that can be used for example for all pictures in a sequence can thereby be provided for the decoder efficiently in the SPS level, reducing the size of the bitstream by reducing the amount of redundant information, and it allows to perform cross-component adaptive loop filtering with reduced signaling overhead, thus the filtering may be more efficient, and the coding efficiency improvement is achieved.

It can be provided that the plurality of CC-ALF related syntax elements comprises a third syntax element when the second syntax element is obtained as indicating that CC-ALF is enabled, wherein the third syntax element is obtained from the picture header and the third syntax element indicates whether CC-ALF is enabled for a current picture comprising a plurality of slices. This third syntax element may also be referred to as pic_ccalf_enabled_flag. With this embodiment, relevant CC-ALF information pertaining to a full picture can be provided while keeping the size of the bitstream small.

In a further embodiment, the plurality of CC-ALF related syntax elements comprises a fourth syntax element when the second syntax element is obtained as indicating that CC-ALF is enabled, wherein the fourth syntax element is obtained from the picture header and the fourth syntax element indicates whether CC-ALF is enabled for a Cb color component for a current picture of a video sequence. The fourth syntax element may, for example, be denoted with pic_cross_component_alf_cb_enabled_flag. However, this is not mandatory. The fourth syntax element can efficiently cause the decoder to enable CC-ALF for a Cb color component while keeping the amount of redundant information, for example in a slice header, small.

In a further embodiment, it may be provided that, if the fourth syntax element has a value of 1, it indicates that the CC-ALF for a Cb color component is enabled for the current picture and/or if the fourth syntax element has a value of 0, it indicates that the CC-ALF for a Cb color component is disabled for the current picture.

Moreover, the plurality of CC-ALF related syntax elements may comprise a fifth syntax element when the fourth syntax element CC-ALF for the Cb color component is enabled for the current picture, wherein the fifth syntax element is obtained from the picture header and the fifth syntax element indicates a parameter set that is associated with the Cb colour component of all the slices in the current picture. This syntax element may be denoted with pic_cross_component_alf_cb_aps_id. This, however, is just a naming and is not construed to limit the present disclosure. This embodiment may allow for providing parameter sets that are provided for all slices of a picture already at a picture level, thereby reducing the amount of redundant information.

In a further embodiment, the plurality of CC-ALF associated syntax elements comprises a seventh syntax element when the when the second syntax element is obtained as indicating that CC-ALF is enabled, wherein the seventh syntax element is obtained from the picture header and the seventh syntax element specifies whether CC-ALF is enabled for a Cr colour component for a current picture of a video sequence associated with the bitstream. This syntax element may, for example, be denoted with pic_cross_component_alf_cr_enabled_flag without this limiting the present disclosure. With this syntax element, CC-ALF the decoder can reliable determine whether CC-ALF is enabled for Cr colour components.

It can be provided that, if the seventh syntax element has a value of 1, it indicates that CC-ALF for the Cr color component is enabled for the current picture and/or if the seventh syntax element has a value of 0, it indicates that CC-ALF for the Cr color component is disabled for the current picture.

In a further embodiment, the plurality of CC-ALF associated syntax elements comprises an eighth syntax element when the seventh syntax element is obtained as indicating that CC-ALF for the Cr color component is enabled for the current picture, wherein the eighth syntax element is obtained from the picture header and the eighth syntax element indicates a parameter set that is associated with the Cr colour component of all the slices in the current picture. The eighth syntax element may be denoted with pic_cross_component_alf_cr_aps_id, though this is only but one example. This syntax element can provide information on relevant parameters to be used during the filtering.

It may further be provided that the fourth syntax element, the fifth syntax element, the sixth syntax element, the seventh syntax element, the eighth syntax element and the ninth syntax element are obtained when the third syntax element is obtained as indicating that CC-ALF is enabled for the current picture of a video sequence associated with the bitstream.

In one embodiment, the plurality of CC-ALF related syntax element comprises a tenth syntax element when the second syntax element is obtained as indicating that CC-ALF is enabled, wherein the tenth syntax element is obtained from a slice header and the tenth syntax element indicates whether CC-ALF for a Cb colour component is enabled for a current slice of a current picture of a video sequence associated with the bitstream. This syntax element may, without this being intended to limit the present disclosure, be referred to as slice_cross_component_alf_cb_enabled_flag. Thereby, the decoder can determine whether CC-ALF is to be enabled for Cb colour components may be provided.

It can further be provided that, if the tenth syntax element has a value of 1, it indicates that CC-ALF for the Cb colour component is enabled for the current slice and/or if the tenth syntax element has a value of 0, it indicates that CC-ALF for the Cb colour component is disabled for the current slice.

In one embodiment, the plurality of CC-ALF related syntax elements comprises an eleventh syntax element when the tenth syntax element is obtained as indicating that CC-ALF for the Cb color component is enabled for the current slice, wherein the tenth syntax element is obtained from the slice header and the tenth syntax element specifies a parameter set that the Cb color component of the current slice refers to. This syntax element may be denoted with pic_cross_component_alf_cb_aps_id, though this is not intended to limit the present disclosure.

It can be provided that the plurality of CC-ALF related syntax element comprises a twelfth syntax element when the second syntax element is obtained as indicating that CC-ALF is enabled, wherein the twelfth syntax element is obtained from the slice header and the twelfth syntax element indicates whether CC-ALF for a Cr colour component is enabled for a current slice of a current picture of a video sequence associated with the bitstream. The twelfth syntax element may, for example, be denoted with slice_cross_component_alf_cr_enabled_flag.

In a more specific embodiment, if the twelfth syntax element has a value of 1, it indicates that CC-ALF for the Cr colour component is enabled for the current slice and/or if the twelfth syntax element has a value of 0, it indicates that CC-ALF for the Cr colour component is disabled for the current slice.

It can further be provided that the plurality of CC-ALF related syntax elements comprises a thirteenth syntax element when the twelfth syntax element is obtained as indicating that CC-ALF for the Cr color component is enabled for the current slice, wherein the thirteenth syntax element is obtained from a slice header and the thirteenth syntax element specifies a parameter set that the Cr color component of the current slice refers to. The thirteenth syntax element may, for example, be denoted with slice_cross_component_alf_cr_aps_id. This can efficiently provide information on the parameter to be used for the filtering associated with the Cr color component.

In one embodiment, the second syntax element is obtained if the first syntax element has a first value, or the second syntax element is obtained at least based on a value of the first syntax element.

It can further be provided that the plurality of CC-ALF related syntax elements comprises a fourteenth syntax element that is obtained from the SPS level, wherein the fourteenth syntax element indicates the type of the input to the CC-ALF. The fourteenth syntax element may be denoted with ChromaArrayType, though this is not limiting the present disclosure.

Furthermore, the second syntax element may be obtained when the first syntax element has a first value and the fourteenth syntax element has a second value. This second value may be any value that is different from a value that indicates that CC-ALF is not to be enabled or that may be used to indicate so.

Furthermore, it can be provided that the second syntax element is obtained when the first syntax element has a value that is equal to 1 and the fourteenth syntax element has a value that is not equal to 0.

For any of the above embodiments, it can further be provided that the CC-ALF operates as part of the adaptive loop filter process and makes use of luma sample values to refine at least one chroma component.

The present disclosure further pertains to a device for encoding video data, comprising a video data memory, and a video encoder, wherein the video encoder is configured to apply a CC-ALF to refine a chroma component, generate a bitstream including a plurality of CC-ALF related syntax elements, wherein the plurality of CC-ALF related syntax elements indicate CC-ALF related information, wherein the plurality of CC-ALF related syntax elements is signaled at any one or more of an SPS level, a picture header, or a slice header, wherein the plurality of CC-ALF related syntax elements comprises a first syntax element that indicates whether an ALF comprising the CC-ALF is enabled or not at a sequence level and the first syntax element is signaled at the SPS level, and a second syntax element that indicates whether the CC-ALF is enabled or not at a sequence level and the second syntax element is signaled at the SPS level. With this, the advantages of the encoding methods referred to above are provided to encoders for encoding, for example, videos.

The present disclosure also pertains to A device for decoding video data, comprising a video data memory, and a video decoder, wherein the video decoder is configured to parse a plurality of CC-ALF, related syntax elements from a bitstream, wherein the plurality of syntax elements, wherein the plurality of CC-ALF related syntax elements is obtained from any one or more of an SPS level, a picture header, or a slice header, wherein the plurality of CC-ALF related syntax elements comprises a first syntax element that indicates whether an ALF comprising the CC-ALF is enabled or not at a sequence level and the first syntax element is signaled at the SPS level, and a second syntax element that indicates whether the CC-ALF is enabled or not at a sequence level and the second syntax element is signaled at the SPS level, and perform a CC-ALF process using at least one of the plurality of CC-ALF related syntax elements.

With this, the advantages of the reduced size of the bitstream are realized while obtaining reliable decoding of a video.

Further, an encoder for encoding a video is provided, the encoder comprising processing circuitry for performing a method according to any of the above embodiments. With this, the advantages of the encoding methods referred to above are provided to encoders for encoding, for example, videos.

Moreover, a decoder for decoding a bitstream is provided, the decoder comprising processing circuitry for perform a method according to any of the above embodiments. With this, the advantages of the reduced size of the bitstream are realized while obtaining reliable decoding of a video.

Further provided within this disclosure is a computer-readable storage medium comprising thereon computer-executable instructions that, when executed by a computing device, cause the computing device to perform a method according to any of the above embodiments.

The present disclosure further provides an encoded bitstream for the video signal by including a plurality of CC-ALF related syntax elements, wherein the plurality of CC-ALF related syntax elements indicate CC-ALF related information, wherein the plurality of CC-ALF related syntax elements are signaled at any one or more of an SPS level, a picture header, or a slice header, wherein the plurality of CC-ALF related syntax elements comprises a first syntax element that indicates whether an ALF comprising the CC-ALF is enabled or not at a sequence level and the first syntax element is signaled at the SPS level, and a second syntax element that indicates whether the CC-ALF is enabled or not at a sequence level and the second syntax element is signaled at the SPS level.

The bitstream may be reduced in size while providing information to be used in decoding when applying CC-ALF in a reliable way.

Details of one or more embodiments are set forth in the accompanying drawings and the description below. Other features, objects, and advantages will be apparent from the description, drawings, and claims.

### BRIEF DESCRIPTION OF THE DRAWINGS

In the following embodiments of the disclosure are described in more detail with reference to the attached figures and drawings.

FIG. 1A is a block diagram showing an example of a video coding system configured to implement embodiments of the disclosure.

FIG. 1B is a block diagram showing another example of a video coding system configured to implement embodiments of the disclosure.

FIG. 2 is a block diagram showing an example of a video encoder configured to implement embodiments of the disclosure.

FIG. 3 is a block diagram showing an example structure of a video decoder configured to implement embodiments of the disclosure.

FIG. 4 is a block diagram illustrating an example of an encoding apparatus or a decoding apparatus.

FIG. 5 is a block diagram illustrating another example of an encoding apparatus or a decoding apparatus.

FIG. 6A, FIG. 6B, and FIG. 6C include placement of the CC-ALF (FIG. 6A) with respect to other loop filters (FIG. 6B and FIG. 6C) Diamond shaped filter.

FIG. 7 is a diagram illustrating all slice headers have to transmit the CC-ALF data.

FIG. 8 is a diagram illustrating an example of improved syntax elements of the CC-ALF.

FIG. 9A is a conceptual diagram illustrating nominal vertical and horizontal relative locations of luma and chroma samples.

FIG. 9B is a schematic diagram illustrating a co-located luma block and a chroma block.

FIG. 10 is a block diagram showing an example structure of a content supply system which realizes a content delivery service.

FIG. 11 is a block diagram showing a structure of an example of a terminal device.

FIG. 12 is a block diagram showing an example of an encoder.

FIG. 13 is a block diagram showing an example of a decoder.

FIG. 14 shows a flow diagram of a method of encoding a video according to one embodiment.

FIG. 15 shows a flow diagram of a method of decoding a video according to one embodiment.

FIG. 16 is a schematic diagram of a data structure, i.e. a video bitstream.

In the following identical reference signs refer to identical or at least functionally equivalent features if not explicitly specified otherwise.

### DETAILED DESCRIPTION OF THE EMBODIMENTS

The following definition is for the reference:

Coding block: An M×N block of samples for some values of M and N such that the division of a CTB into coding blocks is a partitioning.

Coding tree block (CTB): An N×N block of samples for some value of N such that the division of a component into CTBs is a partitioning.

Coding tree unit (CTU): A CTB of luma samples, two corresponding CTBs of chroma samples of a picture that has three sample arrays, or a CTB of samples of a monochrome picture or a picture that is coded using three separate colour planes and syntax structures used to code the samples.

Coding unit (CU): A coding block of luma samples, two corresponding coding blocks of chroma samples of a picture that has three sample arrays, or a coding block of samples of a monochrome picture or a picture that is coded using three separate colour planes and syntax structures used to code the samples.

Component: An array or single sample from one of the three arrays (luma and two chroma) that compose a picture in 4:2:0, 4:2:2, or 4:4:4 colour format or the array or a single sample of the array that compose a picture in monochrome format.

In the following description, reference is made to the accompanying figures, which form part of the disclosure, and which show, by way of illustration, specific aspects of embodiments of the disclosure or specific aspects in which embodiments of the present disclosure may be used. It is understood that embodiments of the disclosure may be used in other aspects and comprise structural or logical changes not depicted in the figures. The following detailed description, therefore, is not to be taken in a limiting sense, and the scope of the present disclosure is defined by the appended claims.

For instance, it is understood that a disclosure in connection with a described method may also hold true for a corresponding device or system configured to perform the method and vice versa. For example, if one or a plurality of specific method steps are described, a corresponding device may include one or a plurality of units, e.g. functional units, to perform the described one or plurality of method steps (e.g. one unit performing the one or plurality of steps, or a plurality of units each performing one or more of the plurality of steps), even if such one or more units are not explicitly described or illustrated in the figures. On the other hand, for example, if a specific apparatus is described based on one or a plurality of units, e.g. functional units, a corresponding method may include one step to perform the functionality of the one or plurality of units (e.g. one step performing the functionality of the one or plurality of units, or a plurality of steps each performing the functionality of one or more of the plurality of units), even if such one or plurality of steps are not explicitly described or illustrated in the figures. Further, it is understood that the features of the various exemplary embodiments and/or aspects described herein may be combined with each other, unless noted otherwise.

Video coding typically refers to the processing of a sequence of pictures, which form the video or video sequence. Instead of the term “picture” the term “frame” or “image” may be used as synonyms in the field of video coding. Video coding (or coding in general) comprises two parts video encoding and video decoding. Video encoding is performed at the source side, typically comprising processing (e.g. by compression) the original video pictures to reduce the amount of data required for representing the video pictures (for more efficient storage and/or transmission). Video decoding is performed at the destination side and typically comprises the inverse processing compared to the encoder to reconstruct the video pictures. Embodiments referring to “coding” of video pictures (or pictures in general) shall be understood to relate to “encoding” or “decoding” of video pictures or respective video sequences. The combination of the encoding part and the decoding part is or CODEC.

In case of lossless video coding, the original video pictures can be reconstructed, i.e. the reconstructed video pictures have the same quality as the original video pictures (assuming no transmission loss or other data loss during storage or transmission). In case of lossy video coding, further compression, e.g. by quantization, is performed, to reduce the amount of data representing the video pictures, which cannot be completely reconstructed at the decoder, i.e. the quality of the reconstructed video pictures is lower or worse compared to the quality of the original video pictures.

Several video coding standards belong to the group of “lossy hybrid video codecs” (i.e. combine spatial and temporal prediction in the sample domain and two-dimensional (2D) transform coding for applying quantization in the transform domain). Each picture of a video sequence is typically partitioned into a set of non-overlapping blocks and the coding is typically performed on a block level. In other words, at the encoder the video is typically processed, i.e. encoded, on a block (video block) level, e.g. by using spatial (intra picture) prediction and/or temporal (inter picture) prediction to generate a prediction block, subtracting the prediction block from the current block (block currently processed/to be processed) to obtain a residual block, transforming the residual block and quantizing the residual block in the transform domain to reduce the amount of data to be transmitted (compression), whereas at the decoder the inverse processing compared to the encoder is applied to the encoded or compressed block to reconstruct the current block for representation. Furthermore, the encoder duplicates the decoder processing loop such that both will generate identical predictions (e.g. intra- and inter predictions) and/or re-constructions for processing, i.e. coding, the subsequent blocks.

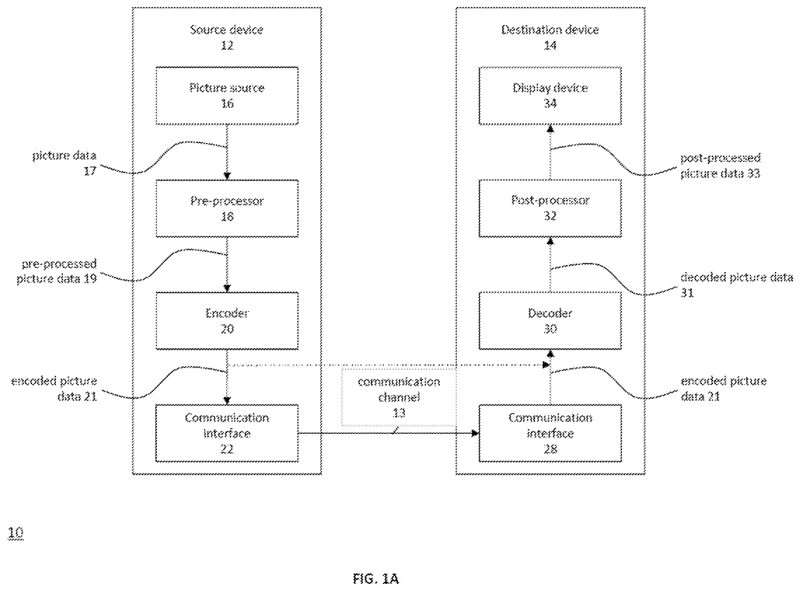

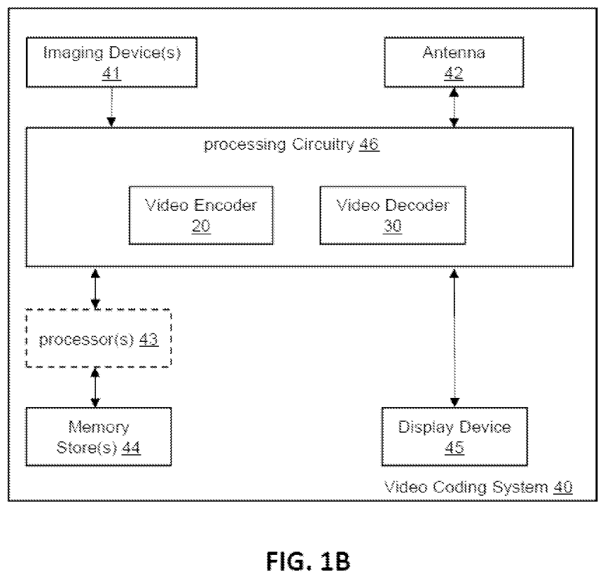

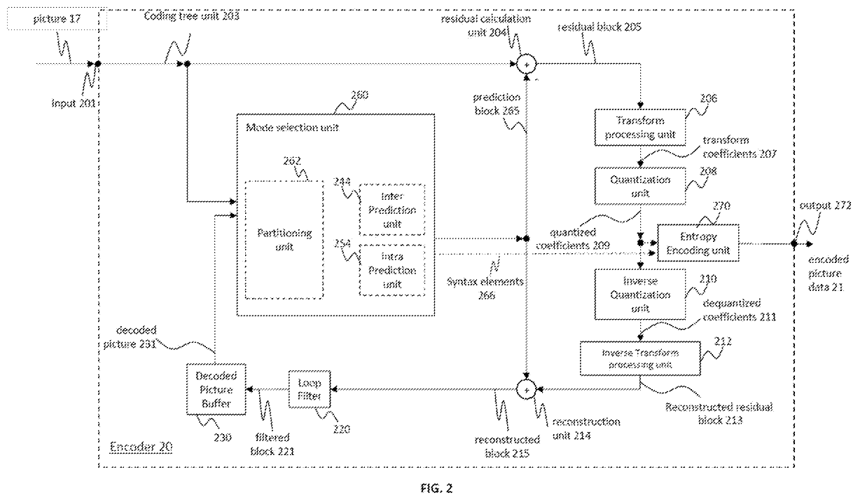

In the following embodiments of a video coding system 10, a video encoder 20 and a video decoder 30 are described based on FIGS. 1A to 3.

FIG. 1A is a schematic block diagram illustrating an example coding system 10, e.g. a video coding system 10 (or coding system 10) that may utilize techniques of this present application. Video encoder 20 (or encoder 20) and video decoder 30 (or decoder 30) of video coding system 10 represent examples of devices that may be configured to perform techniques in accordance with various examples described in the present application.

As shown in FIG. 1A, the coding system 10 comprises a source device 12 configured to provide encoded picture data 21 e.g. to a destination device 14 for decoding the encoded picture data 13.

The source device 12 may comprise an encoder 20, and may additionally, i.e. optionally, comprise a picture source 16, a pre-processor (or pre-processing unit) 18, e.g. a picture pre-processor 18, and a communication interface or communication unit 22.

The picture source 16 may comprise or be any kind of picture capturing device, for example a camera for capturing a real-world picture, and/or any kind of a picture generating device, for example a computer-graphics processor for generating a computer animated picture, or any kind of other device for obtaining and/or providing a real-world picture, a computer generated picture (e.g. a screen content, a virtual reality (VR) picture) and/or any combination thereof (e.g. an augmented reality (AR) picture). The picture source may be any kind of memory or storage storing any of the aforementioned pictures.

In distinction to the pre-processor 18 and the processing performed by the pre-processing unit 18, the picture or picture data 17 may also be referred to as raw picture or raw picture data 17.

Pre-processor 18 may be configured to receive the (raw) picture data 17 and to perform pre-processing on the picture data 17 to obtain a pre-processed picture 19 or pre-processed picture data 19. Pre-processing performed by the pre-processor 18 may, e.g., comprise trimming, color format conversion (e.g. from red, green, and blue (RGB) to luma, blue-difference, and red-difference (YCbCr)), color correction, or de-noising. It can be understood that the pre-processing unit 18 may be optional component.

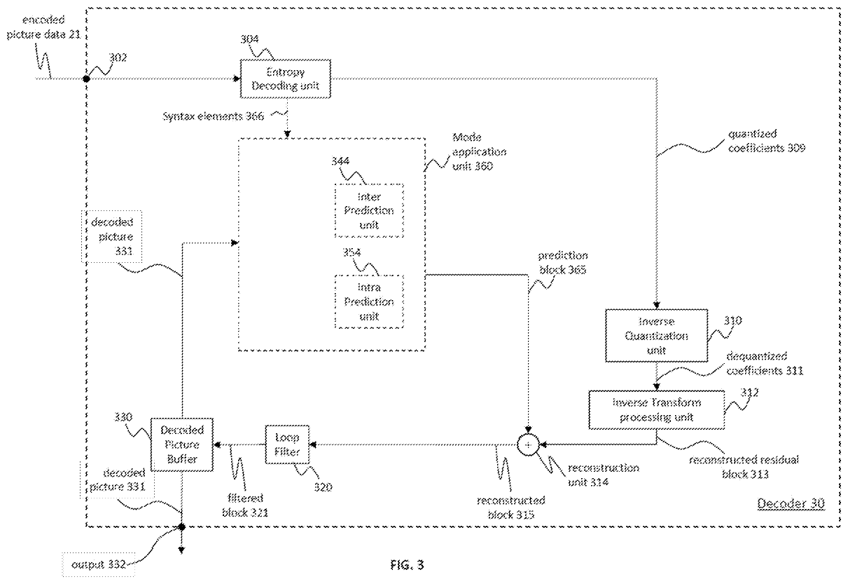

The video encoder 20 may be configured to receive the pre-processed picture data 19 and provide encoded picture data 21 (further details will be described below, e.g., based on FIG. 2).

Communication interface 22 of the source device 12 may be configured to receive the encoded picture data 21 and to transmit the encoded picture data 21 (or any further processed version thereof) over communication channel 13 to another device, e.g. the destination device 14 or any other device, for storage or direct reconstruction.

The destination device 14 may comprise a decoder 30 (e.g. a video decoder 30), and may additionally, i.e. optionally, comprise a communication interface or communication unit 28, a post-processor 32 (or post-processing unit 32) and a display device 34.

The communication interface 28 of the destination device 14 may be configured receive the encoded picture data 21 (or any further processed version thereof), e.g. directly from the source device 12 or from any other source, e.g. a storage device, e.g. an encoded picture data storage device, and provide the encoded picture data 21 to the decoder 30.

The communication interface 22 and the communication interface 28 may be configured to transmit or receive the encoded picture data 21 or encoded data 13 via a direct communication link between the source device 12 and the destination device 14, e.g. a direct wired or wireless connection, or via any kind of network, e.g. a wired or wireless network or any combination thereof, or any kind of private and public network, or any kind of combination thereof.

The communication interface 22 may be, e.g., configured to package the encoded picture data 21 into an appropriate format, e.g. packets, and/or process the encoded picture data using any kind of transmission encoding or processing for transmission over a communication link or communication network.

The communication interface 28, forming the counterpart of the communication interface 22, may be, e.g., configured to receive the transmitted data and process the transmission data using any kind of corresponding transmission decoding or processing and/or de-packaging to obtain the encoded picture data 21.

Both, or at least one of communication interface 22 and communication interface 28 may be configured as unidirectional communication interfaces as indicated by the arrow for the communication channel 13 in FIG. 1A pointing from the source device 12 to the destination device 14, or bi-directional communication interfaces, and may be configured, e.g. to send and receive messages, e.g. to set up a connection, to acknowledge and exchange any other information related to the communication link and/or data transmission, e.g. encoded picture data transmission.

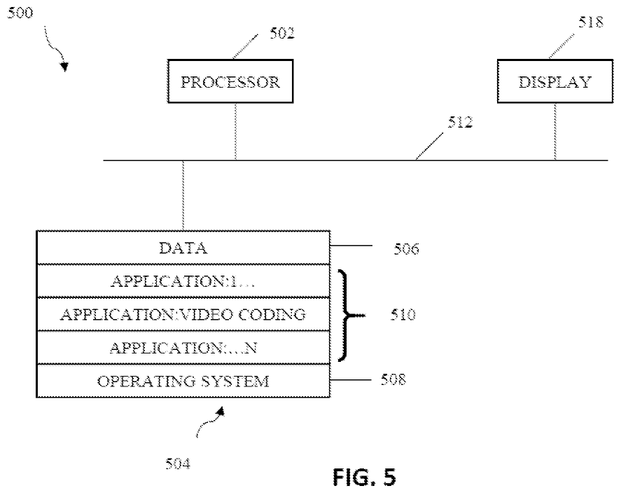

The decoder 30 may be configured to receive the encoded picture data 21 and provide decoded picture data 31 or a decoded picture 31 (further details will be described below, e.g., based on FIG. 3 or FIG. 5).

The post-processor 32 of destination device 14 may be configured to post-process the decoded picture data 31 (also called reconstructed picture data), e.g. the decoded picture 31, to obtain post-processed picture data 33, e.g. a post-processed picture 33. The post-processing performed by the post-processing unit 32 may comprise, e.g. color format conversion (e.g. from YCbCr to RGB), color correction, trimming, or re-sampling, or any other processing, e.g. for preparing the decoded picture data 31 for display, e.g. by display device 34.

The display device 34 of the destination device 14 may be configured to receive the post-processed picture data 33 for displaying the picture, e.g. to a user or viewer. The display device 34 may be or comprise any kind of display for representing the reconstructed picture, e.g. an integrated or external display or monitor. The displays may, e.g. comprise liquid-crystal displays (LCD), organic light-emitting diode (LED) (OLED) displays, plasma displays, projectors, micro LED displays, liquid crystal on silicon (LCoS), digital light processor (DLP) or any kind of other display.

Although FIG. 1A depicts the source device 12 and the destination device 14 as separate devices, embodiments of devices may also comprise both or both functionalities, the source device 12 or corresponding functionality and the destination device 14 or corresponding functionality. In such embodiments the source device 12 or corresponding functionality and the destination device 14 or corresponding functionality may be implemented using the same hardware and/or software or by separate hardware and/or software or any combination thereof.

The source device and/or the destination device may further be implemented using dedicated hardware and/or software. For example, one or both of these devices may be implemented using designed hardware to realize one or more of the above and below referred to functionalities. Alternatively or additionally, one or more of the above and below described functionalities may be implemented using designed software that may be run on general purpose hardware, like processors. Furthermore, combinations of the above are also envisaged, where the source device and/or the destination device may be implemented using a combination of dedicated hardware for realizing one or more functionalities and software to realize one or more other functionalities.

As will be apparent for the skilled person based on the description, the existence and (exact) split of functionalities of the different units or functionalities within the source device 12 and/or destination device 14 as shown in FIG. 1A may vary depending on the actual device and application.

The encoder 20 (e.g. a video encoder 20) or the decoder 30 (e.g. a video decoder 30) or both encoder 20 and decoder 30 may be implemented via processing circuitry as shown in FIG. 1B, such as one or more microprocessors, digital signal processors (DSPs), application-specific integrated circuits (ASICs), field-programmable gate arrays (FPGAs), discrete logic, hardware, video coding dedicated or any combinations thereof. The encoder 20 may be implemented via processing circuitry 46 to embody the various modules as discussed with respect to encoder 20 of FIG. 2 and/or any other encoder system or subsystem described herein. The decoder 30 may be implemented via processing circuitry 46 to embody the various modules as discussed with respect to decoder 30 of FIG. 3 and/or any other decoder system or subsystem described herein. The processing circuitry may be configured to perform the various operations as discussed later. As shown in FIG. 5, if the techniques are implemented partially in software, a device may store instructions for the software in a suitable, non-transitory computer-readable storage medium and may execute the instructions in hardware using one or more processors to perform the techniques of this disclosure. Either of video encoder 20 and video decoder 30 may be integrated as part of a combined encoder/decoder (CODEC) in a single device, for example, as shown in FIG. 1B.

Source device 12 and destination device 14 may comprise any of a wide range of devices, including any kind of handheld or stationary devices, e.g. notebook or laptop computers, mobile phones, smart phones, tablets or tablet computers, cameras, desktop computers, set-top boxes, televisions, display devices, digital media players, video gaming consoles, video streaming devices (such as content services servers or content delivery servers), broadcast receiver device, broadcast transmitter device, or the like and may use no or any kind of operating system. In some cases, the source device 12 and the destination device 14 may be equipped for wireless communication. Thus, the source device 12 and the destination device 14 may be wireless communication devices.

In some cases, video coding system 10 illustrated in FIG. 1A is merely an example and the techniques of the present application may apply to video coding settings (e.g., video encoding or video decoding) that do not necessarily include any data communication between the encoding and decoding devices. In other examples, data is retrieved from a local memory, streamed over a network, or the like. A video encoding device may encode and store data to memory, and/or a video decoding device may retrieve and decode data from memory. In some examples, the encoding and decoding is performed by devices that do not communicate with one another, but simply encode data to memory and/or retrieve and decode data from memory.

For convenience of description, embodiments of the disclosure are described herein, for example, by reference to HEVC or to the reference software of VVC, the next generation video coding standard developed by the Joint Collaboration Team on Video Coding (JCT-VC) of ITU-T Video Coding Experts Group (VCEG) and International Organization for Standardization (ISO)/International Electrotechnical Commission (IEC) MPEG. One of ordinary skill in the art will understand that embodiments of the disclosure are not limited to HEVC or VVC.

Encoder and Encoding Method:

FIG. 2 shows a schematic block diagram of an example video encoder 20 that may be configured to implement the techniques of the present disclosure. In the example of FIG. 2, the video encoder 20 comprises an input 201 (or input interface 201), a residual calculation unit 204, a transform processing unit 206, a quantization unit 208, an inverse quantization unit 210, and inverse transform processing unit 212, a reconstruction unit 214, a loop filter unit 220, a decoded picture buffer (DPB) 230, a mode selection unit 260, an entropy encoding unit 270 and an output 272 (or output interface 272). The mode selection unit 260 may include an inter prediction unit 244, an intra prediction unit 254 and a partitioning unit 262. Inter prediction unit 244 may include a motion estimation unit and a motion compensation unit (not shown). A video encoder 20 as shown in FIG. 2 may also be referred to as hybrid video encoder or a video encoder according to a hybrid video codec.

The residual calculation unit 204, the transform processing unit 206, the quantization unit 208, the mode selection unit 260 may be referred to as forming a forward signal path of the encoder 20, whereas the inverse quantization unit 210, the inverse transform processing unit 212, the reconstruction unit 214, the buffer 216, the loop filter 220, the DPB 230, the inter prediction unit 244 and the intra-prediction unit 254 may be referred to as forming a backward signal path of the video encoder 20, wherein the backward signal path of the video encoder 20 corresponds to the signal path of the decoder (see video decoder 30 in FIG. 3). The inverse quantization unit 210, the inverse transform processing unit 212, the reconstruction unit 214, the loop filter 220, the DPB 230, the inter prediction unit 244 and the intra-prediction unit 254 are also referred to forming the “built-in decoder” of video encoder 20.

Pictures & Picture Partitioning (Pictures & Blocks):

The encoder 20 may be configured to receive, e.g. via input 201, a picture 17 (or picture data 17), e.g. picture of a sequence of pictures forming a video or video sequence. The received picture or picture data may also be a pre-processed picture 19 (or pre-processed picture data 19). For sake of simplicity the following description refers to the picture 17. The picture 17 may also be referred to as current picture or picture to be coded (in particular in video coding to distinguish the current picture from other pictures, e.g. previously encoded and/or decoded pictures of the same video sequence, i.e. the video sequence which also comprises the current picture).

A (digital) picture is or can be regarded as a two-dimensional array or matrix of samples with intensity values. A sample in the array may also be referred to as pixel (short form of picture element) or a pel. The number of samples in horizontal and vertical direction (or axis) of the array or picture define the size and/or resolution of the picture. For representation of color, typically three color components are employed, i.e. the picture may be represented or include three sample arrays. In RBG format or color space a picture comprises a corresponding red, green and blue sample array. However, in video coding each pixel is typically represented in a luminance and chrominance format or color space, e.g. YCbCr, which comprises a luminance component indicated by Y (sometimes also L is used instead) and two chrominance components indicated by Cb and Cr. The luminance (or luma) component Y represents the brightness or grey level intensity (e.g. like in a grey-scale picture), while the two chrominance (or chroma) components Cb and Cr represent the chromaticity or color information components. Accordingly, a picture in YCbCr format comprises a luminance sample array of luminance sample values (Y), and two chrominance sample arrays of chrominance values (Cb and Cr). Pictures in RGB format may be converted or transformed into YCbCr format and vice versa, the process is also known as color transformation or conversion. If a picture is monochrome, the picture may comprise only a luminance sample array. Accordingly, a picture may be, for example, an array of luma samples in monochrome format or an array of luma samples and two corresponding arrays of chroma samples in 4:2:0, 4:2:2, and 4:4:4 colour format.

Embodiments of the video encoder 20 may comprise a picture partitioning unit (not depicted in FIG. 2) configured to partition the picture 17 into a plurality of (typically non-overlapping) picture blocks 203. These blocks may also be referred to as root blocks, macro blocks (H.264/AVC) or coding tree blocks (CTBs) or coding tree units (CTUs) (H.265/HEVC and VVC). The picture partitioning unit may be configured to use the same block size for all pictures of a video sequence and the corresponding grid defining the block size, or to change the block size between pictures or subsets or groups of pictures, and partition each picture into the corresponding blocks.

In further embodiments, the video encoder may be configured to receive directly a block 203 of the picture 17, e.g. one, several or all blocks forming the picture 17. The picture block 203 may also be referred to as current picture block or picture block to be coded.

Like the picture 17, the picture block 203 again is or can be regarded as a two-dimensional array or matrix of samples with intensity values (sample values), although of smaller dimension than the picture 17. In other words, the block 203 may comprise, e.g., one sample array (e.g. a luma array in case of a monochrome picture 17, or a luma or chroma array in case of a color picture) or three sample arrays (e.g. a luma and two chroma arrays in case of a color picture 17) or any other number and/or kind of arrays depending on the color format applied. The number of samples in horizontal and vertical direction (or axis) of the block 203 define the size of block 203. Accordingly, a block may, for example, an M×N (M-column by N-row) array of samples, or an M×N array of transform coefficients.

Embodiments of the video encoder 20 as shown in FIG. 2 may be configured to encode the picture 17 block by block, e.g. the encoding and prediction is performed per block 203.

Embodiments of the video encoder 20 as shown in FIG. 2 may be further configured to partition and/or encode the picture by using slices (or video slices), wherein a picture may be partitioned into or encoded using one or more slices (typically non-overlapping), and each slice may comprise one or more blocks (e.g. CTUs) or one or more groups of blocks (e.g. tiles (H.265/HEVC and VVC) or bricks (VVC)).

Embodiments of the video encoder 20 as shown in FIG. 2 may be further configured to partition and/or encode the picture by using slices/tile groups (or video tile groups) and/or tiles (or video tiles), wherein a picture may be partitioned into or encoded using one or more slices/tile groups (typically non-overlapping), and each slice/tile group may comprise, e.g. one or more blocks (e.g. CTUs) or one or more tiles, wherein each tile, e.g. may be of rectangular shape and may comprise one or more blocks (e.g. CTUs), e.g. complete or fractional blocks.

Residual Calculation:

The residual calculation unit 204 may be configured to calculate a residual block 205 (or residual 205) based on the picture block 203 and a prediction block 265 (further details about the prediction block 265 are provided later), e.g. by subtracting sample values of the prediction block 265 from sample values of the picture block 203, sample by sample (pixel by pixel) to obtain the residual block 205 in the sample domain.

Transform:

The transform processing unit 206 may be configured to apply a transform, e.g. a discrete cosine transform (DCT) or discrete sine transform (DST), on the sample values of the residual block 205 to obtain transform coefficients 207 in a transform domain. The transform coefficients 207 may also be referred to as transform residual coefficients and represent the residual block 205 in the transform domain.

The transform processing unit 206 may be configured to apply integer approximations of DCT/DST, such as the transforms specified for H.265/HEVC. Compared to an orthogonal DCT transform, such integer approximations are typically scaled by a certain factor. In order to preserve the norm of the residual block which is processed by forward and inverse transforms, additional scaling factors are applied as part of the transform process. The scaling factors are typically chosen based on certain constraints like scaling factors being a power of two for shift operations, bit depth of the transform coefficients, tradeoff between accuracy and implementation costs, etc. Specific scaling factors are, for example, specified for the inverse transform, e.g. by inverse transform processing unit 212 (and the corresponding inverse transform, e.g. by inverse transform processing unit 312 at video decoder 30) and corresponding scaling factors for the forward transform, e.g. by transform processing unit 206, at an encoder 20 may be specified accordingly.

Embodiments of the video encoder 20 (respectively transform processing unit 206) may be configured to output transform parameters, e.g. a type of transform or transforms, e.g. directly or encoded or compressed via the entropy encoding unit 270, so that, e.g., the video decoder 30 may receive and use the transform parameters for decoding.

Quantization:

The quantization unit 208 may be configured to quantize the transform coefficients 207 to obtain quantized coefficients 209, e.g. by applying scalar quantization or vector quantization. The quantized coefficients 209 may also be referred to as quantized transform coefficients 209 or quantized residual coefficients 209.

The quantization process may reduce the bit depth associated with some or all of the transform coefficients 207. For example, an n-bit transform coefficient may be rounded down to an m-bit Transform coefficient during quantization, where n is greater than m. The degree of quantization may be modified by adjusting a quantization parameter (QP). For example for scalar quantization, different scaling may be applied to achieve finer or coarser quantization. Smaller quantization step sizes correspond to finer quantization, whereas larger quantization step sizes correspond to coarser quantization. The applicable quantization step size may be indicated by a QP. The quantization parameter may for example be an index to a predefined set of applicable quantization step sizes. For example, small quantization parameters may correspond to fine quantization (small quantization step sizes) and large quantization parameters may correspond to coarse quantization (large quantization step sizes) or vice versa. The quantization may include division by a quantization step size and a corresponding and/or the inverse dequantization, e.g. by inverse quantization unit 210, may include multiplication by the quantization step size. Embodiments according to some standards, e.g. HEVC, may be configured to use a quantization parameter to determine the quantization step size. Generally, the quantization step size may be calculated based on a quantization parameter using a fixed point approximation of an equation including division. Additional scaling factors may be introduced for quantization and dequantization to restore the norm of the residual block, which might get modified because of the scaling used in the fixed point approximation of the equation for quantization step size and quantization parameter. In one example implementation, the scaling of the inverse transform and dequantization might be combined. Alternatively, customized quantization tables may be used and signaled from an encoder to a decoder, e.g. in a bitstream. The quantization is a lossy operation, wherein the loss increases with increasing quantization step sizes.

Embodiments of the video encoder 20 (respectively quantization unit 208) may be configured to output QPs, e.g. directly or encoded via the entropy encoding unit 270, so that, e.g., the video decoder 30 may receive and apply the quantization parameters for decoding.

Inverse Quantization:

The inverse quantization unit 210 may be configured to apply the inverse quantization of the quantization unit 208 on the quantized coefficients to obtain dequantized coefficients 211, e.g. by applying the inverse of the quantization scheme applied by the quantization unit 208 based on or using the same quantization step size as the quantization unit 208. The dequantized coefficients 211 may also be referred to as dequantized residual coefficients 211 and correspond—although typically not identical to the transform coefficients due to the loss by quantization—to the transform coefficients 207.

Inverse Transform:

The inverse transform processing unit 212 may be configured to apply the inverse transform of the transform applied by the transform processing unit 206, e.g. an inverse DCT or inverse DST or other inverse transforms, to obtain a reconstructed residual block 213 (or corresponding dequantized coefficients 213) in the sample domain. The reconstructed residual block 213 may also be referred to as transform block 213.

Reconstruction:

The reconstruction unit 214 (e.g. adder or summer 214) may be configured to add the transform block 213 (i.e. reconstructed residual block 213) to the prediction block 265 to obtain a reconstructed block 215 in the sample domain, e.g. by adding—sample by sample—the sample values of the reconstructed residual block 213 and the sample values of the prediction block 265.

Filtering:

The loop filter unit 220 (or “loop filter” 220), may be configured to filter the reconstructed block 215 to obtain a filtered block 221, or in general, to filter reconstructed samples to obtain filtered sample values. The loop filter unit is, e.g., configured to smooth pixel transitions, or otherwise improve the video quality. The loop filter unit 220 may comprise one or more loop filters such as a de-blocking filter, a SAO filter or one or more other filters, e.g. an ALF, a noise suppression filter (NSF), or any combination thereof. In an example, the loop filter unit 220 may comprise a de-blocking filter, a SAO filter and an ALF filter. The order of the filtering process may be the deblocking filter, SAO and ALF. In another example, a process called the luma mapping with chroma scaling (LMCS) (namely, the adaptive in-loop reshaper) is added. This process is performed before deblocking. In another example, the deblocking filter process may be also applied to internal sub-block edges, e.g. affine sub-blocks edges, ATMVP sub-blocks edges, sub-block transform (SBT) edges and intra sub-partition (ISP) edges.

To effectively remove blocking artifacts occurring for large “blocks”, VVC uses a longer tap deblocking filter. Here the term “blocks” is used in a very generic fashion and it may refer to a “transform block (TB), prediction block (PB) or a coding unit block (CU)”. The longer tap filter is applied to both luma and chroma components. The longer tap filter for the luma components modifies a maximum of 7 samples for each line of samples perpendicular and adjacent to the edge and it is applied for blocks whose size is >=32 samples in the direction of deblocking i.e. for vertical edges, the block width should be >=32 samples and for horizontal edges, the block height should be >=32 samples.

The chroma longer tap filter is applied for chroma blocks when both blocks adjacent to a given edge have a size >=8 samples and it modifies a maximum of three samples on either side of the edge. Therefore for vertical edges the block width of both the blocks adjacent to the edge should be >=8 sample sand for the horizontal edges the block height of both the blocks adjacent to the edge should be >=8 samples. Although the loop filter unit 220 is shown in FIG. 2 as being an in loop filter, in other configurations, the loop filter unit 220 may be implemented as a post loop filter. The filtered block 221 may also be referred to as filtered reconstructed block 221.

Embodiments of the video encoder 20 (respectively loop filter unit 220) may be configured to output loop filter parameters (such as SAO filter parameters or ALF filter parameters or LMCS parameters), e.g. directly or encoded via the entropy encoding unit 270, so that, e.g., a decoder 30 may receive and apply the same loop filter parameters or respective loop filters for decoding.

DPB:

The DPB 230 may be a memory that stores reference pictures, or in general reference picture data, for encoding video data by video encoder 20. The DPB 230 may be formed by any of a variety of memory devices, such as dynamic random-access memory (RAM) (DRAM), including synchronous DRAM (SDRAM), magnetoresistive RAM (MRAM), resistive RAM (RRAM), or other types of memory devices. The DPB 230 may be configured to store one or more filtered blocks 221. The DPB 230 may be further configured to store other previously filtered blocks, e.g. previously reconstructed and filtered blocks 221, of the same current picture or of different pictures, e.g. previously reconstructed pictures, and may provide complete previously reconstructed, i.e. decoded, pictures (and corresponding reference blocks and samples) and/or a partially reconstructed current picture (and corresponding reference blocks and samples), for example for inter prediction. The DPB 230 may be also configured to store one or more unfiltered reconstructed blocks 215, or in general unfiltered reconstructed samples, e.g. if the reconstructed block 215 is not filtered by loop filter unit 220, or any other further processed version of the reconstructed blocks or samples.

Mode Selection (Partitioning & Prediction):

The mode selection unit 260 comprises partitioning unit 262, inter-prediction unit 244 and intra-prediction unit 254, and is configured to receive or obtain original picture data, e.g. an original block 203 (current block 203 of the current picture 17), and reconstructed picture data, e.g. filtered and/or unfiltered reconstructed samples or blocks of the same (current) picture and/or from one or a plurality of previously decoded pictures, e.g. from DPB 230 or other buffers (e.g. line buffer, not shown). The reconstructed picture data is used as reference picture data for prediction, e.g. inter-prediction or intra-prediction, to obtain a prediction block 265 or predictor 265.

Mode selection unit 260 may be configured to determine or select a partitioning for a current block prediction mode (including no partitioning) and a prediction mode (e.g. an intra or inter prediction mode) and generate a corresponding prediction block 265, which is used for the calculation of the residual block 205 and for the reconstruction of the reconstructed block 215.

Embodiments of the mode selection unit 260 may be configured to select the partitioning and the prediction mode (e.g. from those supported by or available for mode selection unit 260), which provide the best match or in other words the minimum residual (minimum residual means better compression for transmission or storage), or a minimum signaling overhead (minimum signaling overhead means better compression for transmission or storage), or which considers or balances both. The mode selection unit 260 may be configured to determine the partitioning and prediction mode based on rate distortion optimization (RDO), i.e. select the prediction mode which provides a minimum rate distortion. Terms like “best”, “minimum”, “optimum” etc. in this context do not necessarily refer to an overall “best”, “minimum”, “optimum”, etc. but may also refer to the fulfillment of a termination or selection criterion like a value exceeding or falling below a threshold or other constraints leading potentially to a “sub-optimum selection” but reducing complexity and processing time.

In other words, the partitioning unit 262 may be configured to partition a picture from a video sequence into a sequence of coding tree units (CTUs), and the CTU 203 may be further partitioned into smaller block partitions or sub-blocks (which form again blocks), e.g. iteratively using quad-tree-partitioning (QT), binary partitioning (BT) or triple-tree-partitioning (TT) or any combination thereof, and to perform, e.g., the prediction for each of the block partitions or sub-blocks, wherein the mode selection comprises the selection of the tree-structure of the partitioned block 203 and the prediction modes are applied to each of the block partitions or sub-blocks.

In the following the partitioning (e.g. by partitioning unit 260) and prediction processing (by inter-prediction unit 244 and intra-prediction unit 254) performed by an example video encoder 20 will be explained in more detail.

Partitioning:

The partitioning unit 262 may be configured to partition a picture from a video sequence into a sequence of coding tree units (CTUs), and the partitioning unit 262 may partition (or split) a coding tree unit (CTU) 203 into smaller partitions, e.g. smaller blocks of square or rectangular size. For a picture that has three sample arrays, a CTU consists of an N×N block of luma samples together with two corresponding blocks of chroma samples. The maximum allowed size of the luma block in a CTU is specified to be 128×128 in the developing VVC, but it can be specified to be value rather than 128×128 in the future, for example, 256×256. The CTUs of a picture may be clustered/grouped as slices/tile groups, tiles or bricks. A tile covers a rectangular region of a picture, and a tile can be divided into one or more bricks. A brick consists of a number of CTU rows within a tile. A tile that is not partitioned into multiple bricks can be referred to as a brick. However, a brick is a true subset of a tile and is not referred to as a tile. There are two modes of tile groups are supported in VVC, namely the raster-scan slice/tile group mode and the rectangular slice mode. In the raster-scan tile group mode, a slice/tile group contains a sequence of tiles in tile raster scan of a picture. In the rectangular slice mode, a slice contains a number of bricks of a picture that collectively form a rectangular region of the picture. The bricks within a rectangular slice are in the order of brick raster scan of the slice. These smaller blocks (which may also be referred to as sub-blocks) may be further partitioned into even smaller partitions. This is also referred to tree-partitioning or hierarchical tree-partitioning, wherein a root block, e.g. at root tree-level 0 (hierarchy-level 0, depth 0), may be recursively partitioned, e.g. partitioned into two or more blocks of a next lower tree-level, e.g. nodes at tree-level 1 (hierarchy-level 1, depth 1), wherein these blocks may be again partitioned into two or more blocks of a next lower level, e.g. tree-level 2 (hierarchy-level 2, depth 2), etc. until the partitioning is terminated, e.g. because a termination criterion is fulfilled, e.g. a maximum tree depth or minimum block size is reached. Blocks which are not further partitioned are or leaf-blocks or leaf nodes of the tree. A tree using partitioning into two partitions is referred to as binary-tree (BT), a tree using partitioning into three partitions is referred to as ternary-tree (TT), and a tree using partitioning into four partitions is referred to as quad-tree (QT).

For example, a coding tree unit (CTU) may be or comprise a CTB of luma samples, two corresponding CTBs of chroma samples of a picture that has three sample arrays, or a CTB of samples of a monochrome picture or a picture that is coded using three separate colour planes and syntax structures used to code the samples. Correspondingly, a coding tree block (CTB) may be an N×N block of samples for some value of N such that the division of a component into CTBs is a partitioning. A coding unit (CU) may be or comprise a coding block of luma samples, two corresponding coding blocks of chroma samples of a picture that has three sample arrays, or a coding block of samples of a monochrome picture or a picture that is coded using three separate colour planes and syntax structures used to code the samples. Correspondingly a coding block (CB) may be an M×N block of samples for some values of M and N such that the division of a CTB into coding blocks is a partitioning.

In embodiments, e.g., according to HEVC, a coding tree unit (CTU) may be split into CUs by using a quad-tree structure denoted as coding tree. The decision whether to code a picture area using inter-picture (temporal) or intra-picture (spatial) prediction is made at the leaf CU level. Each leaf CU can be further split into one, two or four PUs according to the PU splitting type. Inside one PU, the same prediction process is applied and the relevant information is transmitted to the decoder on a PU basis. After obtaining the residual block by applying the prediction process based on the PU splitting type, a leaf CU can be partitioned into transform units (TUs) according to another quadtree structure similar to the coding tree for the CU.

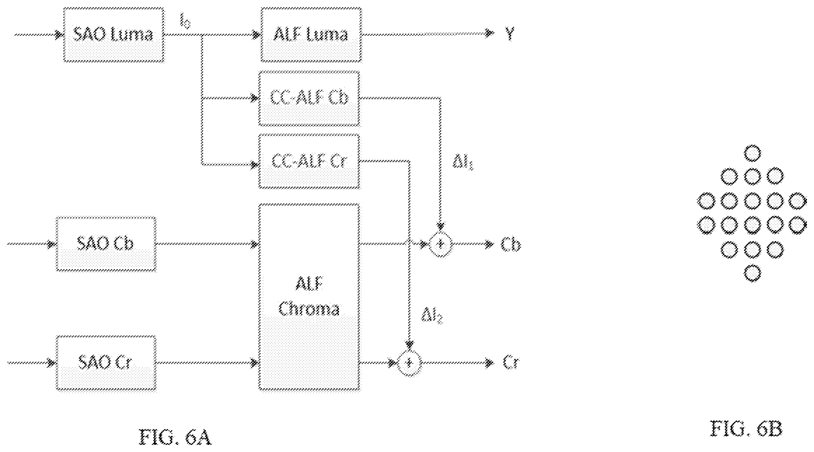

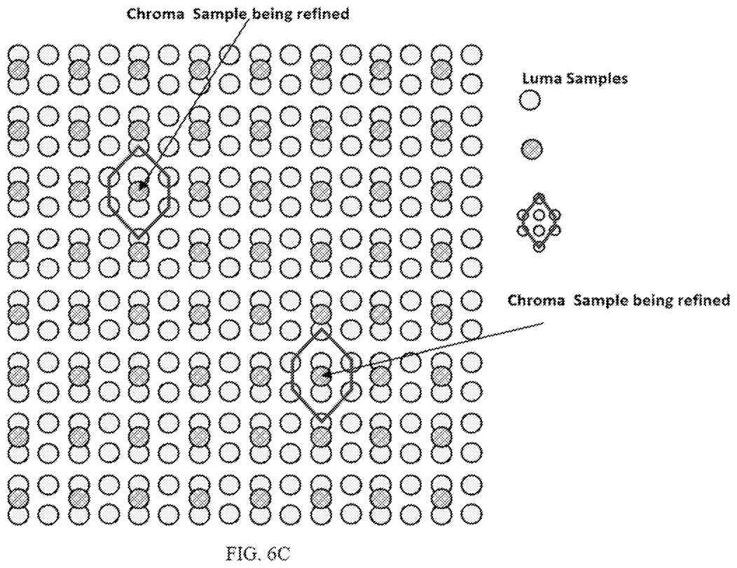

In embodiments, e.g., according to the latest video coding standard currently in development, which is referred to as VVC, a combined quad-tree nested multi-type tree using binary and ternary splits segmentation structure for example used to partition a coding tree unit. In the coding tree structure within a coding tree unit, a CU can have either a square or rectangular shape. For example, the coding tree unit (CTU) is first partitioned by a quaternary tree. Then the quaternary tree leaf nodes can be further partitioned by a multi-type tree structure. There are four splitting types in multi-type tree structure, vertical binary splitting (SPLIT_BT_VER), horizontal binary splitting (SPLIT_BT_HOR), vertical ternary splitting (SPLIT_TT_VER), and horizontal ternary splitting (SPLIT_TT_HOR). The multi-type tree leaf nodes are called coding units (CUs), and unless the CU is too large for the maximum transform length, this segmentation is used for prediction and transform processing without any further partitioning. This means that, in most cases, the CU, PU and TU have the same block size in the quadtree with nested multi-type tree coding block structure. The exception occurs when maximum supported transform length is smaller than the width or height of the colour component of the CU.VVC develops a unique signaling mechanism of the partition splitting information in quadtree with nested multi-type tree coding tree structure. In the signalling mechanism, a coding tree unit (CTU) is treated as the root of a quaternary tree and is first partitioned by a quaternary tree structure. Each quaternary tree leaf node (when sufficiently large to allow it) is then further partitioned by a multi-type tree structure. In the multi-type tree structure, a first flag (mtt_split_cu_flag) is signalled to indicate whether the node is further partitioned, when a node is further partitioned, a second flag (mtt_split_cu_vertical_flag) is signalled to indicate the splitting direction, and then a third flag (mtt_split_cu_binary_flag) is signalled to indicate whether the split is a binary split or a ternary split. Based on the values of mtt_split_cu_vertical_flag and mtt_split_cu_binary_flag, the multi-type tree slitting mode (MttSplitMode) of a CU can be derived by a decoder based on a predefined rule or a table. It should be noted, for a certain design, for example, 64×64 luma block and 32×32 chroma pipelining design in VVC hardware decoders, TT split is forbidden when either width or height of a luma coding block is larger than 64, as shown in FIG. 6. TT split is also forbidden when either width or height of a chroma coding block is larger than 32. The pipelining design will divide a picture into virtual pipeline data units (VPDUs) which are defined as non-overlapping units in a picture. In hardware decoders, successive VPDUs are processed by multiple pipeline stages simultaneously. The VPDU size is roughly proportional to the buffer size in most pipeline stages, so it is important to keep the VPDU size small. In most hardware decoders, the VPDU size can be set to maximum transform block (TB) size. However, in VVC, ternary tree (TT) and binary tree (BT) partition may lead to the increasing of VPDUs sizes.

In addition, it should be noted that, when a portion of a tree node block exceeds the bottom or right picture boundary, the tree node block is forced to be split until the all samples of every coded CU are located inside the picture boundaries.

As an example, the intra sub-partitions (ISP) tool may divide luma intra-predicted blocks vertically or horizontally into 2 or 4 sub-partitions depending on the block size.

In one example, the mode selection unit 260 of video encoder 20 may be configured to perform any combination of the partitioning techniques described herein.

As described above, the video encoder 20 is configured to determine or select the best or an optimum prediction mode from a set of (e.g. pre-determined) prediction modes. The set of prediction modes may comprise, e.g., intra-prediction modes and/or inter-prediction modes.

Intra-Prediction:

The set of intra-prediction modes may comprise 35 different intra-prediction modes, e.g. non-directional modes like DC (or mean) mode and planar mode, or directional modes, e.g. as defined in HEVC, or may comprise 67 different intra-prediction modes, e.g. non-directional modes like DC (or mean) mode and planar mode, or directional modes, e.g. as defined for VVC. As an example, several conventional angular intra prediction modes are adaptively replaced with wide-angle intra prediction modes for the non-square blocks, e.g. as defined in VVC. As another example, to avoid division operations for DC prediction, only the longer side is used to compute the average for non-square blocks. The results of intra prediction of planar mode may be further modified by a position dependent intra prediction combination (PDPC) method.

The intra-prediction unit 254 is configured to use reconstructed samples of neighboring blocks of the same current picture to generate an intra-prediction block 265 according to an intra-prediction mode of the set of intra-prediction modes.

The intra prediction unit 254 (or in general the mode selection unit 260) is further configured to output intra-prediction parameters (or in general information indicative of the selected intra prediction mode for the block) to the entropy encoding unit 270 in form of syntax elements 266 for inclusion into the encoded picture data 21, so that, e.g., the video decoder 30 may receive and use the prediction parameters for decoding.

Inter-Prediction:

The set of (or possible) inter-prediction modes depends on the available reference pictures (i.e. previous at least partially decoded pictures, e.g. stored in DBP 230) and other inter-prediction parameters, e.g. whether the whole reference picture or only a part, e.g. a search window area around the area of the current block, of the reference picture is used for searching for a best matching reference block, and/or e.g. whether pixel interpolation is applied, e.g. half/semi-pel, quarter-pel and/or 1/16 pel interpolation, or not.

Additional to the above prediction modes, skip mode, direct mode and/or other inter prediction mode may be applied.

For example, Extended merge prediction, the merge candidate list of such mode is constructed by including the following five types of candidates in order: spatial motion vector prediction (MVP) from spatial neighbor CUs, temporal MVP from collocated CUs, history-based MVP from a first in first out (FIFO) table, pairwise average MVP and zero motion vectors (MVs). A bilateral-matching based decoder side motion vector refinement (DMVR) may be applied to increase the accuracy of the MVs of the merge mode. Merge mode with MVD (MMVD), which comes from merge mode with motion vector differences. A MMVD flag is signaled right after sending a skip flag and merge flag to specify whether MMVD mode is used for a CU. And a CU-level adaptive motion vector resolution (AMVR) scheme may be applied. AMVR allows MVD of the CU to be coded in different precision. Dependent on the prediction mode for the current CU, the MVDs of the current CU can be adaptively selected. When a CU is coded in merge mode, the combined inter/intra prediction (CIIP) mode may be applied to the current CU. Weighted averaging of the inter and intra prediction signals is performed to obtain the CIIP prediction. Affine motion compensated prediction, the affine motion field of the block is described by motion information of two control point (4-parameter) or three control point motion vectors (6-parameter). Subblock-based temporal motion vector prediction (SbTMVP), which is similar to the temporal motion vector prediction (TMVP) in HEVC, but predicts the motion vectors of the sub-CUs within the current CU. Bi-directional optical flow (BDOF), previously referred to as BIO, is a simpler version that requires much less computation, especially in terms of number of multiplications and the size of the multiplier. Triangle partition mode, in such a mode, a CU is split evenly into two triangle-shaped partitions, using either the diagonal split or the anti-diagonal split. Besides, the bi-prediction mode is extended beyond simple averaging to allow weighted averaging of the two prediction signals.

The inter prediction unit 244 may include a motion estimation (ME) unit and a motion compensation (MC) unit (both not shown in FIG. 2). The motion estimation unit may be configured to receive or obtain the picture block 203 (current picture block 203 of the current picture 17) and a decoded picture 231, or at least one or a plurality of previously reconstructed blocks, e.g. reconstructed blocks of one or a plurality of other/different previously decoded pictures 231, for motion estimation. E.g. a video sequence may comprise the current picture and the previously decoded pictures 231, or in other words, the current picture and the previously decoded pictures 231 may be part of or form a sequence of pictures forming a video sequence.

The encoder 20 may, e.g., be configured to select a reference block from a plurality of reference blocks of the same or different pictures of the plurality of other pictures and provide a reference picture (or reference picture index) and/or an offset (spatial offset) between the position (x, y coordinates) of the reference block and the position of the current block as inter prediction parameters to the motion estimation unit. This offset is also called motion vector (MV).

The motion compensation unit may be configured to obtain, e.g. receive, an inter prediction parameter and to perform inter prediction based on or using the inter prediction parameter to obtain an inter prediction block 265. Motion compensation, performed by the motion compensation unit, may involve fetching or generating the prediction block based on the motion/block vector determined by motion estimation, possibly performing interpolations to sub-pixel precision. Interpolation filtering may generate additional pixel samples from known pixel samples, thus potentially increasing the number of candidate prediction blocks that may be used to code a picture block. Upon receiving the motion vector for the PU of the current picture block, the motion compensation unit may locate the prediction block to which the motion vector points in one of the reference picture lists.

The motion compensation unit may also generate syntax elements associated with the blocks and video slices for use by video decoder 30 in decoding the picture blocks of the video slice. In addition or as an alternative to slices and respective syntax elements, tile groups and/or tiles and respective syntax elements may be generated or used.

Entropy Coding

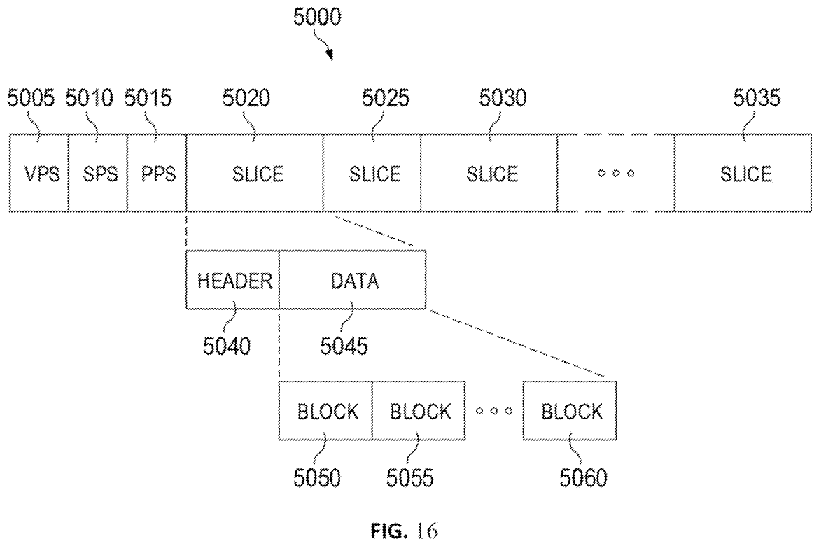

The entropy encoding unit 270 may be configured to apply, for example, an entropy encoding algorithm or scheme (e.g. a variable length coding (VLC) scheme, an context adaptive VLC scheme (CAVLC), an arithmetic coding scheme, a binarization, a context adaptive binary arithmetic coding (CABAC), syntax-based CABAC (SBAC), probability interval partitioning entropy (PIPE) coding or another entropy encoding methodology or technique) or bypass (no compression) on the quantized coefficients 209, inter prediction parameters, intra prediction parameters, loop filter parameters and/or other syntax elements to obtain encoded picture data 21 which can be output via the output 272, e.g. in the form of an encoded bitstream 21, so that, e.g., the video decoder 30 may receive and use the parameters for decoding. The bitstream may, for example, have a form as specified further in FIG. 16 below. The embodiments described in relation to this figure are thus considered encompassed also in the bitstream 21 described here. Furthermore, any structure of a bitstream referred to herein may be provided as bitstream 21 in the sense of this embodiment. The encoded bitstream 21 may be transmitted to video decoder 30, or stored in a memory for later transmission or retrieval by video decoder 30.

Other structural variations of the video encoder 20 can be used to encode the video stream. For example, a non-transform based encoder 20 can quantize the residual signal directly without the transform processing unit 206 for certain blocks or frames. In another implementation, an encoder 20 can have the quantization unit 208 and the inverse quantization unit 210 combined into a single unit.

Decoder and Decoding Method:

FIG. 3 shows an example of a video decoder 30 that may be configured to implement the techniques of this present disclosure. The video decoder 30 may be configured to receive encoded picture data 21 (e.g. encoded bitstream 21), e.g. encoded by encoder 20, to obtain a decoded picture 331. The encoded picture data or bitstream comprises information for decoding the encoded picture data, e.g. data that represents picture blocks of an encoded video slice (and/or tile groups or tiles) and associated syntax elements.

In the example of FIG. 3, the decoder 30 comprises an entropy decoding unit 304, an inverse quantization unit 310, an inverse transform processing unit 312, a reconstruction unit 314 (e.g. a summer 314), a loop filter 320, a DBP 330, a mode application unit 360, an inter prediction unit 344 and an intra prediction unit 354. Inter prediction unit 344 may be or include a motion compensation unit. Video decoder 30 may, in some examples, perform a decoding pass generally reciprocal to the encoding pass described with respect to video encoder 100 from FIG. 2.

As explained with regard to the encoder 20, the inverse quantization unit 210, the inverse transform processing unit 212, the reconstruction unit 214, the loop filter 220, the DPB 230, the inter prediction unit 344 and the intra prediction unit 354 are or forming the “built-in decoder” of video encoder 20. Accordingly, the inverse quantization unit 310 may be identical in function to the inverse quantization unit 110, the inverse transform processing unit 312 may be identical in function to the inverse transform processing unit 212, the reconstruction unit 314 may be identical in function to reconstruction unit 214, the loop filter 320 may be identical in function to the loop filter 220, and the DPB 330 may be identical in function to the DPB 230. Therefore, the explanations provided for the respective units and functions of the video 20 encoder apply correspondingly to the respective units and functions of the video decoder 30.

Entropy Decoding:

The entropy decoding unit 304 may be configured to parse the bitstream 21 (or in general encoded picture data 21) and perform, for example, entropy decoding to the encoded picture data 21 to obtain, e.g., quantized coefficients 309 and/or decoded coding parameters (not shown in FIG. 3), e.g. any or all of inter prediction parameters (e.g. reference picture index and motion vector), intra prediction parameter (e.g. intra prediction mode or index), transform parameters, quantization parameters, loop filter parameters, and/or other syntax elements. Entropy decoding unit 304 may be configured to apply the decoding algorithms or schemes corresponding to the encoding schemes as described with regard to the entropy encoding unit 270 of the encoder 20. Entropy decoding unit 304 may be further configured to provide inter prediction parameters, intra prediction parameter and/or other syntax elements to the mode application unit 360 and other parameters to other units of the decoder 30. Video decoder 30 may receive the syntax elements at the video slice level and/or the video block level. In addition or as an alternative to slices and respective syntax elements, tile groups and/or tiles and respective syntax elements may be received and/or used.

Inverse Quantization:

The inverse quantization unit 310 may be configured to receive QPs (or in general information related to the inverse quantization) and quantized coefficients from the encoded picture data 21 (e.g. by parsing and/or decoding, e.g. by entropy decoding unit 304) and to apply based on the quantization parameters an inverse quantization on the decoded quantized coefficients 309 to obtain dequantized coefficients 311, which may also be referred to as transform coefficients 311. The inverse quantization process may include use of a quantization parameter determined by video encoder 20 for each video block in the video slice (or tile or tile group) to determine a degree of quantization and, likewise, a degree of inverse quantization that should be applied.

Inverse Transform:

Inverse transform processing unit 312 may be configured to receive dequantized coefficients 311, or transform coefficients 311, and to apply a transform to the dequantized coefficients 311 in order to obtain reconstructed residual blocks 213 in the sample domain. The reconstructed residual blocks 213 may also be referred to as transform blocks 313. The transform may be an inverse transform, e.g., an inverse DCT, an inverse DST, an inverse integer transform, or a conceptually similar inverse transform process. The inverse transform processing unit 312 may be further configured to receive transform parameters or corresponding information from the encoded picture data 21 (e.g. by parsing and/or decoding, e.g. by entropy decoding unit 304) to determine the transform to be applied to the dequantized coefficients 311.

Reconstruction:

The reconstruction unit 314 (e.g. adder or summer 314) may be configured to add the reconstructed residual block 313, to the prediction block 365 to obtain a reconstructed block 315 in the sample domain, e.g. by adding the sample values of the reconstructed residual block 313 and the sample values of the prediction block 365.

Filtering:

The loop filter unit 320 (either in the coding loop or after the coding loop) may be configured to filter the reconstructed block 315 to obtain a filtered block 321, e.g. to smooth pixel transitions, or otherwise improve the video quality. The loop filter unit 320 may comprise one or more loop filters such as a de-blocking filter, a SAO filter or one or more other filters, e.g. an ALF, an NSF, or any combination thereof. In an example, the loop filter unit 220 may comprise a de-blocking filter, a SAO filter and an ALF filter. The order of the filtering process may be the deblocking filter, SAO and ALF. In another example, a process called the LMCS (namely, the adaptive in-loop reshaper) is added. This process is performed before deblocking. In another example, the deblocking filter process may be also applied to internal sub-block edges, e.g. affine sub-blocks edges, ATMVP sub-blocks edges, sub-block transform (SBT) edges and intra sub-partition (ISP) edges. Although the loop filter unit 320 is shown in FIG. 3 as being an in loop filter, in other configurations, the loop filter unit 320 may be implemented as a post loop filter.

JVET-P0080 and JVET-O0630 proposes a new in-loop filter called as cross component ALF filter, also referred to herein as CC-ALF or CCALF. CC-ALF operates as part of the adaptive loop filter process and makes use of luma sample values to refine each chroma component (i.e. Cr or Cb component, such as, a first chroma component is namely Cb component, and a second chroma component is namely Cr component). CC-ALF operates by applying a diamond shaped filter on the Luma component for each Chroma sample of the Chroma component and then output filtered value is then used as a correction for the output of the Chroma ALF process.

The CC-ALF may be used as a loop filter and as a post-processing step, respectively.

DPB:

The decoded video blocks 321 of a picture are then stored in DPB 330, which stores the decoded pictures 331 as reference pictures for subsequent motion compensation for other pictures and/or for output respectively display.

The decoder 30 may be configured to output the decoded picture 311, e.g. via output 312, for presentation or viewing to a user.

Prediction:

The inter prediction unit 344 may be identical to the inter prediction unit 244 (in particular to the motion compensation unit) and the intra prediction unit 354 may be identical to the inter prediction unit 254 in function, and performs split or partitioning decisions and prediction based on the partitioning and/or prediction parameters or respective information received from the encoded picture data 21 (e.g. by parsing and/or decoding, e.g. by entropy decoding unit 304). Mode application unit 360 may be configured to perform the prediction (intra or inter prediction) per block based on reconstructed pictures, blocks or respective samples (filtered or unfiltered) to obtain the prediction block 365.

When the video slice is coded as an intra coded (I) slice, intra prediction unit 354 of mode application unit 360 is configured to generate prediction block 365 for a picture block of the current video slice based on a signaled intra prediction mode and data from previously decoded blocks of the current picture. When the video picture is coded as an inter coded (i.e., B, or P) slice, inter prediction unit 344 (e.g. motion compensation unit) of mode application unit 360 is configured to produce prediction blocks 365 for a video block of the current video slice based on the motion vectors and other syntax elements received from entropy decoding unit 304. For inter prediction, the prediction blocks may be produced from one of the reference pictures within one of the reference picture lists. Video decoder 30 may construct the reference frame lists, List 0 and List 1, using default construction techniques based on reference pictures stored in DPB 330. The same or similar may be applied for or by embodiments using tile groups (e.g. video tile groups) and/or tiles (e.g. video tiles) in addition or alternatively to slices (e.g. video slices), e.g. a video may be coded using I, P or B tile groups and/or tiles.

Mode application unit 360 may be configured to determine the prediction information for a video block of the current video slice by parsing the motion vectors or related information and other syntax elements, and uses the prediction information to produce the prediction blocks for the current video block being decoded. For example, the mode application unit 360 uses some of the received syntax elements to determine a prediction mode (e.g., intra or inter prediction) used to code the video blocks of the video slice, an inter prediction slice type (e.g., B slice, P slice, or generalized P and B (GPB) slice), construction information for one or more of the reference picture lists for the slice, motion vectors for each inter encoded video block of the slice, inter prediction status for each inter coded video block of the slice, and other information to decode the video blocks in the current video slice. The same or similar may be applied for or by embodiments using tile groups (e.g. video tile groups) and/or tiles (e.g. video tiles) in addition or alternatively to slices (e.g. video slices), e.g. a video may be coded using I, P or B tile groups and/or tiles.

Embodiments of the video decoder 30 as shown in FIG. 3 may be configured to partition and/or decode the picture by using slices (or video slices), wherein a picture may be partitioned into or decoded using one or more slices (typically non-overlapping), and each slice may comprise one or more blocks (e.g. CTUs) or one or more groups of blocks (e.g. tiles (H.265/HEVC and VVC) or bricks (VVC)).

Embodiments of the video decoder 30 as shown in FIG. 3 may be configured to partition and/or decode the picture by using slices/tile groups (or video tile groups) and/or tiles (or video tiles), wherein a picture may be partitioned into or decoded using one or more slices/tile groups (typically non-overlapping), and each slice/tile group may comprise, e.g. one or more blocks (e.g. CTUs) or one or more tiles, wherein each tile, e.g. may be of rectangular shape and may comprise one or more blocks (e.g. CTUs), e.g. complete or fractional blocks.

Other variations of the video decoder 30 can be used to decode the encoded picture data 21. For example, the decoder 30 can produce the output video stream without the loop filtering unit 320. For example, a non-transform based decoder 30 can inverse-quantize the residual signal directly without the inverse-transform processing unit 312 for certain blocks or frames. In another implementation, the video decoder 30 can have the inverse-quantization unit 310 and the inverse-transform processing unit 312 combined into a single unit.

It should be understood that, in the encoder 20 and the decoder 30, a processing result of a current step may be further processed and then output to the next step. For example, after interpolation filtering, motion vector derivation or loop filtering, a further operation, such as Clip or shift, may be performed on the processing result of the interpolation filtering, motion vector derivation or loop filtering.

It should be noted that further operations may be applied to the derived motion vectors of current block (including but not limit to control point motion vectors of affine mode, sub-block motion vectors in affine, planar, ATMVP modes, temporal motion vectors, and so on). For example, the value of motion vector is constrained to a predefined range according to its representing bit. If the representing bit of motion vector is bitDepth, then the range is −2\hat{ }(bitDepth−1)˜2\hat{ }(bitDepth−1)−1, where “\hat{ }” means exponentiation. For example, if bitDepth is set equal to 16, the range is −32768˜32767, if bitDepth is set equal to 18, the range is −131072˜131071. For example, the value of the derived motion vector (e.g. the MVs of four 4×4 sub-blocks within one 8×8 block) is constrained such that the max difference between integer parts of the four 4×4 sub-block MVs is no more than N pixels, such as no more than 1 pixel. Here provides two methods for constraining the motion vector according to the bitDepth.

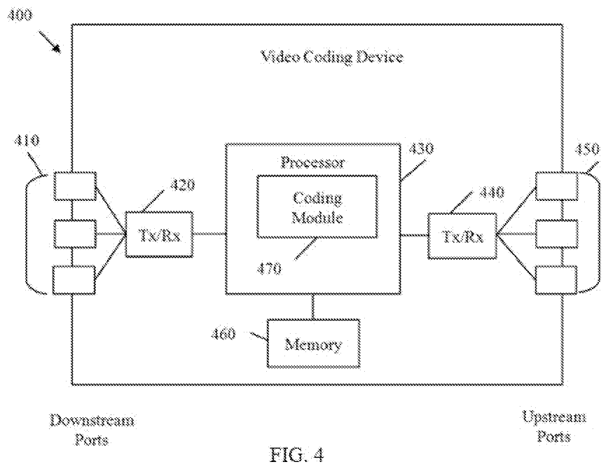

FIG. 4 is a schematic diagram of a video coding device 400 according to an embodiment of the disclosure. The video coding device 400 is suitable for implementing the disclosed embodiments as described herein. In an embodiment, the video coding device 400 may be a decoder such as video decoder 30 of FIG. 1A or an encoder such as video encoder 20 of FIG. 1A.

The video coding device 400 comprises ingress ports 410 (or input ports 410) and receiver units (Rx) 420 for receiving data, a processor, logic unit, or central processing unit (CPU) 430 to process the data, transmitter units (Tx) 440 and egress ports 450 (or output ports 450) for transmitting the data, and a memory 460 for storing the data. The video coding device 400 may also comprise optical-to-electrical (OE) components and electrical-to-optical (EO) components coupled to the ingress ports 410, the receiver units 420, the transmitter units 440, and the egress ports 450 for egress or ingress of optical or electrical signals.

The processor 430 is implemented by hardware and software. The processor 430 may be implemented as one or more CPU chips, cores (e.g., as a multi-core processor), FPGAs, ASICs, and DSPs. The processor 430 is in communication with the ingress ports 410, receiver units 420, transmitter units 440, egress ports 450, and memory 460. The processor 430 comprises a coding module 470. The coding module 470 implements the disclosed embodiments described above. For instance, the coding module 470 implements, processes, prepares, or provides the various coding operations. The inclusion of the coding module 470 therefore provides a substantial improvement to the functionality of the video coding device 400 and effects a transformation of the video coding device 400 to a different state. Alternatively, the coding module 470 is implemented as instructions stored in the memory 460 and executed by the processor 430.

The memory 460 may comprise one or more disks, tape drives, and solid-state drives and may be used as an over-flow data storage device, to store programs when such programs are selected for execution, and to store instructions and data that are read during program execution. The memory 460 may be, for example, volatile and/or non-volatile and may be a read-only memory (ROM), RAM, ternary content-addressable memory (TCAM), and/or static RAM (SRAM).

FIG. 5 is a simplified block diagram of an apparatus 500 that may be used as either or both of the source device 12 and the destination device 14 from FIG. 1 according to an exemplary embodiment.

A processor 502 in the apparatus 500 can be a central processing unit. Alternatively, the processor 502 can be any other type of device, or multiple devices, capable of manipulating or processing information now-existing or hereafter developed. Although the disclosed implementations can be practiced with a single processor as shown, e.g., the processor 502, advantages in speed and efficiency can be achieved using more than one processor.

A memory 504 in the apparatus 500 can be a ROM device or a RAM device in an implementation. Any other suitable type of storage device can be used as the memory 504. The memory 504 can include code and data 506 that is accessed by the processor 502 using a bus 512. The memory 504 can further include an operating system 508 and application programs 510, the application programs 510 including at least one program that permits the processor 502 to perform the methods described here. For example, the application programs 510 can include applications 1 through N, which further include a video coding application that performs the methods described here.

The apparatus 500 can also include one or more output devices, such as a display 518. The display 518 may be, in one example, a touch sensitive display that combines a display with a touch sensitive element that is operable to sense touch inputs. The display 518 can be coupled to the processor 502 via the bus 512.

Although depicted here as a single bus, the bus 512 of the apparatus 500 can be composed of multiple buses. Further, the secondary storage 514 can be directly coupled to the other components of the apparatus 500 or can be accessed via a network and can comprise a single integrated unit such as a memory card or multiple units such as multiple memory cards. The apparatus 500 can thus be implemented in a wide variety of configurations.

### DETAILED DESCRIPTION OF EMBODIMENTS OF THE PRESENT DISCLOSURE

Video coding may be performed based on color space and color format. For example, color video plays an important role in multimedia systems, where various color spaces are used to efficiently represent color. A color space specifies color with numerical values using multiple components. A popular color space is the RGB color space, where color is represented as a combination of three primary color component values (i.e., red, green and blue). For color video compression, the YCbCr color space has been widely used, as described in A. Ford and A. Roberts, “Colour space conversions,” University of Westminster, London, Tech. Rep., August 1998.

YCbCr can be easily converted from the RGB color space via a linear transformation and the redundancy between different components, namely the cross component redundancy, is significantly reduced in the YCbCr color space. One advantage of YCbCr is the backward compatibility with black and white TV as Y signal conveys luminance information. In addition, chrominance bandwidth can be reduced by subsampling the Cb and Cr components in 4:2:0 chroma sampling format with significantly less subjective impact than subsampling in the RGB color space. Because of these advantages, YCbCr has been the major color space in video compression. There are also other color spaces, such as YCoCg, used in video compression. In this disclosure, regardless of the actual color space used, the luma (or L or Y) and two chroma (Cb and Cr) are used to represent the three color components in the video compression scheme.

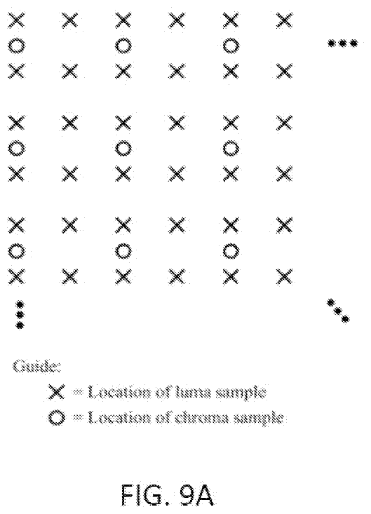

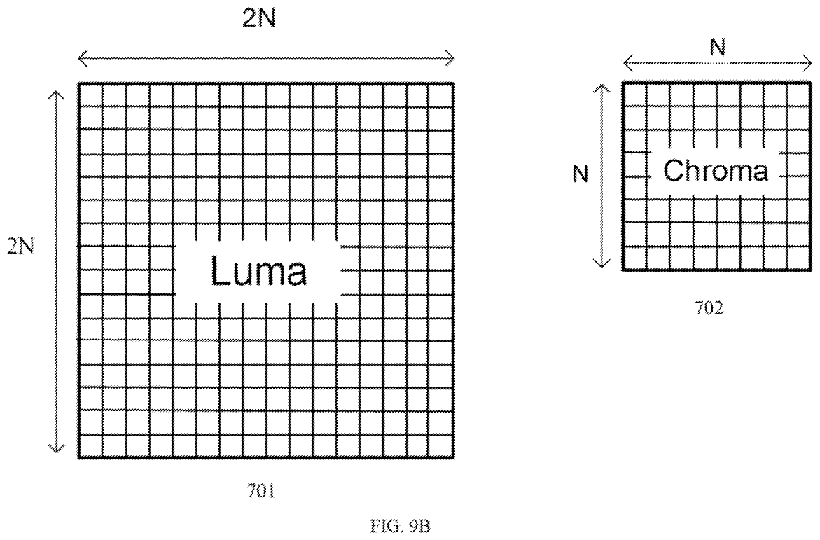

For example, when the chroma format sampling structure is 4:2:0 sampling, each of the two chroma arrays has half the height and half the width of the luma array. The nominal vertical and horizontal relative locations of luma and chroma samples in pictures are shown in FIG. 9A. FIG. 9B illustrates an example of 4:2:0 sampling. FIG. 9B illustrates an example of a co-located luma block and a chroma block. If the video format is YUV 4:2:0, then there are one 16×16 luma block and two 8×8 chroma blocks.

Further, a coding block or a transform block contains a luma block and two chroma blocks.

As shown, the luma block contains four times the samples as the chroma block. Further, the chroma block contains N number of samples by N number of samples while the luma block contains 2N number of samples by 2N number of samples. Hence, the luma block is four times the resolution of the chroma block. For example, when YUV 4:2:0 format is used, the luma samples may be down-sampled by a factor of four (e.g., width by two, and height by two). YUV is a color encoding system that employs a color space in terms of luma components Y and two chrominance components U and V.

Picture Header:

Picture header concept has newly been introduced in the VVC standard (as presented in WET-P1006, P0095, P0120, P0239). Please see section 7.3.2.6 in WET-P2001-VE for the syntax of picture header.

In the current VVC draft, a mandatory picture header concept is proposed to be transmitted once per picture as the first VCL NAL unit of a picture. The current VVC draft also moves few of the syntax elements currently present in the slice header to this picture header. Syntax elements that functionally only need to be transmitted once per picture are moved to the picture header instead of being transmitted multiple times for a given picture, e.g., syntax elements in the slice header are transmitted once per slice. There is a benefit observed by moving syntax elements from the slice header as the computation required for slice header processing can be a limiting factor to overall throughput.

For ALF, following syntax elements (ALF related syntax elements) have been introduced in the picture header:

Picture header raw byte sequence payload (RBSP) syntax:

| | Descriptor |
|---|---|
| picture_header_rbsp( ) { | |
| ...... | |
| if( sps_alf_enabled_flag ) { | |
| pic_alf_enabled_present_flag | u(1) |
| if( pic_alf_enabled_present_flag ) { | |
| pic_alf_enabled_flag | u(1) |
| if( pic_alf_enabled_flag ) { | |
| pic_num_alf_aps_ids_luma | u(3) |
| for( i = 0, i < pic_num_alf_aps_ids_luma, i++ ) | |
| pic_alf_aps_id_luma[ i ] | u(3) |
| if( ChromaArrayType != 0 ) | |
| pic_alf_chroma_idc | u(2) |
| if( pic_alf_chroma_idc ) | |
| pic_alf_aps_id_chroma | u(3) |
| } | |
| } | |
| } | |

Here, the syntax elements are pic_alf_enabled_present_flag, pic_alf_enabled_flag, pic_num_alf_aps_ids_luma, pic_alf_aps_id_luma[i], pic_alf_chroma_idc, pic_alf_aps_id_chroma. These syntax elements are provided in the picture header where there presence potentially depends on other syntax elements that have previously or otherwise been signaled. For example, sps_alf_enabled_flag and ChromaArrayType are such other syntax elements.

In the following, any syntax element denoted with a descriptor in a table and/or provided in bolt letters is a syntax element that is signaled or provided in the current syntax structure.

In the slice header the following syntax changes are introduced for the ALF.

General Slice Header Syntax:

| | Descriptor |
|---|---|
| slice_header( ) { | |
| ...... | |
| if( sp_alf_enabled_flag && !pic_alf_enabled_present_ | |
| flag ) { | |
| slice_alf_enabled_flag | u(1) |
| if( slice_alf_enabled_flag ) { | |
| slice_num_alf_aps_ids_luma | u(3) |
| for( i = 0, i < slice_num_alf_aps_ids_luma, i++ ) | |
| slice_alf_aps_id_luma[ i ] | u(3) |
| if( ChromaArrayType != 0) | |
| slice_alf_chroma_idc | u(2) |
| if( slice_alf_chroma_idc ) | |
| slice_alf_aps_id_chroma | u(3) |
| } | |
| } | |
| ........ | |

The semantics of the ALF picture header entries and slice header entries are as follows.

pic_alf_enabled_present_flag equal to 1 specifies that pic_alf_enabled_flag, pic_num_alf_aps_ids_luma, pic_alf_aps_id_luma[i], pic_alf_chroma_idc, and pic_alf_aps_id_chroma are present in the picture header (PH). pic_alf_enabled_present_flag equal to 0 specifies that pic_alf_enabled_flag, pic_num_alf_aps_ids_luma, pic_alf_aps_id_luma[i], pic_alf_chroma_idc, and pic_alf_aps_id_chroma are not present in the PH. When pic_alf_enabled_present_flag is not present, it is inferred to be equal to 0.

pic_alf_enabled_flag equal to 1 specifies that adaptive loop filter is enabled for all slices associated with the PH and may be applied to Y, Cb, or Cr colour component in the slices. pic_alf_enabled_flag equal to 0 specifies that adaptive loop filter may be disabled for one, or more, or all slices associated with the PH. When not present, pic_alf_enabled_flag is inferred to be equal to 0.

pic_num_alf_aps_ids_luma specifies the number of ALF adaptation parameter sets (APSs) that the slices associated with the PH refers to.

pic_alf_aps_id_luma[i] specifies the adaptation_parameter_set_id of the i-th ALF APS that the luma component of the slices associated with the PH refers to.

The value of alf_luma_filter_signal_flag of the APS NAL unit having aps_params_type equal to ALF_APS and adaptation_parameter_set_id equal to pic_alf_aps_id_luma[i] shall be equal to 1.

pic_alf_chroma_idc equal to 0 specifies that the adaptive loop filter is not applied to Cb and Cr colour components. pic_alf_chroma_idc equal to 1 indicates that the adaptive loop filter is applied to the Cb colour component. pic_alf_chroma_idc equal to 2 indicates that the adaptive loop filter is applied to the Cr colour component. pic_alf_chroma_idc equal to 3 indicates that the adaptive loop filter is applied to Cb and Cr colour components. When pic_alf_chroma_idc is not present, it is inferred to be equal to 0.

pic_alf_aps_id_chroma specifies the adaptation_parameter_set_id of the ALF_APS that the chroma component of the slices associated with the PH refers to.

The value of alf_chroma_filter_signal_flag of the APS NAL unit having aps_params_type equal to ALF_APS and adaptation_parameter_set_id equal to pic_alf_aps_id_chroma shall be equal to 1.

slice_alf_enabled_flag equal to 1 specifies that adaptive loop filter is enabled and may be applied to Y, Cb, or Cr colour component in a slice. slice_alf_enabled_flag equal to 0 specifies that adaptive loop filter is disabled for all colour components in a slice. When not present, the value of slice_alf_enabled_flag is inferred to be equal to pic_alf_enabled_flag.

slice_num_alf_aps_ids_luma specifies the number of ALF APSs that the slice refers to. When slice_alf_enabled_flag is equal to 1 and slice_num_alf_aps_ids_luma is not present, the value of slice_num_alf_aps_ids_luma is inferred to be equal to the value of pic_num_alf_aps_ids_luma.

slice_alf_aps_id_luma[i] specifies the adaptation_parameter_set_id of the i-th ALF APS that the luma component of the slice refers to. The TemporalId of the APS NAL unit having aps_params_type equal to ALF_APS and adaptation_parameter_set_id equal to slice_alf_aps_id_luma[i] shall be less than or equal to the TemporalId of the coded slice NAL unit. When slice_alf_enabled_flag is equal to 1 and slice_alf_aps_id_luma[i] is not present, the value of slice_alf_aps_id_luma[i] is inferred to be equal to the value of pic_alf_aps_id_luma[i].

The value of alf_luma_filter_signal_flag of the APS NAL unit having aps_params_type equal to ALF_APS and adaptation_parameter_set_id equal to slice_alf_aps_id_luma[i] shall be equal to 1.

slice_alf_chroma_idc equal to 0 specifies that the adaptive loop filter is not applied to Cb and Cr colour components. slice_alf_chroma_idc equal to 1 indicates that the adaptive loop filter is applied to the Cb colour component. slice_alf_chroma_idc equal to 2 indicates that the adaptive loop filter is applied to the Cr colour component. slice_alf_chroma_idc equal to 3 indicates that the adaptive loop filter is applied to Cb and Cr colour components. When slice_alf_chroma_idc is not present, it is inferred to be equal to pic_alf_chroma_idc.

slice_alf_aps_id_chroma specifies the adaptation_parameter_set_id of the ALF_APS that the chroma component of the slice refers to. The TemporalId of the APS NAL unit having aps_params_type equal to ALF_APS and adaptation_parameter_set_id equal to slice_alf_aps_id_chroma shall be less than or equal to the TemporalId of the coded slice NAL unit. When slice_alf_enabled_flag is equal to 1 and slice_alf_aps_id_chroma is not present, the value of slice_alf_aps_id_chroma is inferred to be equal to the value of pic_alf_aps_id_chroma.

The value of alf_chroma_filter_signal_flag of the APS NAL unit having aps_params_type equal to ALF_APS and adaptation_parameter_set_id equal to slice_alf_aps_id_chroma shall be equal to 1.

As described above, when all the slices have the same ALF filtering data, then instead of transmitting the ALF filtering data separately in each of the slice headers, the common ALF filtering data across all slices is only transmitted once in the picture header and as a result all the slices inherit the ALF filtering data from the picture header. In this way the overhead of the slice header (in terms of number of bits) is reduced.

The present disclosure collects all the common syntax elements of CC-ALF which are signaled in each slice header of a picture and are defined in the picture header. The present disclosure tries to extend the same principle of ALF signaling also to the cross component ALF (CC-ALF). For CC-ALF each of the slice header has to transmit the following information in the conventional way:

General Slice Header Syntax:

| | Descriptor |
|---|---|
| slice_header( ) { | |
| ...... | |
| if( ChromaArrayType != 0) | |
| slice_cross_component_alf cb_enabled_flag | u(1) |
| if( slice_cross_component_alf_cb_enabled_flag ) { | |
| slice_cross_component_alf_cb_aps_id | u(3) |
| slice_cross_component_cb_filters_signalled_minus1 | ue(v) |
| } | |
| if( ChromaArrayType != 0) | |
| slice_cross_component_alf_cr_enabled_flag | u(1) |
| if( slice_cross_component_alf_cr_enabled_flag ) { | |
| slice_cross_component_alf_cr_aps_id | u(3) |
| slice_cross_component_cr_filters_signalled_minus1 | ue(v) |
| } | |
| ........ | |

Therefore, each slice has to transmit all the above syntax elements even if the information is same across all the slices in a given picture.

Therefore, to reduce the overhead of slice header, the present disclosure defines picture header entries also for CC-ALF.

Technical problem(s) to be solved by the present disclosure:

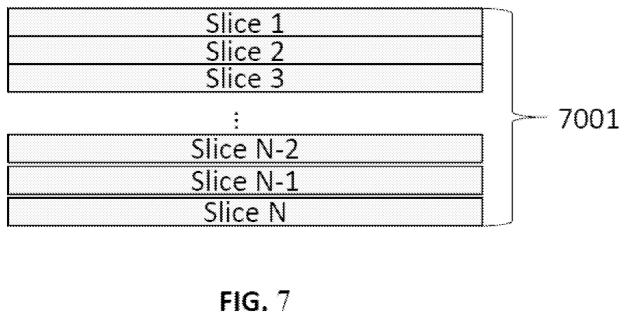

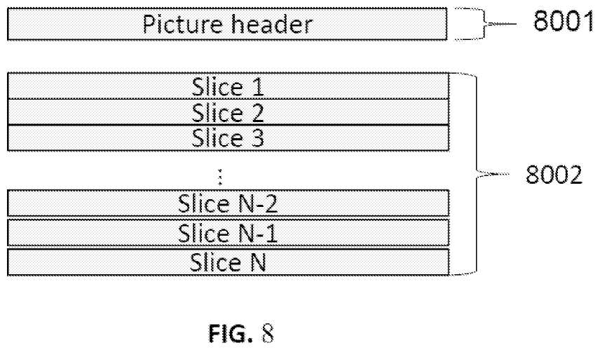

The present disclosure introduces picture header entries for CC-ALF to reduce the slice overhead. As shown in FIG. 7, slice 1 till slice N contain the same CC-ALF filter information 7001. Therefore, each slice header has to transmit the same data resulting in redundancy and slice bit signaling overhead. As shown in FIG. 8, to remove this redundancy in CC-ALF data, picture header entries 8001 for CC-ALF are introduced which defines the common CC-ALF data (also namely CC-ALF related information) and all the slices can then inherit this common information 8002. Therefore, this removes the redundancy in signaling and reduces the parsing overhead of slice headers.

### EMBODIMENTS OF THE TECHNICAL IMPLEMENTATION OF THE PRESENT DISCLOSURE

It is noted that each of the below embodiments disclosed as “alternative” may be provided in combination with any of the other (alternative) embodiments and may be implemented using any of the above described devices, like an encoder and/or a decoder as referred to in the above figures.

### Alternative Embodiment 1

In the first step a new SPS syntax element called a “second syntax element” (denoted below for example with sps_ccalf_enabled_flag) is introduced which controls if CC-ALF is enabled or not. The syntax is as shown below: the second syntax element (sps_ccalf_enabled_flag) decouples the ALF operation and CC-ALF operation completely and therefore enables ALF and CC-ALF to be separately turned on or off at sequence level.

Sequence Parameter Set RBSP Syntax:

| | Descriptor |
|---|---|
| seq_parameter_set_rbsp( ) { | |
| ...... | |
| sps_alf_enabled_flag | u(1) |
| sps_ccalf_enabled _flag | u(1) |
| ....... | |

Here, sps_alf_enabled_flag is an example of a first syntax element that is likewise provided in the SPS level syntax. The first and the second syntax element may be signaled independent from each other as exemplarily provided in the above table. However, as for example provided in the alternative embodiment 5 below, the second syntax element may also be signaled depending for example on a value the first syntax element has or takes.

The new picture header entries (marked in bold and Italic) are as shown below:

Picture Header RBSP Syntax:

| | Descriptor |
|---|---|
| picture_header_rbsp( ) { | |
| ........ | |
| if( sps_alf_enabled_flag ) { | |
| pic_alf_enabled_present_flag | u(1) |
| if( pic_alf_enabled_present_flag ) | { |
| pic_alf_enabled_flag | u(1) |
| if( pic_alf_enabled_flag ) { | |
| pic_num_alf_aps_ids_luma | u(3) |
| for( i = 0, i < pic_num_alf_aps_ids_luma, i++) | |
| pic_alf_aps_id_luma[ i ] | u(3) |
| if( ChromaArrayType != 0 ) | |
| pic_alf_chroma_idc | u(2) |
| if( pic_alf_chroma_idc ) | |
| pic_alf_aps_id_chroma | u(3) |
| } | |
| } | |
| } | |
| [symbol] | |
| [symbol] [symbol] | u(1) |
| [symbol] [symbol] | |
| [symbol] | u(1) |
| [symbol] [symbol] | |
| [symbol] [symbol] | |
| [symbol] [symbol] | u(1) |
| [symbol] [symbol] | |
| [symbol] [symbol] | u(3) |
| [symbol] [symbol] | ue(v) |
| [symbol] | |
| [symbol] [symbol] | |
| [symbol] [symbol] | u(1) |
| [symbol] [symbol] | |
| [symbol] [symbol] | u(3) |
| [symbol] [symbol] | ue(v) |
| [symbol] | |
| [symbol] | |
| } | |
| ...... | |

Here, further syntax elements are introduced in the picture header, where these further syntax elements may only be present if the first and/or second syntax elements take specific values. This is denoted with the “if”-syntax, depending on the value of the first syntax element and/or the second syntax element.

Further, in the picture header, a third syntax element (denoted here with pic_ccalf_enabled_flag) may be provided depending on the value of the second syntax element. This syntax element may indicate (as explained below) whether CC-ALF is to be enabled for the current picture.

A fourth syntax element (like pic_cross_component_alf_cb_enabled_flag) may further be provided in the picture header depending on the second syntax element.

Depending for example on the value of the second syntax element and/or the value of the third syntax element and/or the fourth syntax element, a fifth syntax element, like pic_cross_component_alf_cb_aps_id, may be provided. Moreover, a sixth syntax element, denoted here with pic_cross_component_cb_filters_signalled_minus1, may be provided in the picture header, potentially also depending on the second syntax element and/or the third syntax element and/or the fourth syntax element.

In parallel to this, a seventh syntax element, denoted above with pic_cross_component_alf_cr_enabled_flag, may be provided, depending on the second syntax element and/or the third syntax element.

Depending for example on the value of the seventh syntax element, but potentially also depending on the second syntax element and/or the third syntax element, an eighth (like pic_cross_component_alf_cr_aps_id) and/or a ninth syntax element (like pic_cross_component_cr__filters_signalled_minus1) may be provided.

The meaning of the first to ninth syntax elements and also the meaning of the tenth to fourteenth syntax element further specified below will be explained later.

The slice header syntax is as follows.

General Slice Header Syntax:

| | Descriptor |
|---|---|
| slice_header( ) { | |
| ....... | |
| if( sps_alf_enabled_flag && !pic_alf_enabled_present_flag ) { | |
| slice_alf_enabled_flag | u(1) |
| if( slice_alf_enabled_flag ) { | |
| slice_num_alf_aps_ids_luma | u(3) |
| for( i = 0, i < slice_num_alf_aps_ids_luma, i++ ) | |
| slice_alf_aps_id_luma[ i ] | u(3) |
| if( ChromaArrayType != 0 ) | |
| slice_alf_chroma_idc | u(2) |
| if( slice_alf_chroma_idc ) | |
| slice_alf_aps_id_chroma | u(3) |
| } | |
| if( sps_ccalf_enabled_flag && ! pic_ccalf_enabled_present_flag) { | |
| slice_ccalf_enabled_flag | u(1) |
| if( slice_ccalf_enabled_flag ) { | |
| if( ChromaArrayType != 0 ) | |
| slice_cross_component_alf_cb_enabled_flag | u(1) |
| if( slice_cross_component_alf_cb_enabled_flag ) { | |
| slice_cross_component_alf_cb_aps_id | u(3) |
| slice_cross_component_cb_filters_signalled_minus1 | ue(v) |
| } | |
| if( ChromaArrayType != 0 ) | |
| slice_cross_component_alf_cr_enabled_flag | u(1) |
| if( slice_cross_component_alf_cr_enabled_flag ) { | |
| slice_cross_component_alf_cr_aps_id | u(3) |
| slice_cross_component_cr_filters_signalled_minus1 | ue(v) |
| } | |
| } | |
| ..... | |

As provided above, in some embodiments, the further syntax elements provided in the slice header syntax may only be provided if the first and/or second syntax element and/or one or more further syntax elements provided in the picture header take appropriate values.

Further, as shown above, a tenth syntax element, like slice_cross_component_alf_cb_enabled_flag, may be provided depending on the value of the second syntax element and potentially also depending on a fourteenth syntax element (optionally provided in the SPS level and denoted here with ChromaArrayType) not being equal to 0. Moreover, an eleventh syntax element may be provided which is denoted above with slice_cross_component_alf_cb_aps_id, depending on the value of the second syntax element and/or depending on the value of the tenth syntax element.

Correspondingly, a twelfth syntax element, like slice_cross_component_alf_cr_enabled_flag, may be provided depending on the value of the second syntax element and potentially also depending on the fourteenth syntax element not being equal to 0. Moreover, a thirteenth syntax element may be provided which is denoted above with slice_cross_component_alf_cr_aps_id, depending on the value of the second syntax element and/or depending on the value of the twelfth syntax element.

However, it is also encompassed that the syntax elements (further the tenth to thirteenth syntax elements) provided in the slice header may be present independent from the value of other syntax elements, like the second syntax element or the fourteenth syntax element. Further, it can be provided that the syntax elements pertaining to CC-ALF in the slice header (like, for example, the tenth to thirteenth syntax elements) take a default value if the first syntax element or the second syntax element or another syntax element indicates that CC-ALF is not enabled.

The semantics of the newly introduced syntax elements are as follows.

The second syntax element is denoted here with sps_ccalf_enabled_flag. This is only exemplarily and not limiting the disclosure. In embodiments, the value of the second syntax element equal to 0 specifies that the CC-ALF is disabled for a current video sequence. The value of the second syntax element equal to 1 specifies that the CC-ALF is enabled for a current video sequence.

pic_ccalf_enabled_present_flag equal to 1 specifies that pic_ccalf_enabled_flag, pic_cross_component_alf_cb_enabled_flag, pic_cross_component_alf_cb_aps_id, pic_cross_component_alf_cb_filter_count_minus1, pic_cross_component_alf_cr_enabled_flag, pic_cross_component_alf_cr_aps_id and pic_cross_component_alf_cr_filter_count_minus1 are present in the PH (picture header). pic_alf_enabled_present_flag equal to 0 specifies that pic_ccalf_enabled_flag, pic_cross_component_alf_cb_enabled_flag, pic_cross_component_alf_cb_aps_id, pic_cross_component_alf_cb_filter_count_minus1, pic_cross_component_alf_cr_enabled_flag, pic_cross_component_alf_cr_aps_id and pic_cross_component_alf_cr_filter_count_minus1 are not present in the PH. When pic_ccalf_enabled_present_flag is not present, it is inferred to be equal to 0.

The value of the third syntax element (denoted here with pic_ccalf_enabled_flag) equal to 1 specifies that CC-ALF is enabled for all slices associated with the PH and may be applied to Cb, or Cr colour component in the slices. The value of the third syntax element equal to 0 specifies that CC-ALF may be disabled for one, or more, or all slices associated with the PH. When not present, the value of the third syntax element may be inferred to be equal to 0.

A fourth syntax element was mentioned above and may be denoted here with pic_cross_component_alf_cb_enabled_flag. The value of the fourth syntax element equal to 0 specifies that the cross component Cb filter is not applied to Cb colour component of all slices associated with the PH. When the value of the fourth syntax element is equal to 1, this indicates that the cross component Cb filter is applied to the Cb colour component of all the slices associated with the PH. When the fourth syntax element is not present, it is inferred to be equal to 0.

A fifth syntax element may be denoted here with pic_cross_component_alf_cb_aps_id. The fifth syntax element specifies the adaptation_parameter_set_id that the Cb colour component of all the slices associated with the PH.

A sixth syntax element may be denoted here with pic_cross_component_cb_filters_signalled_minus1. The value of the sixth syntax element plus 1 specifies the number of cross component Cb filters of all the slices associated with the PH. The value of the sixth syntax element shall be in the range 0 to 3.

When the fourth syntax element is equal to 1, it is a requirement of bitstream conformance that the sixth syntax element shall be less than or equal to the value of alf_cross_component_cb_filters_signalled_minus1 in the ALF APS referred to by the fifth syntax element of current picture.

A seventh syntax element mentioned above is denoted with pic_cross_component_alf_cr_enabled_flag. The value of the seventh syntax element equal to 0 specifies that the cross component Cr filter is not applied to Cr colour component of all slices associated with the PH. The value of the seventh syntax element equal to 1 indicates that the cross component Cr filter is applied to the Cr colour component of all the slices associated with the PH. When the seventh syntax element is not present, it is inferred to be equal to 0.

An eighths syntax element was also mentioned and exemplarily denoted with pic_cross_component_alf_cr_aps_id. The value of the eighth syntax element is intended to specify the adaptation_parameter_set_id that the Cr colour component of all the slices associated with the PH.

Moreover, a ninth syntax element is mentioned that may be denoted with pic_cross_component_cr_filters_signalled_minus1. The value of the ninth syntax element plus 1 specifies the number of cross component Cr filters of all the slices associated with the PH. The value of the ninth syntax element shall be in the range 0 to 3.

When the value of the seventh syntax element is equal to 1, it is a requirement of bitstream conformance that the value of the ninth syntax element shall be less than or equal to the value of alf_cross_component_cr_filters_signalled_minus1 in the ALF APS referred to by the eighth syntax element of current picture.

The semantics of the CC-ALF slice header syntax elements are further refined as follows.

slice_ccalf_enabled_flag equal to 1 specifies that CC-ALF is enabled and may be applied to Cb, or Cr colour component in a slice. slice_alf_enabled_flag equal to 0 specifies that CC-ALF is disabled for all colour components in a slice. When not present, the value of slice_ccalf_enabled_flag is inferred to be equal to the third syntax element.

The tenth syntax element mentioned above may be denoted with slice_cross_component_alf_cb_enabled_flag and it may be provided that the value of the tenth syntax element equal to 0 specifies that the cross component Cb filter is not applied to Cb colour component. The tenth syntax element equal to 1 indicates that the cross component Cb filter is applied to the Cb colour component. When the tenth syntax element is not present, it is inferred to be equal to the fourth syntax element (like pic_cross_component_alf_cb_enabled_flag).

An eleventh syntax element mentioned above may be referred to as slice_cross_component_alf_cb_aps_id. The value of the eleventh syntax element specifies the adaptation_parameter_set_id that the Cb colour component of the slice refers to.

When the tenth syntax element has a value equal to 1, it is a requirement of bitstream conformance that, for all slices of the current picture, the ALF_APS referred to by the eleventh syntax element shall be the same.

When the tenth syntax element is equal to 1 and the eleventh syntax element is not present, the value of the eleventh syntax element is inferred to be equal to the value of the fifth syntax element.

slice_cross_component_cb_filters_signalled_minus1 plus 1 specifies the number of cross component Cb filters. The value of slice_cross_component_cb_filters_signalled_minus1 shall be in the range 0 to 3.

When the tenth syntax element equal to 1, it is a requirement of bitstream conformance that slice_cross_component_cb_filters_signalled_minus1 shall be less than or equal to the value of alf_cross_component_cb_filters_signalled_minus1 in the ALF APS referred to by the eleventh of current slice.

When the tenth syntax element is equal to 1 and the eleventh is not present, the value of slice_cross_component_cb_filters_signalled_minus1 is inferred to be equal to the value of pic_cross_component_cb_filters_signalled_minus1

A twelfth syntax element mentioned may be referred to as slice_cross_component_alf_cr_enabled_flag. The value of the twelfth syntax element equal to 0 specifies that the cross component Cr filter is not applied to Cr colour component. The value of the twelfth syntax element equal to 1 indicates that the CC-ALF is applied to the Cr colour component. When the twelfth syntax element is not present, it is inferred to be equal to the seventh syntax element, like pic_cross_component_alf_cr_enabled_flag.

A thirteenth syntax element was mentioned and may further be referred to as slice_cross_component_alf_cr_aps_id. The value of the thirteenth syntax element specifies the adaptation_parameter_set_id that the Cr colour component of the slice refers to.

When the value of the twelfth syntax element is equal to 1, it is a requirement of bitstream conformance that, for all slices of the current picture, the ALF APS referred to by the thirteenth syntax element shall be the same.

When the value of the twelfth syntax element is equal to 1 and the thirteenth syntax element is not present, the value of the thirteenth syntax element is inferred to be equal to the value of the eighth syntax element.

slice_cross_component_cr_filters_signalled_minus1 plus 1 specifies the number of cross component Cr filters. The value of slice_cross_component_cr_filters_signalled_minus1 shall be in the range 0 to 3.

When the twelfth syntax element is equal to 1, it is a requirement of bitstream conformance that slice_cross_component_cr_filters_signalled_minus1 shall be less than or equal to the value of alf_cross_component_cr_filters_signalled_minus1 in the referenced ALF APS referred to by the thirteenth syntax element of current slice.

When the twelfth syntax element is equal to 1 and the thirteenth syntax element is not present, the value of slice_cross_component_cr_filters_signalled_minus1 is inferred to be equal to the value of pic_cross_component_cr_filters_signalled_minus1.

### Embodiment Alternative 2

In the alternative 2, the second syntax element in the SPS level (like sps_ccalf_enabled_flag) is not introduced anymore, therefore the first syntax element (like sps_alf_enabled_flag) also controls the application of CC-ALF filter.

The syntax for alternative 2 is as follows.

Picture header RBSP syntax:

| | Descriptor |
|---|---|
| picture_header_rbsp( ) { | |
| ........ | |
| if( sps_alf_enabled_flag ) { | |
| pic_alf_enabled_present_flag | u(1) |
| if( pic_alf_enabled_present_flag ) { | |
| pic_alf_enabled_flag | u(1) |
| if( pic_alf_enabled_flag ) { | |
| pic_num_alf_aps_ids_luma | u(3) |
| for( i = 0, i < pic_num_alf_aps_ids_luma, i++ ) | |
| pic_alf_aps_id_luma[ i ] | u(3) |
| if( ChromaArrayType != 0 ) | |
| pic_alf_chroma_idc | u(2) |
| if( pic_alf_chroma_idc ) | |
| pic_alf_aps_id_chroma | u(3) |
| } | |
| } | |
| pic_ccalf_enabled_present_flag | u(1) |
| if( pic_ccalf_enabled_present_flag ) { | |
| pic_ccalf_enabled_flag | u(1) |
| if( pic_ccalf_enabled_flag ) { | |
| if( ChromaArrayType != 0 ) | |
| pic_cross_component_alf_cb_enabled_flag | u(1) |
| if( pic_cross_component_alf_cb_enabled_flag ) { | |
| pic_cross_component_alf_cb_aps_id | u(3) |
| pic_cross_component_cb_filters_signalled_minus1 | ue(v) |
| } | |
| if( ChromaArrayType != 0 ) | |
| pic_cross_component_alf_cr_enabled_flag | u(1) |
| if( pic_cross_component_alf_cr_enabled_flag ) { | |
| pic_cross_component_alf_cr_aps_id | u(3) |
| pic_cross_component_cr_filters_signalled_minus1 | ue(v) |
| } | |
| } | |
| } | |
| ...... | |

In this second embodiment, the second syntax element, which may be sps_ccalf_enabled_flag, may be provided in the SPS level. Whether or not CCALF is to be enabled may, in this embodiment, be specified based on a further syntax element, like pic_ccalf_enabled_present_flag, which specifies whether CC-ALF that further syntax elements pertaining to CC-ALF are present and from which it may further be obtained that, for the current picture to which pic_ccalf_enabled_present_flag pertains, CC-ALF is to be enabled.

The slice header syntax is as follows:

General Slice Header Syntax:

| | Descriptor |
|---|---|
| slice_header( ) { | |
| ....... | |
| if( sps_alf_enabled_flag && !pic_alf_enabled_present_flag ) | |
| { | |
| slice_alf_enabled_flag | u(1) |
| if( slice_alf_enabled_flag ) { | |
| slice_num_alf_aps_ids_luma | u(3) |
| for( i = 0, i < slice_num_alf_aps_ids_luma, i++ ) | |
| slice_alf_aps_id_luma[ i ] | u(3) |
| if( ChromaArrayType != 0 ) | |
| slice_alf_chroma_idc | u(2) |
| if( slice_alf_chroma_idc ) | |
| slice_alf_aps_id_chroma | u(3) |
| } | |
| if( sps_alf_enabled_flag && ! pic_ccalf_enabled_present_flag) { | |
| slice_ccalf_enabled_flag | u(1) |
| if( slice_ccalf_enabled_flag ) { | |
| if( ChromaArrayType != 0 ) | |
| slice_cross_component_alf_cb_enabled_flag | u(1) |
| if( slice_cross_component_alf_cb_enabled_flag ) | |
| { | |
| slice_cross_component_alf_cb_aps_id | u(3) |
| slice_cross_component_cb_filters_signalled_minus1 | ue(v) |
| } | |
| if( ChromaArrayType != 0 ) | |
| slice_cross_component_alf_cr_enabled_flag | u(1) |
| if( slice_cross_component_alf_cr_enabled_flag ) | |
| { | |
| slice_cross_component_alf_cr_aps_id | u(3) |
| slice_cross_component_cr_filters_signalled_minus1 | ue(v) |
| } | |
| } | |
| ..... | |

As seen from the above, the presence of syntax elements in the slice header, like for example slice_ccalf_enabled_flag, slice_cross_component_alf_cb_enabled_flag, slice_cross_component_alf_cb_aps_id, slice_cross_component_cb_filters_signalled_minus1, slice_cross_component_alf_cr_enabled_flag, slice_cross_component_alf_cr_aps_id and slice_cross_component_cr_filters_signalled_minus1, and/or the tenth to thirteenth syntax elements already referred to above may depend on the first syntax element provided in the SPS level, like sps_alf_enabled_flag, and a syntax element provided in the picture header, like pic_ccalf_enabled_present_flag and potentially on a further syntax element that is provided in the slice header, like slice_ccalf_enabled_flag.

### Embodiment Alternative 3

The other alternative for the CC-ALF picture header entries is as follows: in this alternative pic_alf_enabled_present_flag, pic_alf_enabled_flag controls the CC-ALF picture header and CC-ALF slice header entries respectively.

Picture Header RBSP Syntax:

| | Descriptor |
|---|---|
| picture_header_rbsp( ) { | |
| ........ | |
| if( sps_alf_enabled_flag ) { | |
| pic_alf_enabled_present_flag | u(1) |
| if( pic_alf_enabled present_flag ) { | |
| pic_alf_enabled_flag | u(1) |
| if( pic_alf_enabled flag ) { | |
| pic_num_alf_aps_ids_luma | u(3) |
| for( i = 0, i < pic_num_alf_aps_ids_luma, i++ ) | |
| pic_alf_aps_id_luma[ i ] | u(3) |
| if( ChromaArrayType != 0 ) | |
| pic_alf_chroma_idc | u(2) |
| if( pic_alf_chroma_idc ) | |
| pic_alf_aps_id_chroma | u(3) |
| if( ChromaArrayType != 0 ) | |
| pic_cross_component_alf_cb_enabled_flag | u(1) |
| if( pic_cross_component_alf_cb_enabled_flag ) { | |
| pic_cross_component_alf_cb_aps_id | u(3) |
| pic_cross_component_cb_filters_signalled_minus1 | ue(v) |
| } | |
| if( ChromaArrayType != 0 ) | |
| pic_cross_component_alf_cr_enabled_flag | u(1) |
| if( pic_cross_component_alf_cr_enabled_flag ) { | |
| pic_cross_component_alf_cr_aps_id | u(3) |
| pic_cross_component_cr_filters_signalled_minus1 | ue(v) |
| } /* end of pic_alf_enabled_flag */ | |
| } /* end of pic_alf_enabled_present_flag */ | |
| } /* end of sps_alf_enabled_flag */ | |
| ...... | |

The slice header syntax is as follows:

General Slice Header Syntax:

| | Descriptor |
|---|---|
| slice_header( ) { | |
| ....... | |
| if( sps_alf_enabled_flag && !pic_alf_enabled_present_flag ) | |
| //explanation: if sps_alf_enabled_flag is true (and) if | |
| pic_alf_enabled_present_flag is false )//{ | |
| slice_alf_enabled_flag | u(1) |
| if( slice_alf_enabled_flag ) { | |
| slice_num_alf_aps_ids_luma | u(3) |
| for( i = 0, i < slice_num_alf_aps_ids_luma, i++ ) | |
| slice_alf_aps_id_luma[ i ] | u(3) |
| if( ChromaArrayType != 0 ) | |
| slice_alf_chroma_idc | u(2) |
| if( slice_alf_chroma_idc ) | |
| slice_alf_aps_id_chroma | u(3) |
| if( ChromaArrayType != 0 ) | |
| slice_cross_component_alf_cb_enabled_flag | u(1) |
| if( slice_cross_component_alf_cb_enabled_flag ) { | |
| slice_cross_component_alf_cb_aps_id | u(3) |
| slice_cross_component_cb_filters_signalled_minus1 | ue(v) |
| } | |
| if( ChromaArrayType != 0 ) | |
| slice_cross_component_alf_cr_enabled_flag | u(1) |
| if( slice_cross_component_alf_cr_enabled_flag ) { | |
| slice_cross_component_alf_cr_aps_id | u(3) |
| slice_cross_component_cr_filters_signalled_minus1 | ue(v) |
| } | |
| } /* end of slice_alf_enabled_flag loop */ | |
| } /* end of sps_alf_enabled_flag && !pic_alf_enabled_present_flag | |
| */ | |
| ..... | |

It can be noted that !(0)=1 or !(1)=0.

### Embodiment Alternative 4

Since, in the current design of CC-ALF, there is a restriction that slice_cross_component_alf_cb_aps_id, slice_cross_component_alf_cr_aps_id should be the same across all slices, it does not make sense to repeat this syntax element in the slice header but rather only signal the pic_cross_component_alf_cb_aps_id and pic_cross_component_alf_cr_aps_id in the picture header. The values of the syntax elements slice_cross_component_alf_cb_aps_id and slice_cross_component_alf_cr may then be inferred to be the same as pic_cross_component_alf_cb_aps_id and pic_cross_component_alf_cr_aps_id. Thereby, the amount of information in the bitstream can be reduced further.

The possible syntax are as follows:

Picture Header RBSP Syntax

| | Descriptor |
|---|---|
| picture_header_rbsp( ) { | |
| ........ | |
| if( sps_alf_enabled_flag ) { | |
| pic_alf_enabled_present_flag | u(1) |
| if( pic_alf_enabled_present_flag ) { | |
| pic_alf_enabled_flag | u(1) |
| if( pic_alf_enabled_flag ) { | |
| pic_num_alf_aps_ids_luma | u(3) |
| for( i = 0, i < pic_num_alf_aps_ids_luma, i++ ) | |
| pic_alf_aps_id_luma[ i ] | u(3) |
| if( ChromaArrayType != 0 ) | |
| pic_alf_chroma_idc | u(2) |
| if( pic_alf_chroma_idc ) | |
| pic_alf_aps_id_chroma | u(3) |
| } | |
| } | |
| } | |
| if( sps_ccalf_enabled_flag ) { | |
| pic_cross_component_alf_cb_aps_id | u(3) |
| pic_cross_component_alf_cr_aps_id | u(3) |
| pic_ccalf_enabled_present_flag | u(1) |
| if( pic_ccalf_enabled_present_flag ) { | |
| pic_ccalf_enabled_flag | u(1) |
| if( pic_ccalf_enabled_flag ) { | |
| if( ChromaArrayType != 0 ) | |
| pic_cross_component_alf_cb_enabled_flag | u(1) |
| if( pic_cross_component_alf_cb_enabled_flag ) { | |
| pic_cross_component_cb_filters_signalled_minus1 | ue(v) |
| } | |
| if( ChromaArrayType != 0 ) | |
| pic_cross_component_alf_cr_enabled_flag | u(1) |
| if( pic_cross_component_alf_cr_enabled_flag ) { | |
| pic_cross_component_cr_filters_signalled_minus1 | ue(v) |
| } | |
| } | |
| } | |
| ...... | |

Here, the further syntax elements that pertain to CC-ALF (i.e. at least the syntax elements comprising an element CC-ALF or cross_component_alf or cc_alf are provided depending on a value of the second syntax element signaled in the SPS level, i.e. in this embodiment sps_ccalf_enabled_flag.

Further, depending on the value of the second syntax element, a third syntax element, like pic_ccalf_enabled_flag may be provided in the picture header, where this third syntax element may indicate whether CC-ALF is enabled for the slices of the current picture.

Furthermore, a fourth syntax element, like pic_cross_component_alf_cb_enabled_flag, and a seventh syntax element, like pic_cross_component_alf_cb_enabled_flag, may be provided in the picture header depending on the value of the second syntax element.

The slice header syntax may be as follows:

General Slice Header Syntax

| | Descriptor |
|---|---|
| slice_header( ) { | |
| ....... | |
| if( sps_alf_enabled_flag && !pic_alf_enabled_present_flag ) { | |
| slice_alf_enabled_flag | u(1) |
| if( slice_alf_enabled_flag ) { | |
| slice_num_alf_aps_ids_luma | u(3) |
| for( i = 0, i < slice_num_alf_aps_ids_luma, i++ ) | |
| slice_alf_aps_id_luma[ i ] | u(3) |
| if( ChromaArrayType != 0 ) | |
| slice_alf_chroma_idc | u(2) |
| if( slice_alf_chroma_idc ) | |
| slice_alf_aps_id_chroma | u(3) |
| } | |
| if( sps_ccalf_enabled_flag && ! pic_ccalf_enabled_present_flag) { | |
| slice_ccalf_enabled_flag | u(1) |
| if( slice_ccalf_enabled_flag ) { | |
| if( ChromaArrayType != 0 ) | |
| slice_cross_component_alf_cb_enabled_flag | u(1) |
| if( slice_cross_component_alf_cb_enabled_flag ) { | |
| slice_cross_component_cb_filters_signalled_minus1 | ue(v) |
| } | |
| if( ChromaArrayType != 0 ) | |
| slice_cross_component_alf_cr_enabled_flag | u(1) |
| if( slice_cross_component_alf_cr_enabled_flag ) { | |
| slice_cross_component_cr_filters_signalled_minus1 | ue(v) |
| } | |
| } | |
| ..... | |

Also for this embodiment, it may be provided that syntax elements in the slice header that pertain to CC-ALF are provided depending on the value of the second syntax element provided in SPS level and/or depending on a value of one or more syntax elements pertaining to CC-ALF provided in the picture header, like for example pic_ccalf_enabled_present_flag.

slice_cross_component_alf_cb_aps_id may always be inferred to be the same as the value of pic_cross_component_alf_cb_aps_id.

slice_cross_component_alf_cr_aps_id may always be inferred to be the same as the value of pic_cross_component_alf_cr_aps_id.

The other possible syntax is as follows

Picture Header RBSP Syntax

| | Descriptor |
|---|---|
| picture_header_rbsp( ) { | |
| ........ | |
| if( sps_alf_enabled_flag ) { | |
| pic_alf_enabled_present_flag | u(1) |
| if( pic_alf_enabled_present_flag ) { | |
| pic_alf_enabled_flag | u(1) |
| if( pic_alf_enabled_flag ) { | |
| pic_num_alf_aps_ids_luma | u(3) |
| for( i = 0, i < pic_num_alf_aps_ids_luma, i++ | |
| ) | |
| pic_alf_aps_id_luma[ i ] | u(3) |
| if( ChromaArrayType != 0 ) | |
| pic_alf_chroma_idc | u(2) |
| if( pic_alf_chroma_idc ) | |
| pic_alf_aps_id_chroma | u(3) |
| } | |
| } | |
| pic_cross_component_alf_cb_aps_id | u(3) |
| pic_cross_component_alf_cr_aps_id | u(3) |
| pic_ccalf_enabled_present_flag | u(1) |
| if( pic_ccalf_enabled_present_flag ) { | |
| pic_ccalf_enabled_flag | u(1) |
| if( pic_ccalf_enabled_flag ) { | |
| if( ChromaArrayType != 0 ) | |
| pic_cross_component_alf_cb_enabled_flag | u(1) |
| if( pic_cross_component_alf_cb_enabled_flag ) | |
| { | |
| pic_cross_component_alf_cb_aps_id | u(3) |
| pic_cross_component_cb_filters_signalled_minus1 | ue(v) |
| } | |
| if( ChromaArrayType != 0 ) | |
| pic_cross_component_alf_cr_enabled_flag | u(1) |
| if( pic_cross_component_alf_cr_enabled_flag ) { | |
| pic_cross_component_alf_cr_aps_id | u(3) |
| pic_cross_component_cr_filters_signalled_minus1 | ue(v) |
| } | |
| } | |
| } | |
| ...... | |

In the syntax according to the above table, the presence of syntax elements that pertain to CC-ALF depends on the value of the first syntax element provided in the SPS level, like sps_alf_enabled_flag. The second syntax element, like sps_ccalf_enabled_flag, may or may not be provided in the SPS level in this embodiment.

The slice header syntax may be as follows:

General Slice Header Syntax

| | Descriptor |
|---|---|
| slice_header( ) { | |
| ....... | |
| if( sps_alf_enabled_flag && !pic_alf_enabled_present_flag ) | |
| { | |
| slice_alf_enabled_flag | u(1) |
| if( slice_alf_enabled_flag ) { | |
| slice_num_alf_aps_ids_luma | u(3) |
| for( i = 0, i < slice_num_alf_aps_ids_luma, i++ ) | |
| slice_alf_aps_id_luma[ i ] | u(3) |
| if( ChromaArrayType != 0 ) | |
| slice_alf_chroma_idc | u(2) |
| if( slice_alf_chroma_idc ) | |
| slice_alf_aps_id_chroma | u(3) |
| } | |
| if( sps_alf_enabled_flag && ! pic_ccalf_enabled_present_flag) { | |
| slice_ccalf_enabled_flag | u(1) |
| if( slice_ccalf_enabled_flag ) { | |
| if( ChromaArrayType != 0 ) | |
| slice_cross_component_alf_cb_enabled_flag | u(1) |
| if( slice_cross_component_alf_cb_enabled_flag ) | |
| { | |
| slice_cross_component_cb_filters_signalled_minus1 | ue(v) |
| } | |
| if( ChromaArrayType != 0 ) | |
| slice_cross_component_alf_cr_enabled_flag | u(1) |
| if( slice_cross_component_alf_cr_enabled_flag ) | |
| { | |
| slice_cross_component_cr_filters_signalled_minus1 | ue(v) |
| } | |
| } | |
| ..... | |

slice_cross_component_alf_cb_aps_id is always inferred to the be the same as the value of pic_cross_component_alf_cb_aps_id.

slice_cross_component_alf_cr_aps_id is always inferred to the be the same as the value of pic_cross_component_alf_cr_aps_id.

The other possible syntax is as follows:

Picture Header RBSP Syntax:

| | Descriptor |
|---|---|
| picture_header_rbsp( ) { | |
| ........ | |
| if( sps_alf_enabled_flag ) { | |
| pic_cross_component_alf_cb_aps_id | u(3) |
| pic_cross_component_alf_cr_aps_id | u(3) |
| pic_alf_enabled_present_flag | u(1) |
| if( pic_alf_enabled_present_flag ) { | |
| pic_alf_enabled_flag | u(1) |
| if( pic_alf_enabled_flag ) { | |
| pic_num_alf_aps_ids_luma | u(3) |
| for( i = 0, i < pic_num_alf_aps_ids_luma, i++ | |
| ) | |
| pic_alf_aps_id_luma[ i ] | u(3) |
| if( ChromaArrayType != 0 ) | |
| pic_alf_chroma_idc | u(2) |
| if( pic_alf_chroma_idc ) | |
| pic_alf_aps_id_chroma | u(3) |
| if( ChromaArrayType != 0 ) | |
| pic_cross_component_alf_cb_enabled_flag | u(1) |
| if( pic_cross_component_alf_cb_enabled_flag ) { | |
| pic_cross_component_cb_filters_signalled_minus1 | ue(v) |
| } | |
| if( ChromaArrayType != 0 ) | |
| pic_cross_component_alf_cr_enabled_flag | u(1) |
| if( pic_cross_component_alf_cr_enabled_flag ) { | |
| pic_cross_component_cr_filters_signalled_minus1 | ue(v) |
| } /* end of pic_alf_enabled_flag */ | |
| } /* end of pic_alf_enabled_present_flag */ | |
| } /* end of sps_alf_enabled_flag */ | |
| ...... | |

The slice header syntax is as follows:

General Slice Header Syntax:

| | Descriptor |
|---|---|
| slice_header( ) { | |
| ....... | |
| if( sps_alf_enabled_flag && !pic_alf_enabled_present_flag ) | |
| { | |
| slice_alf_enabled_flag | u(1) |
| if( slice_alf_enabled_flag ) { | |
| slice_num_alf_aps_ids_luma | u(3) |
| for( i = 0, i < slice_num_alf_aps_ids_luma, i++ ) | |
| slice_alf_aps_id_luma[ i ] | u(3) |
| if( ChromaArrayType != 0 ) | |
| slice_alf_chroma_idc | u(2) |
| if( slice_alf_chroma_idc ) | |
| slice_alf_aps_id_chroma | u(3) |
| if( ChromaArrayType != 0 ) | |
| slice_cross_component_alf_cb_enabled_flag | u(1) |
| if( slice_cross_component_alf_cb_enabled_flag ) { | |
| slice_cross_component_cb_filters_signalled_minus1 | ue(v) |
| } | |
| if( ChromaArrayType != 0 ) | |
| slice_cross_component_alf_cr_enabled_flag | u(1) |
| if( slice_cross_component_alf_cr_enabled_flag ) { | |
| slice_cross_component cr_filters_signalled_minus1 | ue(v) |
| } | |
| } /* end of slice_alf_enabled_flag loop */ | |
| } /* end of sps_alf_enabled_flag && | |
| !pic_alf_enabled_present_flag */ | |
| ..... | |

In this embodiment, the slice_cross_component_alf_cb_aps_id is always inferred to the be the same as the value of pic_cross_component_alf_cb_aps_id.

In this embodiment, a twelfth syntax element, like slice_cross_component_alf_cr_aps_id, is always inferred to the be the same as the value of the eighth syntax element, like pic_cross_component_alf_cr_aps_id).

### Embodiment Alternative 5

The other alternative syntax is as possible below. In this syntax CC-ALF parameters are conditionally signaled based on a value of the second syntax element as already referred to above. This second syntax element may be provided as or may comprise a flag, such as sps_ccalf_enabled_flag.

SPS RBSP Syntax:

| | Descriptor |
|---|---|
| seq_parameter_set_rbsp( ) { | |
| sps_decoding_parameter_set_id | u(4) |
| sps_video_parameter_set_id | u(4) |
| sps_max_sublayers_minus1 | u(3) |
| sps_reserved_zero_4bits | u(4) |
| sps_ptl_dpb_hrd_params_present_flag | u(1) |
| if( sps_ptl_dpb_hrd_params_present_flag ) | |
| profile_tier_level( 1, sps_max_sublayers_minus1 ) | |
| gdr_enabled_flag | u(1) |
| sps_seq_parameter_set_id | u(4) |
| chroma_format_idc | u(2) |
| if( chroma_format_idc = = 3 ) | |
| separate_colour_plane_flag | u(1) |
| ref_pic_resampling_enabled_flag | u(1) |
| pic_width_max_in_luma_samples | ue(v) |
| pic_height_max_in_luma_samples | ue(v) |
| sps_log2_ctu_size_minus5 | u(2) |
| subpics_present_flag | u(1) |
| if( subpics_present_flag ) { | |
| sps_nums_ubpics_minus1 | u(8) |
| for( i = 0, i <= sps_num_subpics_minus1, i++ ) { | |
| subpic_ctu_top_left_x[ i ] | u(v) |
| subpic_ctu_top_left_y[ i ] | u(v) |
| subpic_width_minus1[ i ] | u(v) |
| subpic_height_minus1[ i ] | u(v) |
| subpic_treated_as_pic_flag[ i ] | u(1) |
| loop_filter_across_subpic_enabled_flag[ i ] | u(1) |
| } | |
| } | |
| sps_subpic_id_present_flag | u(1) |
| if( sps_subpics_id_present_flag ) { | |
| sps_subpic_id_signalling_present_flag | u(1) |
| if( sps_subpics_id_signalling_present_flag ) { | |
| sps_subpic_id_len_minus1 | ue(v) |
| for( i = 0, i <= sps_num_subpics_minus1, i++ ) | |
| sps_subpic_id[ i ] | u(v) |
| } | |
| } | |
| bit_depth_minus8 | ue(v) |
| min_qp_prime_ts_minus4 | ue(v) |
| sps_weighted_pred_flag | u(1) |
| sps_weighted_bipred_flag | u(1) |
| log2_max_pic_order_cnt_lsb_minus4 | u(4) |
| sps_poc_msb_flag | u(1) |
| if( sps_poc_msb_flag ) | |
| poc_msb_len_minus1 | ue(v) |
| if( sps_max_sublayers_minus1 > 0 ) | |
| sps_sublayer_dpb_params_flag | u(1) |
| if( sps_ptl_dpb_hrd_params_present_flag ) | |
| dpb_parameters( 0, sps_max_sublayers_minus1, | |
| sps_sublayer_dpb_params_flag ) | |
| long_term_ref_pics_flag | u(1) |
| inter_layer_ref_pics_present_flag | u(1) |
| sps_idr_rpl_present_flag | u(1) |
| rpl1_same_as_rpl0_flag | u(1) |
| for( i = 0, i < !rpl1_same_as_rpl0_flag ? 2 : 1, i++ ) { | |
| num_ref_pic_lists_in_sps[ i ] | ue(v) |
| for( j = 0, j < num_ref_pic_lists_in_sps[ i ], j++ ) | |
| ref_pic_list_struct( i, j ) | |
| } | |
| if( ChromaArrayType != 0 ) | |
| qtbtt_dual_tree_intra_flag | u(1) |
| log2_min_luma_coding_block_size_minus2 | ue(v) |
| partition_constraints_override_enabled_flag | u(1) |
| sps_log2_diff_min_qt_min_cb_intra_slice_luma | ue(v) |
| sps_log2_diff_min_qt_min_cb_inter_slice | ue(v) |
| sps_max_mtt_hierarchy_depth_inter_slice | ue(v) |
| sps_max_mtt_hierarchy_depth_intra_slice_luma | ue(v) |
| if( sps_max_mtt_hierarchy_depth_intra_slice_luma != 0 ) { | |
| sps_log2_diff_max_bt_min_qt_intra_slice_luma | ue(v) |
| sps_log2_diff_max_tt_min_qt_intra_slice_luma | ue(v) |
| } | |
| if( sps_max_mtt_hierarchy_depth_inter_slice != 0 ) { | |
| sps_log2_diff_max_bt_min_qt_inter_slice | ue(v) |
| sps_log2_diff_max_tt_min_qt_inter_slice | ue(v) |
| } | |
| if( qtbtt_dual_tree_intra_flag ) { | |
| sps_log2_diff_min_qt_min_cb_intra_slice_{——}chroma | ue(v) |
| sps_max_mtt_hierarchy_depth_intra_slice_chroma | ue(v) |
| if( sps_max_mtt_hierarchy_depth_intra_slice_chroma != 0 | |
| ) { | |
| sps_log2_diff_max_bt_min_qt_intra_slice_chroma | ue(v) |
| sps_log2_diff_max_tt_min_qt_intra_slice_chroma | ue(v) |
| } | |
| } | |
| sps_max_luma_transform_size_64_flag | u(1) |
| sps_joint_cbcr_enabled_flag | u(1) |
| if( ChromaArrayType != 0 ) { | |
| same_qp_table_for_chroma | u(1) |
| numQpTables = same_qp_table_for_chroma ? 1 : ( | |
| sps_joint_cbcr_enabled_flag ? 3 : 2 ) | |
| for( i = 0, i < numQpTables, i++ ) { | |
| qp_table_start_minus26[ i ] | se(v) |
| num_points_in_qp_table_minus1[ i ] | ue(v) |
| for( j = 0, j <= num_points_in_qp_table_minus1[ i ], j++ | |
| ) { | |
| delta_qp_in_val_minus1[ i ][ j ] | ue(v) |
| delta_qp_diff_val[ i ][ j ] | ue(v) |
| } | |
| } | |
| } | |
| sps_sao_enabled_flag | u(1) |
| sps_alf_enabled_flag | u(1) |
| if( sps_alf_enabled_flag && ChromaArrayType != 0 ) | |
| sps_ccalf_enabled_flag | u(1) |
| sps_transform_skip_enabled_flag | u(1) |
| if( sps_transform_skip_enabled_flag ) | |
| sps_bdpcm_enabled_flag | u(1) |
| if( sps_bdpcm_enabled_flag && chroma_format_idc = = | |
| 3 ) | |
| sps_bdpcm_chroma_enabled_flag | u(1) |
| sps_ref_wrap_around_enabled_flag | u(1) |
| if( sps_ref_wraparound_enabled_flag ) | |
| sps_ref_wrap_around_offset_minus1 | ue(v) |
| sps_temporal_mvp_enabled_flag | u(1) |
| if( sps_temporal_mvp_enabled_flag ) | |
| sps_sbtmvp_enabled_flag | u(1) |
| sps_amvr_enabled_flag | u(1) |
| sps_bdof_enabled_flag | u(1) |
| if( sps_bdof_enabled_flag ) | |
| sps_bdof_pic_present_flag | u(1) |
| sps_smvd_enabled_flag | u(1) |
| sps_dmvr_enabled_flag | u(1) |
| if( sps_dmvr_enabled_flag ) | |
| sps_dmvr_pic_present_flag | u(1) |
| sps_mmvd_enabled_flag | u(1) |
| sps_isp_enabled_flag | u(1) |
| sps_mrl_enabled_flag | u(1) |
| sps_mip_enabled_flag | u(1) |
| if( ChromaArrayType != 0 ) | |
| sps_cclm_enabled_flag | u(1) |
| if( chroma_format_idc = = 1 ) { | |
| sps_chroma_horizontal_collocated_flag | u(1) |
| sps_chroma_vertical_collocated_flag | u(1) |
| } | |
| sps_mts_enabled_flag | u(1) |
| if( sps_mts_enabled_flag ) { | |
| sps_explicit_mts_intra_enabled_flag | u(1) |
| sps_explicit_mts_inter_enabled_flag | u(1) |
| } | |
| sps_sbt_enabled_flag | u(1) |
| sps_affine_enabled_flag | u(1) |
| if( sps_affine_enabled_flag ) { | |
| sps_affine_type_flag | u(1) |
| sps_affine_amvr_enabled_flag | u(1) |
| sps_affine_prof_enabled_flag | u(1) |
| if( sps_affine_prof_enabled_flag ) | |
| sps_prof_pic_present_flag | u(1) |
| } | |
| if( chroma_format_idc = = 3 ) { | |
| sps_palette_enabled_flag | u(1) |
| sps_act_enabled_flag | u(1) |
| } | |
| sps_bcw_enabled_flag | u(1) |
| sps_ibc_enabled_flag | u(1) |
| sps_ciip_enabled_flag | u(1) |
| if( sps_mmvd_enabled_flag ) | |
| sps_fpel_mmvd_enabled_flag | u(1) |
| sps_triangle_enabled_flag | u(1) |
| sps_lmcs_enabled_flag | u(1) |
| sps_lfnst_enabled_flag | u(1) |
| sps_ladf_enabled_flag | u(1) |
| if( sps_ladf_enabled_flag ) { | |
| sps_num_ladf_intervals_minus2 | u(2) |
| sps_ladf_lowest_interval_qp_offset | se(v) |
| for( i = 0, i < sps_num_ladf_intervals_minus2 + 1, i++ ) { | |
| sps_ladf_qp_offset[ i ] | se(v) |
| sps_ladf_delta_threshold_minus1[ i ] | ue(v) |
| } | |
| } | |
| sps_scaling_list_enabled_flag | u(1) |
| sps_loop_filter_acrcoss_virtual_boundaries_disabled_present_flag | u(1) |
| if( | |
| sps_loop_filter_acrcoss_virtual_boundaries_disabled_present_flag ) { | |
| sps_num_ver_virtual_boundaries | u(2) |
| for( i = 0, i < sps_num_ver_virtual_boundaries, i++ ) | |
| sps_virtual_boundaries_pos_x[ i ] | u(13) |
| sps_num_hor_virtual_boundaries | u(2) |
| for( i = 0, i < sps_num_hor_virtual_boundaries, i++ ) | |
| sps_virtual_boundaries_pos_y[ i ] | u(13) |
| } | |
| if( sps_ptl_dpb_hrd_params_present_flag ) { | |
| sps_general_hrd_params_present_flag | u(1) |
| if( sps_general_hrd_params_present_flag ) { | |
| general_hrd_parameters( ) | |
| if( sps_max_sublayers_minus1 > 0 ) | |
| sps_sublayer_cpb_params_present_flag | u(1) |
| firstSubLayer = | |
| sps_sublayer_cpb_params_present_flag ? 0 : | |
| sps_max_sublayers_minus1 | |
| ols_hrd_parameters( firstSubLayer, | |
| sps_max_sublayers_minus1 ) | |
| } | |
| } | |
| field_seq_flag | u(1) |
| vui_parameters_present_flag | u(1) |
| if( vui_parameters_present_flag ) | |
| vui_parameters( ) /* Specified in ITU-T H.SEI \| ISO/IEC | |
| 23002-7 */ | |
| sps_extension_flag | u(1) |
| if( sps_extension_flag ) | |
| while( more_rbsp_data( ) ) | |
| sps_extension_data_flag | u(1) |
| rbsp_trailing_bits( ) | |
| } | |

As seen in the above table, the second syntax element sps_ccalf_enabled_flag is provided depending on the value of the first syntax element sps_alf_enabled_flag and optionally depending on a fourteenth syntax element, like ChromaArrayType. Further, the second syntax element may, in some embodiments, be signaled if the fourteenth syntax element takes a value that is different from zero.

SPS RBSP Syntax

| | Descriptor |
|---|---|
| seq_parameter_set_rbsp( ) { | |
| ...... | |
| sps_alf_enabled_flag | u(1) |
| if(sps_alf_enabled_flag && ChromaArrayType != 0 ) | |
| sps_ccalf_enabled_flag | u(1) |
| ....... | |

Notes: ChromaArrayType !=0, that is, it is not luma component and Cb, Cr chroma component

ChromaArrayType indicates the chroma sampling relative to the luma sampling as specified in the following table.

| ChromaArrayType | Chroma format |
|---|---|
| 0 | Monochrome |
| 1 | 4:2:0 |
| 2 | 4:2:2 |
| 3 | 4:4:4 |

In monochrome sampling there is only one sample array, which is nominally considered the luma array.

In 4:2:0 sampling, each of the two chroma arrays has half the height and half the width of the luma array.

In 4:2:2 sampling, each of the two chroma arrays has the same height and half the width of the luma array.

In 4:4:4 sampling, each of the two chroma arrays has the same height and width as the luma array.

As provided in the above table, the second syntax element is provided if the first syntax element indicates “true”, i.e. in the case the first syntax element is sps_alf_enabled_flag and indicates that ALF is to enabled. Furthermore, the second syntax element is provided if the fourteenth syntax element has a value that is not equal to 0.

SPS RBSP Syntax

| | Descriptor |
|---|---|
| seq_parameter_set_rbsp( ) { | |
| sps_decoding_parameter_set_id | u(4) |
| sps_video_parameter_set_id | u(4) |
| sps_max_sublayers_minus1 | u(3) |
| sps_reserved_zero_4bits | u(4) |
| sps_ptl_dpb_hrd_params_present_flag | u(1) |
| if( sps_ptl_dpb_hrd_params_present_flag ) | |
| profile_tier_level( 1, sps_max_sublayers_minus1 ) | |
| gdr_enabled_flag | u(1) |
| sps_seq_parameter_set_id | u(4) |
| chroma_format_idc | u(2) |
| if( chroma_format_idc == 3 ) | |
| separate_colour_plane_flag | u(1) |
| ref_pic_resampling_enabled_flag | u(1) |
| pic_width_max_in_luma_samples | ue(v) |
| pic_height_max_in_luma_samples | ue(v) |
| sps_log2_ctu_size_minus5 | u(2) |
| subpics_present_flag | u(1) |
| if( subpics_present_flag ) { | |
| sps_num_subpics_minus1 | u(8) |
| for( i = 0, i <= sps_num_subpics_minus1, i++ ) { | |
| subpic_ctu_top_left_x[ i ] | u(v) |
| subpic_ctu_top_left_y[ i ] | u(v) |
| subpic_width_minus1[ i ] | u(v) |
| subpic_height_minus1[ i ] | u(v) |
| subpic_treated_as_pic_flag[ i ] | u(1) |
| loop_filter_across_subpic_enabled_flag[ i ] | u(1) |
| } | |
| } | |
| sps_subpic_id_present_flag | u(1) |
| if( sps_subpics_id_present_flag ) { | |
| sps_subpic_id_signalling_present_flag | u(1) |
| if( sps_subpics_id_signalling_present_flag ) { | |
| sps_subpic_id_len_minus1 | ue(v) |
| for( i = 0, i <= sps_num_subpics_minus1, i++ ) | |
| sps_subpic_id[ i ] | u(v) |
| } | |
| } | |
| bit_depth_minus8 | ue(v) |
| min_qp_prime_ts_minus4 | ue(v) |
| sps_weighted_pred_flag | u(1) |
| sps_weighted_bipred_flag | u(1) |
| log2_max_pic_order_cnt_lsb_minus4 | u(4) |
| sps_poc_msb_flag | u(1) |
| if( sps_poc_msb_flag ) | |
| poc_msb_len_minus1 | ue(v) |
| if( sps_max_sublayers_minus1 > 0 ) | |
| sps_sublayer_dpb_params_flag | u(1) |
| if( sps_ptl_dpb_hrd_params_present_flag ) | |
| dpb_parameters( 0, sps_max_sublayers_minus1, | |
| sps_sublayer_dpb_params_flag ) | |
| long_term_ref_pics_flag | u(1) |
| inter_layer_ref_pics_present_flag | u(1) |
| sps_idr_rpl_present_flag | u(1) |
| rpl1_same_as_rpl0_flag | u(1) |
| for( i = 0, i < !rpl1_same_as_rpl0_flag ? 2 : 1, i++ ) { | |
| num_ref_pic_lists_in_sps[ i ] | ue(v) |
| for( j = 0, j < num_ref_pic_lists_in_sps[ i ], j++) | |
| ref_pic_list_struct( i, j ) | |
| } | |
| if( ChromaArrayType != 0 ) | |
| qtbtt_dual_tree_intra_flag | u(1) |
| log2_min_luma_coding_block_size_minus2 | ue(v) |
| partition_constraints_override_enabled_flag | u(1) |
| sps_log2_diff_min_qt_min_cb_intra_slice_luma | ue(v) |
| sps_log2_diff_min_qt_min_cb_inter_slice | ue(v) |
| sps_max_mtt_hierarchy_depth_inter_slice | ue(v) |
| sps_max_mtt_hierarchy_depth_intra_slice_luma | ue(v) |
| if( sps_max_mtt_hierarchy_depth_intra_slice_luma != 0 ) { | |
| sps_log2_diff_max_bt_min_qt_intra_slice_luma | ue(v) |
| sps_log2_diff_max_tt_min_qt_intra_slice_luma | ue(v) |
| } | |
| if( sps_max_mtt_hierarchy_depth_inter_slice != 0 ) { | |
| sps_log2_diff_max_bt_min_qt_inter_slice | ue(v) |
| sps_log2_diff_max_tt_min_qt_inter_slice | ue(v) |
| } | |
| if( qtbtt_dual_tree_intra_flag ) { | |
| sps_log2_diff_min_qt_min_cb_intra_slice_chroma | ue(v) |
| sps_max_mtt_hierarchy_depth_intra_slice_chroma | ue(v) |
| if( sps_max_mtt_hierarchy_depth_intra_slice_chroma != 0 | |
| ) { | |
| sps_log2_diff_max_bt_min_qt_intra_slice_chroma | ue(v) |
| sps_log2_diff_max_tt_min_qt_intra_slice_chroma | ue(v) |
| } | |
| } | |
| sps_max_luma_transform_size_64_flag | u(1) |
| sps_joint_cbcr_enabled_flag | u(1) |
| if( ChromaArrayType != 0 ) { | |
| same_qp_table_for_chroma | u(1) |
| numQpTables = same_qp_table_for_chroma ? 1 : ( | |
| sps_joint_cbcr_enabled_flag ? 3 : 2 ) | |
| for( i = 0, i < numQpTables, i++ ) { | |
| qp_table_start_minus26[ i ] | se(v) |
| num_points_in_qp_table_minus1[ i ] | ue(v) |
| for( j = 0, j <= num_points_in_qp_table_minus1[ i ], j++ | |
| ) { | |
| delta_qp_in_val_minus1[ i ][ j ] | ue(v) |
| delta_qp_diff_val[ i ][ j ] | ue(v) |
| } | |
| } | |
| } | |
| sps_sao_enabled_flag | u(1) |
| sps_alf_enabled_flag | u(1) |
| if( sps_alf_enabled_flag && ChromaArrayType != 0 ) | |
| sps_ccalf_enabled_flag | u(1) |
| sps_transform_skip_enabled_flag | u(1) |
| if( sps_transform_skip_enabled_flag ) | |
| sps_bdpcm_enabled_flag | u(1) |
| if( sps_bdpcm_enabled_flag && chroma_format_idc == | |
| 3 ) | |
| sps_bdpcm_chroma_enabled_flag | u(1) |
| sps_ref_wraparound_enabled_flag | u(1) |
| if( sps_ref_wraparound_enabled_flag ) | |
| sps_ref_wraparound_offset_minus1 | ue(v) |
| sps_temporal_mvp_enabled_flag | u(1) |
| if( sps_temporal_mvp_enabled_flag ) | |
| sps_sbtmvp_enabled_flag | u(1) |
| sps_amvr_enabled_flag | u(1) |
| sps_bdof_enabled_flag | u(1) |
| if( sps_bdof_enabled_flag) | |
| sps_bdof_pic_present_flag | u(1) |
| sps_smvd_enabled_flag | u(1) |
| sps_dmvr_enabled_flag | u(1) |
| if( sps_dmvr_enabled_flag) | |
| sps_dmvr_pic_present_flag | u(1) |
| sps_mmvd_enabled_flag | u(1) |
| sps_isp_enabled_flag | u(1) |
| sps_mrl_enabled_flag | u(1) |
| sps_mip_enabled_flag | u(1) |
| if( ChromaArrayType != 0 ) | |
| sps_cclm_enabled_flag | u(1) |
| if( chroma_format_idc == 1 ) { | |
| sps_chroma_horizontal_collocated_flag | u(1) |
| sps_chroma_vertical_collocated_flag | u(1) |
| } | |
| sps_mts_enabled_flag | u(1) |
| if( sps_mts_enabled_flag ) { | |
| sps_explicit_mts_intra_enabled_flag | u(1) |
| sps_explicit_mts_inter_enabled_flag | u(1) |
| } | |
| sps_sbt_enabled_flag | u(1) |
| sps_affine_enabled_flag | u(1) |
| if( sps_affine_enabled_flag ) { | |
| sps_affine_type_flag | u(1) |
| sps_affine_amyr_enabled_flag | u(1) |
| sps_affine_prof_enabled_flag | u(1) |
| if( sps_affine_prof_enabled_flag ) | |
| sps_prof_pic_present_flag | u(1) |
| } | |
| if( chroma_format_idc == 3 ) { | |
| sps_palette_enabled_flag | u(1) |
| sps_act_enabled_flag | u(1) |
| } | |
| sps_bcw_enabled_flag | u(1) |
| sps_ibc_enabled_flag | u(1) |
| sps_ciip_enabled_flag | u(1) |
| if( sps_mmvd_enabled_flag ) | |
| sps_fpel_mmvd_enabled_flag | u(1) |
| sps_triangle_enabled_flag | u(1) |
| sps_lmcs_enabled_flag | u(1) |
| sps_lfnst_enabled_flag | u(1) |
| sps_ladf_enabled_flag | u(1) |
| if( sps_ladf_enabled_flag ) { | |
| sps_num_ladf_intervals_minus2 | u(2) |
| sps_ladf_lowest_interval_qp_offset | se(v) |
| for( i = 0, i < sps_num_ladf_intervals_minus2 + 1, i++ ) { | |
| sps_ladf_qp_offset[ i ] | se(v) |
| sps_ladf_delta_threshold_minus1[ i ] | ue(v) |
| } | |
| } | |
| sps_scaling_list_enabled_flag | u(1) |
| sps_loop_filter_across_virtual_boundaries_disabled_present_flag | u(1) |
| if( | |
| sps_loop_filter_across_virtual_boundaries_disabled_present_flag ) { | |
| sps_num_ver_virtual_boundaries | u(2) |
| for( i = 0, i < sps_num_ver_virtual_boundaries, i++ ) | |
| sps_virtual_boundaries_pos_x[ i ] | u(13) |
| sps_num_hor_virtual_boundaries | u(2) |
| for( i = 0, i < sps_num_hor_virtual_boundaries, i++ ) | |
| sps_virtual_boundaries_pos_y[ i ] | u(13) |
| } | |
| if( sps_pd_dpb_hrd_params_present_flag ) { | |
| sps_general_hrd_params_present_flag | u(1) |
| if( sps_general_hrd_params_present_flag ) { | |
| general_hrd_parameters( ) | |
| if( sps_max_sublayers_minus1 > 0 ) | |
| sps_sublayer_cpb_params_present_flag | u(1) |
| firstSubLayer = | |
| sps_sublayer_cpb_params_present_flag ? 0 : | |
| sps_max_sublayers_minus1 | |
| ols_hrd_parameters( firstSubLayer, | |
| sps_max_sublayers_minus1 ) | |
| } | |
| } | |
| field_seq_flag | u(1) |
| vui_parameters_present_flag | u(1) |
| if( vui_parameters_present_flag ) | |
| vui_parameters( ) /* Specified in ITU-T H.SEI \| ISO/IEC | |
| 23002-7 */ | |
| sps_extension_flag | u(1) |
| if( sps_extension_flag ) | |
| while( more_rbsp_data( ) ) | |
| sps_extension_data_flag | u(1) |
| rbsp_trailing_bits( ) | |
| } | |

PPS RBSP Syntax

| | Descriptor |
|---|---|
| pic_parameter_set_rbsp(_) { | |
| pps_pic_parameter_set_id | ue(v) |
| pps_seq_parameter_set_id | u(4) |
| pic_width_in_luma_samples | ue(v) |
| pic_height_in_luma_samples | ue(v) |
| conformance_window_flag | u(1) |
| if( conformance_window_flag ) { | |
| conf_win_left_offset | ue(v) |
| conf_win_right_offset | ue(v) |
| conf_win_top_offset | ue(v) |
| conf_win_bottom_offset | ue(v) |
| } | |
| scaling_window_flag | u(1) |
| if( scaling_window_flag ) { | |
| scaling_win_left_offset | ue(v) |
| scaling_win_right_offset | ue(v) |
| scaling_win_top_offset | ue(v) |
| scaling_win_bottom_offset | ue(v) |
| } | |
| output_flag_present_flag | u(1) |
| mixed_nalu_types_in_pic_flag | u(1) |
| pps_subpic_id_signalling_present_flag | u(1) |
| if( pps_subpics_id_signalling_present_flag ) { | |
| pps_num_subpics_minus1 | ue(v) |
| pps_subpic_id_len_minus1 | ue(v) |
| for( i = 0, i <= pps_num_subpic_minus1, i++ ) | |
| pps_subpic_id[ i ] | u(v) |
| } | |
| no_pic_partition_flag | u(1) |
| if( !no_pic_partition_flag ) { | |
| pps_log2_ctu_size_minus5 | u(2) |
| num_exp_tile_columns_minus1 | ue(v) |
| num_exp_tile_rows_minus1 | ue(v) |
| for( i = 0, i <= num_exp_tile_columns_minus1, i++ ) | |
| tile_column_width_minus1[ i] | ue(v) |
| for( i = 0, i <= num_exp_tile_rows_minus1, i++ ) | |
| tile_row_height_minus1[ i ] | ue(v) |
| rect_slice_flag | u(1) |
| if( rect_slice_flag ) | |
| single_slice_per_subpic_flag | u(1) |
| if( rect_slice_flag && !single slice_per_subpic_flag ) { | |
| num_slices_in_pic_minus1 | ue(v) |
| tile_idx_delta_present_flag | u(1) |
| for( i = 0, i < num_slices_in_pic_minus1, i++ ) { | |
| slice_width_in_tiles_minus1[ i ] | ue(v) |
| slice_height_in_tiles_minus1[ i ] | ue(v) |
| if( slice_width_in_tiles_minus1[ i ] == 0 | |
| && | |
| slice_height_in_tiles_minus1[ i ] == 0 ) { | |
| num_slices_in_tile_minus1[ i ] | ue(v) |
| numSlicesInTileMinus1 = | |
| num_slices_in_tile_minus1[ i ] | |
| for( j = 0, j < numSlicesInTileMinus1, j++ | |
| ) | |
| slice_height_in_ctu_minus1[ i++ ] | ue(v) |
| } | |
| if( tile_idx_delta_present_flag && i < | |
| num_slices_in_pic_minus1 ) | |
| tile_idx_delta[ i ] | se(v) |
| } | |
| } | |
| loop_filter_across_tiles_enabled_flag | u(1) |
| loop_filter_across_slices_enabled_flag | u(1) |
| } | |
| entropy_coding_sync_enabled_flag | u(1) |
| if( !no_pic_partition_flag \| \| | |
| entropy_coding_sync_enabled_flag ) | |
| entry_point_offsets_present_flag | u(1) |
| cabac_init_present_flag | u(1) |
| for( i = 0, i < 2, i++ ) | |
| num_ref_idx_default_active_minus1[ i ] | ue(v) |
| rpl1_idx_present_flag | u(1) |
| init_qp_minus26 | se(v) |
| log2_transform_skip_max_size_minus2 | ue(v) |
| cu_qp_delta_enabled_flag | u(1) |
| pps_cb_qp_offset | se(v) |
| pps_cr_qp_offset | se(v) |
| pps_joint_cbcr_qp_offset_present_flag | u(1) |
| if( pps_joint_cbcr_qp_offset_present_flag ) | |
| pps_joint_cbcr_qp_offset_value | se(v) |
| pps_slice_chroma_qp_offsets_present_flag | u(1) |
| pps_cu_chroma_qp_offset_list_enabled_flag | u(1) |
| if( pps_cu_chroma_qp_offset_list_enabled_flag ) { | |
| chroma_qp_offset_list_len_minus1 | ue(v) |
| for( i = 0, i <= chroma_qp_offset_list_len_minus1, i++ ) { | |
| cb_qp_offset_list[ i ] | se(v) |
| cr_qp_offset_list[ i ] | se(v) |
| if( pps_joint_cbcr_qp_offset_present_flag ) | |
| joint_cbcr_qp_offset_list[ i ] | se(v) |
| } | |
| } | |
| pps_weighted_pred_flag | u(1) |
| pps_weighted_bipred_flag | u(1) |
| alf_present_in_ph_flag | |
| | u(1) |
| deblocking_filter_control_present_flag | u(1) |
| if( deblocking_filter_control_present_flag ) { | |
| deblocking_filter_override_enabled_flag | u(1) |
| pps_deblocking_filter_disabled_flag | u(1) |
| if( !pps_deblocking_filter_disabled_flag ) { | |
| pps_beta_offset_div2 | se(v) |
| pps_tc_offset_div2 | se(v) |
| } | |
| } | |
| constant_slice_header_params_enabled_flag | u(1) |
| if( constant_slice_header_params_enabled_flag ) { | |
| pps_dep_quant_enabled_idc | u(2) |
| for( i = 0, i < 2, i++ ) | |
| pps_ref_pic_list_sps_idc[ i ] | u(2) |
| pps_mvd_l1_zero_idc | u(2) |
| pps_collocated_from_l0_idc | u(2) |
| pps_six_minus_max_num_merge_cand_plus1 | ue(v) |
| | ue(v) |
| pps_max_num_merge_cand_minus_max_num_triangle_cand_plus1 | |
| } | |
| picture_header_extension_present_flag | u(1) |
| slice_header_extension_present_flag | u(1) |
| pps_extension_flag | u(1) |
| if( pps_extension_flag ) | |
| while(_more_rbsp_data( ) ) | |
| pps_extension_data_flag | u(1) |
| rbsp_trailing_bits( ) | |
| } | |

General Constraint Information Syntax

| | Descriptor |
|---|---|
| general_constraint_info( ) { | |
| general_progressive_source_flag | u(1) |
| general_interlaced_source_flag | u(1) |
| general_non_packed_constraint_flag | u(1) |
| general_frame_only_constraint_flag | u(1) |
| intra_only_constraint_flag | u(1) |
| max_bitdepth_constraint_idc | u(4) |
| max_chroma_format_constraint_idc | u(2) |
| frame_only_constraint_flag | u(1) |
| no_qtbtt_dual_tree_intra_constraint_flag | u(1) |
| no_partition_constraints_override_constraint_flag | u(1) |
| no_sao_constraint_flag | u(1) |
| no_alf_constraint_flag | u(1) |
| no_ccalf_constraint_flag | u(1) |
| no_joint_cbcr_constraint_flag | u(1) |
| no_ref_wraparound_constraint_flag | u(1) |
| no_temporal_mvp_constraint_flag | u(1) |
| no_sbtmvp_constraint_flag | u(1) |
| no_amvr_constraint_flag | u(1) |
| no_bdof_constraint_flag | u(1) |
| no_dmvr_constraint_flag | u(1) |
| no_cclm_constraint_flag | u(1) |
| no_mts_constraint_flag | u(1) |
| no_sbt_constraint_flag | u(1) |
| no_affine_motion_constraint_flag | u(1) |
| no_bcw_constraint_flag | u(1) |
| no_ibc_constraint_flag | u(1) |
| no_ciip_constraint_flag | u(1) |
| no_fpel_mmvd_constraint_flag | u(1) |
| no_triangle_constraint_flag | u(1) |
| no_ladf_constraint_flag | u(1) |
| no_transform_skip_constraint_flag | u(1) |
| no_bdpcm_constraint_flag | u(1) |
| no_qp_delta_constraint_flag | u(1) |
| no_dep_quant_constraint_flag | u(1) |
| no_sign_data_hiding_constraint_flag | u(1) |
| no_mixed_nalu_types_in_pic_constraint_flag | u(1) |
| no_trail_constraint_flag | u(1) |
| no_stsa_constraint_flag | u(1) |
| no_rasl_constraint_flag | u(1) |
| no_radl_constraint_flag | u(1) |
| no_idr_constraint_flag | u(1) |
| no_cra_constraint_flag | u(1) |
| no_gdr_constraint_flag | u(1) |
| no_aps_constraint_flag | u(1) |
| while( !byte_aligned( ) ) | |
| gci_alignment_zero_bit | f(1) |
| num_reserved_constraint_bytes | u(8) |
| for( i = 0, i < num_reserved_constraint_bytes, i++ ) | |
| gci_reserved_constraint_byte[ i ] | u(8) |
| } | |

7.3.3.2 General Constraint Information Syntax

| | Descriptor |
|---|---|
| general constraint info( ) { | |
| .... | |
| no_alf_constraint_flag | u(1) |
| if (!no_alf_constraint_flag) | |
| no_ccalf_constraint_flag | u(1) |

Notes:

!(0)=1

!(1)=0

PPS RBSP Syntax

Picture Header RBSP Syntax:

| | Descriptor |
|---|---|
| picture_header_rbsp( ) { | |
| non_reference_picture_flag | u(1) |
| gdr_pic_flag | u(1) |
| no_output_of_prior_pics_flag | u(1) |
| if( gdr_pic_flag ) | |
| recovery_poc_cnt | ue(v) |
| ph_pic_parameter_set_id | ue(v) |
| if( sps_poc_msb_flag ) { | |
| ph_poc_msb_present_flag | u(1) |
| if( ph_poc_msb_present_flag ) | |
| poc_msb_val | u(v) |
| } | |
| if ( sps_subpic_id_present_flag && | |
| !sps_subpic_id_signalling_flag ) { | |
| ph_subpic_id_signalling_present_flag | u(1) |
| if( ph_subpics_id_signalling_present_flag ) { | |
| ph_subpic_id_len_minus1 | ue(v) |
| for( i = 0, i <= sps_num_subpics_minus1, i++ ) | |
| ph_subpic_id[ i ] | u(v) |
| } | |
| } | |
| if( | |
| !sps_loop_filter_across_virtual_boundaries_disabled_present_flag ) { | |
| | u(1) |
| ph_loop_filter_across_virtual_boundaries_disabled_present_flag | |
| if( | |
| ph_loop_filter_across_virtual_boundaries_disabled_present_flag ) { | |
| ph_num_ver_virtual_boundaries | u(2) |
| for( i = 0, i < ph_num_ver_virtual_boundaries, i++ ) | |
| ph_virtual_boundaries_pos_x[ i ] | u(13) |
| ph_num_hor_virtual_boundaries | u(2) |
| for( i = 0, i < ph_num_hor_virtual_boundaries, i++ ) | |
| ph_virtual_boundaries_pos y[ i ] | u(13) |
| } | |
| } | |
| if( separate_colour_plane_flag == 1 ) | |
| colour_plane_id | u(2) |
| if( output_flag_present_flag ) | |
| pic_output_flag | u(1) |
| pic_rpl_present_flag | u(1) |
| if( pic_rpl_present_flag ) { | |
| for( i = 0, i < 2, i++ ) { | |
| if( num_ref_pic_lists_in_sps[ i ] > 0 | |
| && !pps_ref_pic_list_sps_idc[ i ] && | |
| ( i == 0 \| \| ( i == 1 | |
| && rpl1_idx_present_flag ) ) ) | |
| pic_rpl_sps_flag[ i ] | u(1) |
| if( pic_rpl_sps_flag[ i ] ) { | |
| if( num_ref_pic_lists_in_sps[ i ] > 1 && | |
| ( i == 0 \| \| ( i | |
| == 1 &&_rpl1_idx_present_flag ) ) ) | |
| pic_rpl_idx[ i ] | u(v) |
| } else | |
| ref_pic_list_struct( i, | |
| num_ref_pic_lists_in_sps[ i ] ) | |
| for( j = 0, j < NumLtrpEntries[ i ][ RplsIdx[ i ] ], j++ ) { | |
| if( ltrp_in_slice_header_flag[ i ][ RplsIdx[ i ] ] ) | |
| pic_poc_lsb_lt[ i ][ j ] | u(v) |
| pic_delta_poc_msb_present_flag[ i ][ j ] | u(1) |
| if( pic_delta_poc_msb_present_flag[ i ][ j ] ) | |
| pic_delta_poc_msb_cycle_lt[ i ][ j ] | ue(v) |
| } | |
| } | |
| } | |
| if( partition_constraints_override_enabled_flag ) { | |
| partition_constraints_override_flag | u(1) |
| if( partition_constraints_override_flag ) { | |
| pic_log2_diff_min_qt_min_cb_intra_slice_luma | ue(v) |
| pic_log2_diff_min_qt_min_cb_inter_slice | ue(v) |
| pic_max_mtt_hierarchy_depth_inter_slice | ue(v) |
| pic_max_mtt_hierarchy_depth_intra_slice_luma | ue(v) |
| if( pic_max_mtt_hierarchy_depth_intra_slice_luma | |
| != 0 ) { | |
| | ue(v) |
| pic_log2_diff_max_bt_min_qt_intra_slice_luma | |
| pic_log2_diff_max_tt_min_qt_intra_slice_luma | ue(v) |
| } | |
| if( pic_max_mtt_hierarchy_depth_inter_slice != 0 ) | |
| { | |
| pic_log2_diff_max_bt_min_qt_inter_slice | ue(v) |
| pic_log2_diff_max_tt_min_qt_inter_slice | ue(v) |
| } | |
| if( qtbtt_dual_tree_intra_flag ) { | |
| | ue(v) |
| pic_log2_diff_min_qt_min_cb_intra_slice_chroma | |
| | ue(v) |
| pic_max_mtt_hierarchy_depth_intra_slice_chroma | |
| if( | |
| pic_max_mtt_hierarchy_depth_intra_slice_chroma != 0 ) { | |
| | ue(v) |
| pic_log2_diff_max_bt_min_qt_intra_slice_chroma | |
| | ue(v) |
| pic_log2_diff_max_tt_min_qt_intra_slice_chroma | |
| } | |
| } | |
| } | |
| } | |
| if( cu_qp_delta_enabled_flag ) { | |
| pic_cu_qp_delta_subdiv_intra_slice | ue(v) |
| pic_cu_qp_delta_subdiv_inter_slice | ue(v) |
| } | |
| if( pps_cu_chroma_qp_offset_list_enabled_flag ) { | |
| pic_cu_chroma_qp_offset_subdiv_intra_slice | ue(v) |
| pic_cu_chroma_qp_offset_subdiv_inter_slice | ue(v) |
| } | |
| if( sps_temporal_mvp_enabled_flag ) | |
| pic_temporal_mvp_enabled_flag | u(1) |
| if(!pps_mvd_l1_zero_idc ) | |
| mvd_l1_zero_flag | u(1) |
| if( !pps_six_minus_max_num_merge_cand_plus1 ) | |
| pic_six_minus_max_num_merge_cand | ue(v) |
| if( sps_affine_enabled_flag ) | |
| pic_five_minus_max_num_subblock_merge_cand | ue(v) |
| if( sps_fpel_mmvd_enabled_flag ) | |
| pic_fpel_mmvd_enabled_flag | u(1) |
| if( sps_bdof_pic_present_flag ) | |
| pic_disable_bdof_flag | u(1) |
| if( sps_dmvr_pic_present_flag ) | |
| pic_disable_dmvr_flag | u(1) |
| if( sps_prof_pic_present_flag ) | |
| pic_disable_prof_flag | u(1) |
| if( sps_triangle_enabled_flag && MaxNumMergeCand >= 2 | |
| && | |
| !pps_max_num_merge_cand_minus_max_num_triangle_cand_plu | |
| s1 ) | |
| pic_max_num_merge_cand_minus_max_num_triangle_cand | ue(v) |
| if ( sps_ibc_enabled_flag ) | |
| pic_six_minus_max_num_ibc_merge_cand | ue(v) |
| if( sps_joint_cbcr_enabled_flag ) | |
| pic_joint_cbcr_sign_flag | u(1) |
| if( sps_sao_enabled_flag ) { | |
| pic_sao_enabled_present_flag | u(1) |
| if( pic_sao_enabled_present_flag ) { | |
| pic_sao_luma_enabled_flag | u(1) |
| if(ChromaArrayType != 0 ) | |
| pic_sao_chroma_enabled_flag | u(1) |
| } | |
| } | |
| if( sps_alf_enabled_flag && alf_present_in_ph_flag ) { | |
| [symbol] [symbol] | [symbol] |
| [symbol] [symbol] | |
| pic_alf_enabled_flag | u(1) |
| if( pic_alf_enabled_flag ) { | |
| pic_num_alf_aps_ids_luma | u(3) |
| for( i = 0, i < pic_num_alf_aps_ids_luma, i++ ) | |
| pic_alf_aps_id_luma[ i ] | u(3) |
| if( ChromaArrayType != 0 ) | |
| pic_alf_chroma_idc | u(2) |
| if( pic_alf_chroma_idc ) | |
| pic_alf_aps_id_chroma | u(3) |
| [symbol] | |
| [symbol] [symbol] | |
| if (sps_ccalf_enabled_flag ) { | |
| pic_cross_component_alf_cb_enabled_flag | u(1) |
| if( pic_cross_component_alf_cb_enabled_flag ) | |
| { | |
| pic_cross_component_alf_cb_aps_id | u(3) |
| ——————— | [symbol] |
| [symbol] [symbol] | |
| } | |
| [symbol] [symbol] | u(1) |
| pic_cross_component_alf_cr_enabled_flag | |
| if( pic_cross_component_alf_cr_enabled_flag ) | |
| { | |
| pic_cross_component_alf_cr_aps_id | u(3) |
| ———— | [symbol] |
| [symbol] [symbol] | |
| } | |
| } | |
| } | |
| } | |
| if( !pps_dep_quant_enabled_flag ) | |
| pic_dep_quant_enabled_flag | u(1) |
| if( !pic_dep_quant_enabled_flag ) | |
| sign_data_hiding_enabled_flag | u(1) |
| if( deblocking_filter_override_enabled_flag ) { | |
| pic_deblocking_filter_override_present_flag | u(1) |
| if( pic_deblocking_filter_override_present_flag ) { | |
| pic_deblocking_filter_override_flag | u(1) |
| if( pic_deblocking_filter_override_flag ) { | |
| pic_deblocking_filter_disabled_flag | u(1) |
| if( !pic_deblocking_filter_disabled_flag ) { | |
| pic_beta_offset_div2 | se(v) |
| pic_tc_offset_div2 | se(v) |
| } | |
| } | |
| } | |
| } | |
| if( sps_lmcs_enabled_flag ) { | |
| pic_lmcs_enabled_flag | u(1) |
| if( pic_lmcs_enabled_flag ) { | |
| pic_lmcs_aps_id | u(2) |
| if( ChromaArrayType != 0 ) | |
| pic_chroma_residual_scale_flag | u(1) |
| } | |
| } | |
| if( sps_scaling_list_enabled_flag ) { | |
| pic_scaling_list_present_flag | u(1) |
| if( pic_scaling_list_present_flag ) | |
| pic_scaling_list_aps_id | u(3) |
| } | |
| if( picture_header_extension_present_flag ) { | |
| ph_extension_length | ue(v) |
| for( i = 0, i < ph_extension_length, i++) | |
| ph_extension_data_byte[ i ] | u(8) |
| } | |
| rbsp_trailing_bits( ) | |
| } | |

| | Descriptor |
|---|---|
| pic_parameter_set_rbsp( ) { | |
| .... | |
| if (sps_alf_enabled_flag) | |
| alf_present_in_ph_flag | u(1) |
| deblocking_filter_control_present_flag | u(1) |
| if( deblocking_filter_control_present_flag ) { | |
| ....... | |

alf_present_in_ph_flag equal to 1 specifies the syntax elements for enabling ALF use may be present in the PHs (picture headers) referring to the PPS. alf_present_in_ph_flag equal to 0 specifies the syntax elements for enabling ALF use may be present in the slice headers referring to the PPS.

Picture Header RBSP Syntax:

| picture_header_rbsp( ) { | Descriptor |
|---|---|
| if( sps_alf_enabled_flag && alf_present_in_ph_flag) { | |
| pic_alf_enabled_flag | u(1) |
| if( pic_alf_enabled_flag) { | |
| pic_num_alf_aps_ids_luma | u(3) |
| for( i = 0, i < pic_num_alf_aps_ids_luma, i++) | |
| pic_alf_aps_id_luma[ i ] | u(3) |
| if( ChromaArrayType != 0) | |
| pic_alf_chroma_idc | u(2) |
| if( pic_alf_chroma_idc ) | |
| pic_alf_aps_id_chroma | u(3) |
| if( sps_ccalf_enabled_flag) { | |
| pic_cross_component_alf_cb_enabled_flag | u(1) |
| if( pic_cross_component_alf_cb_enabled_flag ) { | |
| pic_cross_component_alf_cb_aps_id | u(3) |
| } | |
| pic_cross_component_alf_cr_enabled_flag | u(1) |
| if( pic_cross_component_alf_cr_enabled_flag) { | |
| pic_cross_component_alf_cr_aps_id | u(3) |
| } | |
| } /* end of sps_ccalf_enabled_flag */ | |
| } /* end of pic_alf_enabled_flag */ | |
| } /* end of (sps_alf_enabled_flag && alf_present_in_ph_flag) */ | |

As provided in the above table, the presence of further syntax elements pertaining to CC-ALF in the picture header, like a fourth syntax element (like pic_cross_component_alf_cb_enabled_flag), and a seventh syntax element (like for example pic_cross_component_alf_cr_enabled_flag), may depend on the presence and/or value of the second syntax element. The presence of a fifth syntax element, like pic_cross_component_alf_cb_aps_id may then depend on the second syntax element and/or the presence and/or value of the fourth syntax element, whereas presence and/or value of an eighth syntax element, like pic_cross_component_alf_cr_aps_id, may depend on the presence and/value of the second syntax element and/or presence and/or value of the seventh syntax element.

General Slice Header Syntax:

| slice_header( ) { | Descriptor |
|---|---|
| if( sps_alf_enabled_flag && !alf_present_in_ph_flag) { | |
| slice_alf_enabled_flag | u(1) |
| if( slice_alf_enabled_flag) { | |
| slice_num_alf_aps_ids_luma | u(3) |
| for( i = 0, i < slice_num_alf_aps_ids_luma, i++) | |
| slice_alf_aps_id_luma[ i ] | u(3) |
| if( ChromaArrayType != 0) | |
| slice_alf_chroma_idc | u(2) |
| if( slice_alf_chroma_idc ) | |
| slice_alf_aps_id_chroma | u(3) |
| if( sps_ccalf_enabled_flag) { | |
| slice_cross_component_alf_cb_enabled_flag | u(1) |
| if( slice_cross_component_alf_cb_enabled_flag) { | |
| slice_cross_component_alf_cb_aps_id | u(3) |
| } | |
| slice_cross_component_alf_cr_enabled_flag | u(1) |
| if( slice_cross_component_alf_cr_enabled_flag) { | |
| slice_cross_component_alf_cr_aps_id | u(3) |
| } | |
| } /* end of sps_ccalf_enabled_flag */ | |
| } /* end of slice_alf_enabled_flag */ | |
| } /* end of (sps_alf_enabled_flag && !alf_present_in_ph_flag) */ | |

In the above table, further syntax elements pertaining to CC-ALF may further depend on the presence and/value of the second syntax element. For example, a tenth syntax element, like slice_cross_component_alf_cb_enabled_flag, may be provided depending on the second syntax element. Depending on the presence and/value of this tenth syntax element and/or the second syntax element, an eleventh syntax element, like slice_cross_component_alf_cb_aps_id, may be provided. Furthermore, a twelfth syntax element, like slice_cross_component_alf_cr_enabled_flag may be provided in the slice header depending on the value of the second syntax element. Depending on the presence and/or value of the twelfth syntax element and/or depending on the second syntax element, a thirteenth syntax element, like slice_cross_component_alf_cr_aps_id, may be provided in the slice header.

Notes:

!(0)=1

! (1)=0

if(sps_alf_enabled_flag && ! alf_present_in_ph_flag) means “if sps_alf_enabled_flag is true (and) if alf_present_in_ph_flag is false)”

Slice Header Syntax:

General Slice Header Syntax:

| slice_header( ) { | Descriptor |
|---|---|
| slice_pic_order_cnt_lsb | u(v) |
| if( subpics_present_flag) | |
| slice_subpic_id | u(v) |
| if( rect_slice_flag \| \| NumTilesInPic > 1) | |
| slice_address | u(v) |
| if( !rect_slice_flag && NumTilesInPic > 1) | |
| num_tiles_in_slice_minus1 | ue(v) |
| slice_type | ue(v) |
| if( !pic_rpl_present_flag &&( ( nal_unit_type != | |
| IDR_W_RADL && nal_unit_type != | |
| IDR_N_LP ) \| \| | |
| sps_idr_rpl_present_flag ) ) { | |
| for( i = 0, i < 2, i++) { | |
| if( num_ref_pic_lists_in_sps[ i ] > 0 | |
| && !pps_ref_pic_list_sps_idc[ i ] && | |
| ( i = = | |
| 0 \| \| ( i = = 1 && rpl_1_idx_present_flag ) ) ) | |
| slice_rpl_sps_flag[ i ] | u(1) |
| if( slice_rpl_sps_flag[ i ] ) { | |
| if( num_ref_pic_lists_in_sps[ i ] > 1 && | |
| ( i = = 0 \| \| | |
| ( i = = 1 && rpl1_idx_present_flag ) ) ) | |
| slice_rpl_idx[ i ] | u(v) |
| } else | |
| ref_pic_list struct( i, | |
| num_ref_pic_lists_in_sps[ i ] ) | |
| for( j = 0, j < NumLtrpEntries[ i ][ RplsIdx[ i] ], j++) { | |
| if( ltrp_in_slice_header_flag[ i ][ RplsIdx[ i ] ] ) | |
| slice_poc_lsb_lt[ i ][ j ] | u(v) |
| slice_delta_poc_msb_present_flag[ i ][ j ] | u(1) |
| if( slice_delta_poc_msb_present_flag[ i ][ j ] ) | |
| slice_delta_poc_msb_cycle_lt[ i ][ j ] | ue(v) |
| } | |
| } | |
| } | |
| if( pic_rpl_present_flag \| \| ( ( nal_unit_type != | |
| IDR_W_RADL && nal_unit_type != | |
| IDR_N_LP ) \| \| sps_idr_rpl_present_flag ) ) | |
| { | |
| if( ( slice_type != I && | |
| num_ref_entries[ 0 ][ RplsIdx[ 0 ] ] > 1) \| \| | |
| ( slice_type = = B && | |
| num_ref_entries[ 1 ][ RplsIdx[ 1 ] ] > 1 ) ) { | |
| num_ref_idx_active_override_flag | u(1) |
| if( num_ref_idx_active_override_flag ) | |
| for( i = 0, i < ( slice_type = = B ? 2: 1), i++) | |
| if( num_ref_entries[ i ][ RplsIdx[ i ] ] > 1) | |
| num_ref_idx_active_minus1[ i ] | ue(v) |
| } | |
| } | |
| if( slice_type != I ){ | |
| if( cabac_init_present_flag ) | |
| cabac_init_flag | u(1) |
| if( pic_temporal_mvp_enabled_flag) { | |
| if( slice_type = = B | |
| && !pps_collocated_from_10_idc ) | |
| collocated_from_10_flag | u(1) |
| if( ( collocated_from_10_flag && | |
| NumRefldxActive[ 0 ] > 1) \| \| | |
| ( !collocated_from_10_flag && | |
| NumRefldxActive[ 1 ] > 1 ) ) | |
| collocated_ref_idx | ue(v) |
| } | |
| if( ( pps_weighted_pred_flag && slice_type = = P) \| \| | |
| ( pps_weighted_bipred_flag && slice_type = = B ) ) | |
| pred_weight_table( ) | |
| } | |
| slice_qp_delta | se(v) |
| if( pps_slice_chroma_qp_offsets_present_flag) { | |
| slice_cb_qp_offset | se(v) |
| slice_cr_qp_offset | se(v) |
| if( sps_joint_cbcr_enabled_flag) | |
| slice_joint_cbcr_qp_offset | se(v) |
| } | |
| if( pps_cu_chroma_qp_offset_list_enabled_flag ) | |
| cu_chroma_qp_offset_enabled_flag | u(1) |
| if( sps_sao_enabled_flag && !pic_sao_enabled_present_flag ) | |
| { | |
| slice_sao_luma_flag | u(1) |
| if( ChromaArrayType != 0) | |
| slice_sao_chroma_flag | u(1) |
| } | |
| if( sps_alf_enabled_flag && !alf_present_in_ph_flag | |
| [symbol] [symbol] ) { | |
| slice_alf_enabled_flag | u(1) |
| if( slice_alf_enabled_flag) { | |
| slice_num_alf_aps_ids_luma | u(3) |
| for( i = 0, i < slice_num_alf_aps_ids_luma, i++) | |
| slice_alf_aps_id_luma[ i ] | u(3) |
| if( ChromaArrayType != 0) | |
| slice_alf_chroma_idc | u(2) |
| if( slice_alf_chroma_idc ) | |
| slice_alf_aps_id_chroma | u(3) |
| [symbol] | |
| if (sps_ccalf_enabled_flag) { | |
| [symbol] [symbol] | |
| slice_cross_component_alf_cb_enabled_flag | u(1) |
| if( slice_cross_component_alf_cb_enabled_flag ) { | |
| slice_cross_component_alf_cb_aps_id | u(3) |
| [symbol] [symbol] [symbol] | [symbol] |
| } | |
| [symbol] [symbol] | |
| slice_cross_component_alf_cr_enabled_flag | u(1) |
| if( slice_cross_component_alf_cr_enabled_flag ) { | |
| slice_cross_component_alf_cr_aps_id | u(3) |
| [symbol] [symbol] | [symbol] |
| } | |
| } | |
| } | |
| } | |
| if( deblocking_filter_override_enabled_flag && | |
| !pic_deblocking_filter_override_present_flag ) | |
| slice_deblocking_filter_override_flag | u(1) |
| if( slice_deblocking_filter_override_flag) { | |
| slice_deblocking_filter_disabled_flag | u(1) |
| if( !slice_deblocking_filter_disabled_flag) { | |
| slice_beta_offset_div2 | se(v) |
| slice_tc_offset_div2 | se(v) |
| } | |
| } | |
| if( entry_point_offsets_present_flag && NumEntryPoints > 0) | |
| { | |
| offset_len_minus1 | ue(v) |
| for( i = 0, i < NumEntryPoints, i++) | |
| entry_point_offset_minus1[ i ] | u(v) |
| } | |
| if( slice_header_extension_present_flag ) { | |
| slice_header_extension_length | ue(v) |
| for( i = 0, i < slice_header_extension_length, i++) | |
| slice_header_extension_data_byte[ i ] | u(8) |
| } | |
| byte_alignment( ) | |
| } | |

In the above table, some elements are shown as strike-through. This is meant to say that, in a first embodiment, these elements may be present. In an alternative embodiment, these elements may be cancelled, leaving the remaining syntax the way it is. For example, the element ChromaArrayType may not be provided. Correspondingly, any dependency from this element, also including the conditional presence of other syntax elements, may be provided in a first embodiment. In an alternative embodiment, this dependency does not exist, resulting, for example, in syntax elements being present in any case while, in the alternative embodiment, they were only present if ChromaArrayType had a specific value.

Likewise, syntax elements like slice_cross_component_cr_filters_signalled_minus1 and slice_cross_component_cb_filters_signalled_minus1 may not be provided at all (independent of whether a syntax element like ChromaArrayType would be present).

The semantics of the newly introduced syntax elements are as follows.

The value of the second syntax element, like (sps_ccalf_enabled_flag) equal to 0 specifies that the CC-ALF is disabled. The value of the first syntax element equal to 1 specifies that the CC-ALF is enabled. This may also be provided the other way around, i.e. if the second syntax element has a value equal to 1, CC-ALF may be disabled whereas, if the second syntax element has a value equal to 0, CC-ALF may be enabled.

no_ccalf_constraint_flag equal to 1 specifies that the first syntax element (like sps_ccalf_enabled_flag) shall be equal to 0. no_ccalf_constraint_flag equal to 0 does not impose such a constraint.

In the embodiments, a filtering process is presented as below in details.

For the above discussed embodiments, some general remarks are made below regarding the meaning of specific syntax elements and the consequences of these syntax elements taking specific values. The disclosure presented below is intended to be encompassed by any of the above embodiments, the alternative embodiments 1 to 5.

8.8 In-Loop Filter Process:

8.8.1 General

. . .

4. When the first syntax element (denoted above as sps_alf_enabled_flag) is equal to 1, the following applies. When the second syntax element (like sps_ccalf_enabled_flag) is equal to 1, the reconstructed picture sample array (before adaptive loop filter) SL′ is set equal to the reconstructed picture sample array SL The adaptive loop filter process as specified in clause 8.8.5.1 is invoked with the reconstructed picture sample array SL and, when the fourteenth syntax element (in the above tables, this is denoted as ChromaArrayType) is not equal to 0, the arrays S_{Cb} and S_{Cr} as inputs, and the modified reconstructed picture sample array S′L and, when the fourteenth syntax element is not equal to 0, the arrays S′_{Cb} and S′_{Cr} after adaptive loop filer as outputs. The array S′_{L} and, when the fourteenth syntax element is not equal to 0, the arrays S′_{Cb} and S′_{Cr} are assigned to the array SL and, when the fourteenth syntax element is not equal to 0, the arrays S_{Cb} and S_{Cr} (which represent the decoded picture), respectively. When the second syntax element (like sps_ccalf_enabled_flag) is equal to 1, the following applies. The CC-ALF process as specified in clause x.x.x.x is invoked with the reconstructed picture sample array S_{L} and, when the fourteenth syntax element (like ChromaArrayType) is not equal to 0, the arrays S_{Cb} and S_{Cr} as inputs, and the modified reconstructed picture sample array S′_{L} and, when the fourteenth syntax element is not equal to 0, the arrays S′_{Cb} and S′_{Cr} after cross component adaptive loop filer as outputs. The array S′_{L} and, when the fourteenth syntax element is not equal to 0, the arrays S′_{Cb} and S′_{Cr} are assigned to the array S_{L} and, when the fourteenth syntax element is not equal to 0, the arrays S_{Cb} and S_{Cr} (which represent the decoded picture), respectively.

It should be noted that the present disclosure is not limited to the alternatives presented here, but rather the disclosure in a very generic way allows the CC-ALF data present in the slice header to be conditionally signaled in the picture header. The main advantage of using CC-ALF data in the picture header is that the signal overhead in the slice header is reduced.

The disclosure also covers the case when a particular CC-ALF syntax element signaled in the slice header has the same value across all the slices (for e.g. due to some bitstream conformance requirements), then that particular syntax element is no longer signaled in the slice header but rather signaled only once in the picture header associated with all the slices.

The CC-ALF may be used as a loop filter and as a post-processing step, respectively.

CC-ALF uses luma sample values to refine each chroma component. CC_ALF is applied on the luma samples to derive a correction factor for the chroma sample filtering.

JVET-P0080 and JVET-O0630 proposes a new in-loop filter called as cross component ALF filter. CC-ALF operates as part of the adaptive loop filter process and makes use of luma sample values to refine each chroma component (Cr or Cb component). The tool is controlled by information in the bit-stream, and this information includes both (a) filter coefficients for each chroma component and (b) a mask controlling the application of the filter for blocks of samples. The filter coefficients are signalled in the APS, while block sizes and mask are signalled at the slice-level.

It can be understood that Mask is a bit (0 or 1). Here the mask indicates if the block of samples should be filtered or not (mask=1 means it is filtered) and (mask=0 means it is not filtered). Basically APS carries the coefficients for ALF and other information.

CC-ALF general design is shown in FIG. 6A, FIG. 6B and FIG. 6C. This general design may be applied to any of the above embodiments that refer to CC-ALF related issues. Further, what is described here is intended to be encompassed by each of the alternative embodiments 1 to 5.

The placement of the filter is as shown in FIG. 6a (see left hand side). The filter shape is as shown in FIG. 6B and FIG. 6C.

CC-ALF operates by applying a linear, diamond shaped filter (FIG. 6B and FIG. 6C) to the luma channel for each chroma component, which is expressed as:

$$Δ {I}_{i} ( x , y ) = {\sum }_{( {x}_{0} , {y}_{0} ) ∈ {S}_{i}} {I}_{0} ( {x}_{C} + {x}_{0} , {y}_{C} + {y}_{0} ) {c}_{i} ( {x}_{0} , {y}_{0} ) ,$$

where
(x, y) is chroma component i location being refined (x_{C}, y_{C}) is the luma location based on (x, y)
Sᵢ is filter support in luma for chroma component i
cᵢ (x₀, y₀) represents the filter coefficients

It is noted that there is a first chroma component (such as Cb color component) when i=1 for the chroma component i, and there is a second chroma component (such as Cr color component) when i=2 for the chroma component i.

Main features of the CC-ALF include the following. The luma location (x_{C}, y_{C}), around which the support region is centered, is computed based on the spatial scaling factor between the luma and chroma planes. Basically CC-ALF uses the luma samples to refine the chroma samples. Therefore, the filter is applied on the luma samples and then the correction factor for the chroma is derived. All filter coefficients are transmitted in the APS and have 8-bit dynamic range. An APS may be referenced in the slice header. CC-ALF coefficients used for each chroma component of a slice are also stored in a buffer corresponding to a temporal sublayer. Reuse of these sets of temporal sublayer filter coefficients is facilitated using slice-level flags. It can be understood that temporal sub-layers are basically defined based on the references information. The application of the CC-ALF filters is controlled on a variable block size and signalled by a context-coded flag received for each block of samples. The block size along with an CC-ALF enabling flag is received at the slice-level for each chroma component. Boundary padding for the horizontal virtual boundaries makes use of repetition. For the remaining boundaries the same type of padding is used as for regular ALF.

FIG. 8 are a block diagram showing picture header entries for CC-ALF are introduced which defines the common CC-ALF data and all the slices can then inherit this common information compared with FIG. 7.

FIG. 16 is a schematic diagram of a data structure 5000, the data structure 5000 may represent a portion of a bitstream 21 generated by an encoder in FIG. 2 and received by a decoder in FIG. 3. The data structure 5000 (i.e., the video bitstream 5000) may comprise a VPS 5005, an SPS 5010, a PPS 5015, and at least four slices 5020, 5025, 5030, and 5035. The slice 5020 may comprise a header 5040 and data 5045. The slices 5025, 5030, 5035 are similar to the slice 5020. The data 5045 may comprise at least three blocks 5050, 5055, and 5060, i.e. a coded representation of at least three blocks 5050, 5055, and 5060. Though four slices 5020-5035 are shown, the video bitstream 5000 comprises any suitable number of slices. Though three blocks 5050-5060 are shown, the data 5045 comprise any suitable number of blocks. In addition, each remaining slice 5025, 5030, 5035 also comprises blocks. Thus, while the video bitstream 5000 comprises i.e. a coded representation of numerous blocks, the video bitstream 5000 comprises one SPS 5010 and significantly fewer slice headers than blocks. It can be understood that the bitstream including a plurality of CC-ALF related syntax elements also can be shown in FIG. 16. As shown by the syntax above and below, a plurality of CC-ALF related syntax elements is clearly specified. In addition, the process for encoding or decoding the bitstream is clearly specified in the syntax and/or semantics noted above and below.

The bitstream shown here may be obtained by encoding a video sequence using any of the above described embodiments. Further, this bitstream may be obtained or may include the syntax elements and further the syntax elements related to CC-ALF as explained in the above alternative embodiments 1 to 5.

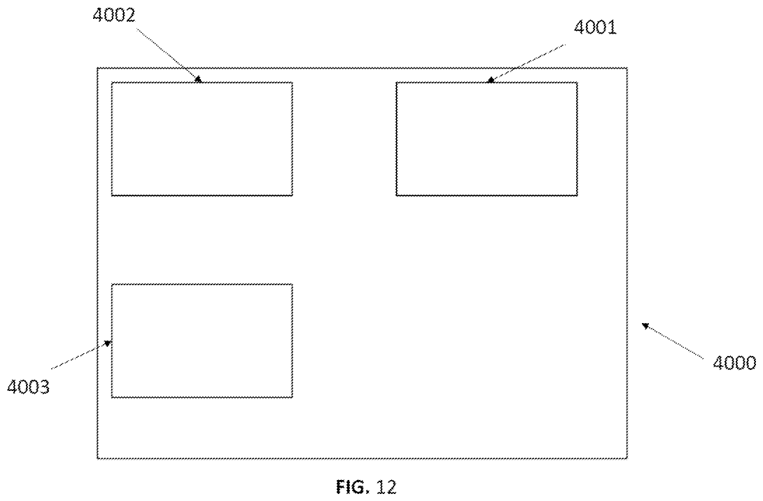

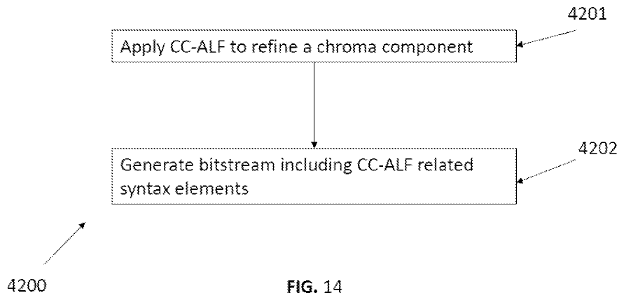

FIG. 14 shows a flow chart of a method 4200 of encoding, for example, a video. This method may, for example, be implemented using the encoder according to FIG. 12, but also any other encoder and encoding device disclosed herein may be used to perform this method.

The method 4200 of encoding comprises applying 4201 a CC-ALF to refine a chroma component and generating 4202 a bitstream including a plurality of CC-ALF related syntax elements, wherein the plurality of CC-ALF related syntax elements indicates CC-ALF related information. Within the bitstream generated in step 4202, the plurality of CC-ALF related syntax elements is signaled at any one or more of an SPS level, a picture header, or a slice header. The plurality of CC-ALF related syntax elements comprises a first syntax element that indicates whether an ALF comprising the CC-ALF is enabled or not at a sequence level and the first syntax element is signaled at the SPS level, and a second syntax element that indicates whether the CC-ALF is enabled or not at a sequence level and the second syntax element is signaled at the SPS level.

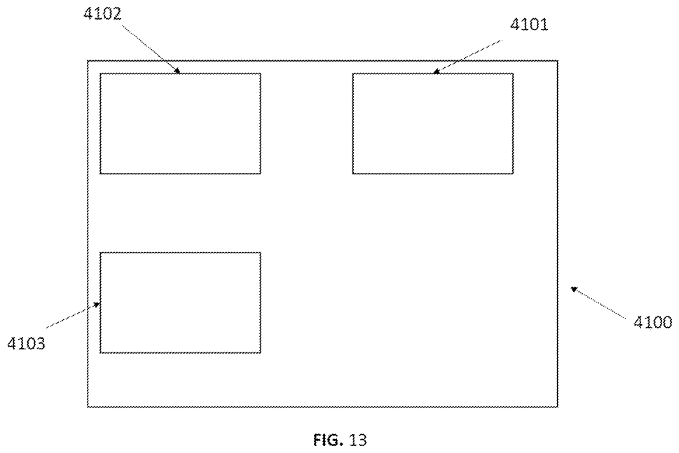

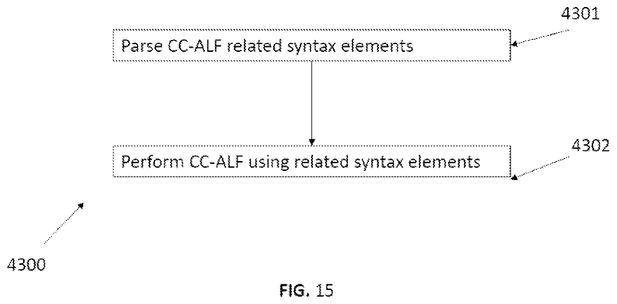

FIG. 15 shows a flow chart of a method 4300 of decoding of, for example, a video from a bitstream or the like. This method 4300 may, for example, be implemented using the decoder according to FIG. 13. Also, any other decoder and decoding device disclosed herein can be used to perform the method 4300.

The method 4300 comprises parsing 4301 a plurality of CC-ALF, related syntax elements from a bitstream, wherein the plurality of CC-ALF related syntax elements is obtained from any one or more of an SPS level, a picture header, or a slice header. The plurality of CC-ALF related syntax elements comprises a first syntax element that indicates whether an ALF comprising the CC-ALF is enabled or not at a sequence level and the first syntax element is signaled at the SPS level, and a second syntax element that indicates whether the CC-ALF is enabled or not at a sequence level and the second syntax element is signaled at the SPS level. The method 4300 further comprises a step of performing 4302 a CC-ALF process using at least one of the plurality of CC-ALF related syntax elements.

In one embodiment, a method of encoding implemented by an encoding device is provided, the method comprising performing a filtering process (such as a cross-component filtering process) by applying a CC-ALF, generating a bitstream including a plurality of CC-ALF related syntax elements (such as M CC-ALF related syntax elements and M>=1 and M is an integer), wherein the plurality of CC-ALF related syntax elements indicate the CC-ALF related information, wherein the plurality of CC-ALF related syntax elements is signaled at any one or more of a VPS level, an SPS level, a PPS level, a picture header, a slice header or a tile header, or wherein the plurality of CC-ALF related syntax elements is signaled at an SPS level and/or a picture header.

With this method, a bitstream may be provided that is reduced in size as information relevant, for example, to all slices of a picture can be provided in the picture header only once.

In one embodiment, the plurality of CC-ALF related syntax elements comprises a first syntax element (e.g. a first indicator, such as sps_ccalf_enabled_flag or sps_alf_enabled_flag), wherein the first syntax element (e.g. a first indicator, such as sps_ccalf_enabled_flag) is signaled at an SPS level. This indicator may indicate whether ALF or CC-ALF or both may be enabled or not for the whole sequence.

In a further embodiment, the first syntax element (e.g. a first indicator, such as sps_ccalf_enabled_flag) indicates whether the CC-ALF is enabled or not at a sequence level, or wherein the first syntax element (e.g. a first indicator, such as sps_alf_enabled_flag) indicates whether ALF comprising the CC-ALF is enabled or not at a sequence level. With this first syntax element, the modes of the adaptive loop filter may be provided at sequence level for all pictures or parts of the sequence.

It can further be provided that the first syntax element (such as sps_ccalf_enabled_flag or sps_alf_enabled_flag) is set as a first value (true or 1) or the first syntax element has a first value (true or 1). With this value, it may be indicated whether ALF and/or CC-ALF is/are enabled using, preferably, only a single bit value.

In one embodiment, the plurality of CC-ALF related syntax elements further comprises a second syntax element (e.g. a second indicator, such as pic_ccalf_enabled_present_flag) if the first syntax element (such as sps_ccalf_enabled_flag or sps_alf_enabled_flag) is set as a first value (true or 1) or the first syntax element has a first value (true or 1), wherein the second syntax element (such as pic_ccalf_enabled_present_flag) is signaled at a picture header, or a ninth syntax element (e.g. a ninth indicator, such as pic_alf_enabled_present_flag) if the first syntax element (such as sps_ccalf_enabled_flag or sps_alf_enabled_flag) is set as a first value (true or 1) or the first syntax element has a first value (true or 1), wherein the ninth syntax element (such as pic_alf_enabled_present_flag) is signaled at a picture header.

That the second syntax element is provided if the first syntax element is set as a first value (and correspondingly for the ninth syntax element) may be understood to mean that the respective syntax element is only or at least provided if the first syntax element has the first value and is not provided in any other case. This embodiment may nevertheless encompass that the second and ninth syntax element are provided or present irrespective of the value of the first syntax element. This meaning may be applied to the presence or non-presence of all further syntax elements referred to herein provided that these syntax elements are referred to be present if another syntax element takes a specific value.

With the second and ninth syntax element, it can be specified whether ALF and/or CC-ALF are enabled for the slices of the picture using a reduced amount of bits.

In one embodiment, the second syntax element (e.g. a second indicator, such as pic ccalf_enabled_present_flag) indicates whether a third syntax element and/or a fourth set of syntax elements are present in a picture header.

It can further be provided that the plurality of CC-ALF related syntax elements further comprises a third syntax element (e.g. a third indicator, such as pic_ccalf_enabled_flag or pic_alf_enabled_flag) if the second syntax element (such as pic_ccalf_enabled_present_flag) or the ninth syntax element (such as pic_alf_enabled_present_flag) is set as a first value (true or 1) or the second syntax element or the ninth syntax element has a first value (true or 1), wherein the third syntax element (such as pic_ccalf_enabled_flag or pic_alf_enabled_flag) is signaled at a picture header.

In a further embodiment, the third syntax element (e.g. a third indicator, such as pic_ccalf_enabled_flag) indicates whether the CC-ALF is enabled for all slices associated with the picture header or not, or wherein the third syntax element (e.g. a third indicator, such as pic_alf_enabled_flag) indicates whether adaptive loop filter comprising the CC-ALF is enabled for all slices associated with the picture header or not. The information on the application of ALF or CC-ALF can thereby be signaled for all slices of a picture using a reduced amount of information.

In a further embodiment, the plurality of CC-ALF related syntax elements further comprises a fourth set of syntax elements if the third syntax element (e.g. a third indicator, such as pic_ccalf_enabled_flag or pic_alf_enabled_flag) is set as a first value (true or 1) or the third syntax element has a first value (true or 1), wherein the fourth set of syntax elements is signaled at a picture header (e.g. at a picture header level) or the fourth set of syntax elements is carried by picture header entries.

Further, in one embodiment, the fourth set of syntax elements comprises:

| | |
|---|---|
| if( ChromaArrayType != 0) | |
| pic_cross_component_alf_cb_enabled_flag | u(1) |
| if(pic_cross_component_alf_cb_enabled_flag ) { | |
| pic_cross_component_alf_cb_aps_id | u(3) |
| } | |
| if( ChromaArrayType != 0) | |
| pic_cross_component_alf_cr_enabled_flag | u(1) |
| if( pic_cross_component_alf_cr_enabled_flag ) { | |
| pic_cross_component_alf_cr_aps_id | u(3) |
| } | |
| } | |

It can additionally or alternatively be provided that the fourth set of syntax elements comprises:

| | |
|---|---|
| if( ChromaArrayType != 0) | |
| pic_cross_component_alf_cb_enabled_flag | u(1) |
| if(pic_cross_component_alf_cb_enabled_flag ) { | |
| pic_cross_component_alf_cb_aps_id | u(3) |
| pic_cross_component_cb_filters_signalled_minus1 | ue(v) |
| } | |
| if( ChromaArrayType != 0) | |
| pic_cross_component_alf_cr_enabled_flag | u(1) |
| if( pic_cross_component_alf_cr_enabled_flag ) { | |
| pic_cross_component_alf_cr_aps_id | u(3) |
| pic_cross_component_cr_filters_signalled_minus1 | ue(v) |
| } | |
| } | |

Furthermore, additionally or alternatively, the fourth set of syntax elements comprises:

| | |
|---|---|
| if( ChromaArrayType != 0) | |
| pic_cross_component_alf_cb_enabled_flag | u(1) |
| if( pic_cross_component_alf_cb_enabled_flag ) { | |
| pic_cross_component_cb_filters_signalled_minus1 | ue(v) |
| } | |
| if( ChromaArrayType != 0) | |
| pic_cross_component_alf_cr_enabled_flag | u(1) |
| if( pic_cross_component_alf_cr_enabled_flag ) { | |
| pic_cross_component_cr_filters_signalled_minus1 | ue(v) |
| } | |

With the above embodiments, relevant information for the filters to be applied can be provided for all slices already in the picture header, potentially reducing the size of the bitstream.

In a further embodiment, it is provided that, for all slices of the same picture, the same CC-ALF related information (such as, aps_ids) is inherited from the picture header. The information provided in the picture header does therefore not need to be included in the slice headers or the like in addition, thereby potentially reducing the amount of information that is provided in the bitstream.

In one embodiment, the plurality of CC-ALF related syntax elements comprises a first syntax element (e.g. a first indicator, such as sps_ccalf_enabled_flag or sps_alf_enabled_flag), wherein the first syntax element (e.g. a first indicator, such as sps_ccalf_enabled_flag) is signaled at an SPS level, a second syntax element (e.g. a second indicator, such as pic ccalf_enabled_present_flag) if the first syntax element (such as sps_ccalf_enabled_flag or sps_alf_enabled_flag) is set as a first value (true or 1) or has a first value (true or 1), wherein the second syntax element (such as pic_ccalf_enabled_present_flag) is signaled at a picture header. Furthermore, the plurality of CC-ALF related syntax elements may comprise a fifth syntax element (e.g. a fifth indicator, such as slice_ccalf_enabled_flag or slice_alf_enabled_flag) if the first syntax element (such as sps_ccalf_enabled_flag or sps_alf_enabled_flag) is set as a first value (true or 1) or has a first value (true or 1) and if the second syntax element (such as pic ccalf_enabled_present_flag or pic_alf_enabled_present_flag) is set as a second value (false or 0) or has a second value (false or 0), wherein the fifth syntax element (such as slice_ccalf_enabled_flag or slice_alf_enabled_flag) is signaled at a slice header.

It can also be provided that the plurality of CC-ALF related syntax elements further comprises a sixth set of syntax elements if the fifth syntax element (e.g. a fifth indicator, such as slice_ccalf_enabled_flag or slice_alf_enabled_flag) is set as a first value (true or 1) or the fifth syntax element has a first value (true or 1), wherein the sixth set of syntax elements is signaled at a slice header or the sixth set of syntax elements is carried by slice header entries. This set of syntax elements may, for example, indicate parameters to be used in ALF or CC-ALF. By providing this set potentially dependent on the value of the fifth syntax element, the size of the bitstream may be further reduced.

Further, it can be provided that the sixth set of syntax elements comprises:

| | |
|---|---|
| if( ChromaArrayType != 0) | |
| slice_cross_component_alf_cb_enabled_flag | u(1) |
| if(slice_cross_component_alf_cb_enabled_flag ) { | |
| slice_cross_component_alf_cb_aps_id | u(3) |
| } | |
| if( ChromaArrayType != 0) | |
| slice_cross_component_alf_cr_enabled_flag | u(1) |
| if( slice_cross_component_alf_cr_enabled_flag ) { | |
| slice_cross_component_alf_cr_aps_id | u(3) |
| } | |
| } | |

Additionally or alternatively, it may be provided that the sixth set of syntax elements comprises:

| | |
|---|---|
| if( ChromaArrayType != 0) | |
| slice_cross_component_alf_cb_enabled_flag | u(1) |
| if( slice_cross_component_alf_cb_enabled_flag ) { | |
| slice_cross_component_alf_cb_aps_id | u(3) |
| slice_cross component_cb_filters_signalled_minus1 | ue(v) |
| } | |
| if( ChromaArrayType != 0) | |
| slice_cross_component_alf_cr_enabled_flag | u(1) |
| if( slice_cross_component_alf_cr_enabled_flag ) { | |
| slice_cross_component_alf_cr_aps_id | u(3) |
| slice_cross component_cr_filters_signalled_minus1 | ue(v) |
| } | |

Furthermore, it may be provided that the sixth set of syntax elements comprises:

| | |
|---|---|
| if( ChromaArrayType != 0) | |
| slice_cross_component_alf_cb_enabled_flag | u(1) |
| if( slice_cross_component_alf_cb_enabled_flag ) { | |
| slice_cross component_cb_filters_signalled_minus1 | ue(v) |
| } | |
| if( ChromaArrayType != 0) | |
| slice_cross_component_alf_cr_enabled_flag | u(1) |
| if( slice_cross_component_alf_cr_enabled_flag ) { | |
| slice_cross_component_cr_filters_signalled_minus1 | ue(v) |
| } | |

In a further embodiment, the plurality of CC-ALF related syntax elements further comprises a seventh syntax element (e.g. a seventh indicator, such as pic_cross_component_alf_cb_aps_id) and an eighth syntax element (e.g. a eighth indicator, such as pic_cross_component_alf_cr_aps_id) if the first syntax element (such as sps_ccalf_enabled_flag or sps_alf_enabled_flag) is set as a first value (true or 1) or has a first value (true or 1).

In one embodiment, the plurality of CC-ALF related syntax elements further comprises a seventh syntax element (e.g. a seventh indicator, such as pic_cross_component_alf_cb_aps_id) and an eighth syntax element (e.g. a eighth indicator, such as pic_cross_component_alf_cr_aps_id) if the first syntax element (such as sps_ccalf_enabled_flag or sps_alf_enabled_flag) is set as a first value (true or 1) or has a first value (true or 1) and if a ninth syntax element (such as pic_alf_enabled_present_flag) is set as a first value (true or 1) or has a first value (true or 1).

In one embodiment, the plurality of CC-ALF related syntax elements further comprises a seventh syntax element (e.g. a seventh indicator, such as pic_cross_component_alf_cb_aps_id), an eighth syntax element (e.g. a eighth indicator, such as pic_cross_component_alf_cr_aps_id) and the second syntax element (such as pic_ccalf_enabled_present_flag) if the first syntax element (such as sps_ccalf_enabled_flag or sps_alf_enabled_flag) is set as a first value (true or 1) or has a first value (true or 1) and if a ninth syntax element (such as pic_alf_enabled_present_flag) is set as a first value (true or 1) or has a first value (true or 1).

It can also be provided that the plurality of CC-ALF related syntax elements further comprises a seventh syntax element (e.g. a seventh indicator, such as pic_cross_component_alf_cb_aps_id), an eighth syntax element (e.g. a eighth indicator, such as pic_cross_component_alf_cr_aps_id) and the ninth syntax element (such as pic_alf_enabled_present_flag) if the first syntax element (such as sps_ccalf_enabled_flag or sps_alf_enabled_flag) is set as a first value (true or 1) or has a first value (true or 1).

Moreover, in one embodiment, the CC-ALF is applied to perform filtering processing on one or more luma samples of a luma component of a current image block, to refine a chroma sample (such as each chroma sample) of a chroma component of the current image block.

Further, it can be provided that the CC-ALF is configured to refine each chroma component using luma sample values.

In one embodiment, the CC-ALF operates as part of the adaptive loop filter process.

It can also be provided that the image block comprises a luma block and chroma blocks, wherein a first chroma block is a first chroma component (such as Cb component) of the image block and a second chroma block is a second chroma component (such as Cr component) of the image block.

The present disclosure further pertains to a method of encoding implemented by an encoding device, comprising determining whether Cross Component ALF (CC-ALF) is enabled or not, generating a bitstream including one or more syntax elements (e.g. CC-ALF related syntax element, such as pic_ccalf_enabled_flag, pic_cross_component_alf_cb_enabled_flag, or pic_cross_component_alf_cr_enabled_flag), wherein the one or more syntax elements indicate whether Cross Component ALF (CC-ALF) is enabled or not at a picture header level and corresponding CC-ALF related information, wherein the syntax elements are signaled at a picture header level. Thereby, relevant information for the later decoding may be provided with reduced size in the bitstream.

It can also be provided that the CC-ALF is applied to perform filtering processing on one or more luma samples of a luma component of a current image block, to refine a chroma sample (such as each chroma sample) of a chroma component of the current image block.

In one embodiment, the method further comprises performing filtering processing on a luma component of a current image block which belongs to a picture by using the CC-ALF filter, wherein one or more luma samples of the luma component of the current image block are used to refine at least one chroma sample (such as each chroma sample) of a chroma component of the current image block.

It can also be provided that the CC-ALF is configured to refine each chroma component using luma sample values.

In a further embodiment, the CC-ALF operates as part of the adaptive loop filter process.

It can also be provided that the image block comprises a luma block and chroma blocks, wherein a first chroma block is a first chroma component (such as Cb component) of the image block and a second chroma block is a second chroma component (such as Cr component) of the image block.

The present disclosure further pertains to a method of decoding implemented by a decoding device, the method comprising parsing one or more syntax elements from a bitstream of a video signal, wherein the one or more syntax elements indicate CC-ALF related information, wherein the one or more syntax elements are obtained from any one or more of a VPS level, an SPS level, a PPS level, a picture header, a slice header or a tile header of the bitstream, or wherein the one or more syntax elements are obtained from an SPS level and/or a picture header, and performing a filtering process (such as a cross-component filtering process) by applying a CC-ALF based on the syntax elements or based on value of the syntax elements.

The information that may be necessary to determine the filtering method to be applied and how it is to be applied may be provided with this in a bitstream that has reduced size while still allowing reliable decoding.

The present disclosure further describes a method of decoding implemented by a decoding device, the method comprising parsing a plurality of syntax elements from a bitstream of a video signal, wherein the syntax elements are obtained from any one or more of a VPS level, an SPS level, a PPS level, a picture header, a slice header or a tile header of the bitstream, or wherein the syntax elements are obtained from an SPS level and/or a picture header, determining CC-ALF related information based on one or more syntax elements from the plurality of syntax elements, wherein performing a filtering process (such as a cross-component filtering process) by applying a CC-ALF based on the CC-ALF related information.

The information that may be necessary to determine the filtering method to be applied and how it is to be applied may be provided with this in a bitstream that has reduced size while still allowing reliable decoding.

It can be provided that the one or more syntax elements or the plurality of syntax elements (such as CC-ALF related syntax elements) comprises a first syntax element (e.g. a first indicator, such as sps_ccalf_enabled_flag or sps_alf_enabled_flag), wherein the first syntax element (e.g. a first indicator, such as sps_ccalf_enabled_flag) is obtained from an SPS level.

Further, it can further be provided that the first syntax element (e.g. a first indicator, such as sps_ccalf_enabled_flag) indicates whether the CC-ALF is enabled or not at a sequence level, or wherein the first syntax element (e.g. a first indicator, such as sps_alf_enabled_flag) indicates whether ALF comprising the CC-ALF is enabled or not at a sequence level.

Thereby, information on which filter method is to be applied can be provided with a reduced amount of information to the decoder in the bitstream.

In one embodiment, the first syntax element (such as sps_ccalf_enabled_flag or sps_alf_enabled_flag) is derived as a first value (true or 1) or the first syntax element has a first value (true or 1).

It can also be provided that the plurality of syntax elements (such as CC-ALF related syntax elements) further comprises a second syntax element (e.g. a second indicator, such as pic ccalf_enabled_present_flag) if the first syntax element (such as sps_ccalf_enabled_flag or sps_alf_enabled_flag) is derived as a first value (true or 1) or the first syntax element has a first value (true or 1), wherein the second syntax element (such as pic_ccalf_enabled_present_flag) is obtained from a picture header, or a ninth syntax element (e.g. a ninth indicator, such as pic_alf_enabled_present_flag) if the first syntax element (such as sps_ccalf_enabled_flag or sps_alf_enabled_flag) is derived as a first value (true or 1) or the first syntax element has a first value (true or 1), wherein the ninth syntax element (such as pic_alf_enabled_present_flag) is obtained from a picture header.

In a further embodiment, the second syntax element (e.g. a second indicator, such as pic_ccalf_enabled_present_flag) indicates whether a third syntax element and/or a fourth set of syntax elements are present in a picture header.

The plurality of syntax elements (such as CC-ALF related syntax elements) may further comprise a third syntax element (e.g. a third indicator, such as pic_ccalf_enabled_flag or pic_alf_enabled_flag) if the second syntax element (such as pic_ccalf_enabled_present_flag) or the ninth syntax element (such as pic_alf_enabled_present_flag) is derived as a first value (true or 1) or the second syntax element or the ninth syntax element has a first value (true or 1), wherein the third syntax element (such as pic_ccalf_enabled_flag or pic_alf_enabled_flag) is obtained from a picture header.

Further, it can be provided that the third syntax element (e.g. a third indicator, such as pic_ccalf_enabled_flag) indicates whether the CC-ALF is enabled for all slices associated with the picture header or not, or wherein the third syntax element (e.g. a third indicator, such as pic_alf_enabled_flag) indicates whether adaptive loop filter comprising the CC-ALF is enabled for all slices associated with the picture header or not.

In one embodiment, the plurality of syntax elements (such as CC-ALF related syntax elements) further comprises a fourth set of syntax elements if the third syntax element (e.g. a third indicator, such as pic_ccalf_enabled_flag or pic_alf_enabled_flag) is derived as a first value (true or 1) or the third syntax element has a first value (true or 1), wherein the fourth set of syntax elements is obtained from a picture header (e.g. at a picture header level) or the fourth set of syntax elements is carried by picture header entries.

This set of syntax elements may only be provided if the third syntax element takes or is derived as the first value and may not be present otherwise or the values of the set of syntax elements may be set to a default value, like 0, if the third syntax element takes a different value. In both cases, reliable provision of relevant information for the decoding may be ensured at reduced size of the bitstream.

Further, the fourth set of syntax elements may comprise:

| | |
|---|---|
| if( ChromaArrayType != 0) | |
| pic_cross_component_alf_cb_enabled_flag | u(1) |
| if(pic_cross_component_alf_cb_enabled_flag ) { | |
| pic_cross_component_alf_cb_aps_id | u(3) |
| } | |
| if( ChromaArrayType != 0) | |
| pic_cross_component_alf_cr_enabled_flag | u(1) |
| if( pic_cross_component_alf_cr_enabled_flag ) { | |
| pic_cross_component_alf_cr_aps_id | u(3) |
| } | |
| } | |

Alternatively or additionally, the fourth set of syntax elements may comprise:

| | |
|---|---|
| if( ChromaArrayType != 0) | |
| pic_cross_component_alf_cb_enabled_flag | u(1) |
| if(pic_cross_component_alf_cb_enabled_flag ) { | |
| pic_cross_component_alf_cb_aps_id | u(3) |
| pic_cross_component_cb_filters_signalled_minus1 | ue(v) |
| } | |
| if( ChromaArrayType != 0) | |
| pic_cross_component_alf_cr_enabled_flag | u(1) |
| if( pic_cross_component_alf_cr_enabled_flag ) { | |
| pic_cross_component_alf_cr_aps_id | u(3) |
| pic_cross_component_cr_filters_signalled_minus1 | ue(v) |
| } | |
| } | |

In a further embodiment, the fourth set of syntax elements may comprise:

| | |
|---|---|
| if( ChromaArrayType != 0) | |
| pic_cross_component_alf_cb_enabled_flag | u(1) |
| if( pic_cross_component_alf_cb_enabled_flag ) { | |
| pic_cross_component_cb_filters_signalled_minus1 | ue(v) |
| } | |
| if( ChromaArrayType != 0) | |
| pic_cross_component_alf_cr_enabled_flag | u(1) |
| if( pic_cross_component_alf_cr_enabled_flag ) { | |
| pic_cross_component_cr_filters_signalled_minus1 | ue(v) |
| } | |

It can be provided that, for all slices of the same picture, the same CC-ALF related information (such as, aps_ids) is inherited from the picture header. Thereby, the amount of information provided in the bitstream to indicate to the decoder the CC-ALF related information for the slices of a picture can be reduced.

In one embodiment, the plurality of syntax elements (such as CC-ALF related syntax elements) comprises a first syntax element (e.g. a first indicator, such as sps_ccalf_enabled_flag or sps_alf_enabled_flag), wherein the first syntax element (e.g. a first indicator, such as sps_ccalf_enabled_flag) is obtained from an SPS level, a second syntax element (e.g. a second indicator, such as pic_ccalf_enabled_present_flag) if the first syntax element (such as sps_ccalf_enabled_flag or sps_alf_enabled_flag) is derived as a first value (true or 1) or has a first value (true or 1), wherein the second syntax element (such as pic_ccalf_enabled_present_flag) is obtained from a picture header.

In a further embodiment, the plurality of syntax elements (such as CC-ALF related syntax elements) further comprises a fifth syntax element (e.g. a fifth indicator, such as slice_ccalf_enabled_flag or slice_alf_enabled_flag) if the first syntax element (such as sps_ccalf_enabled_flag or sps_alf_enabled_flag) is derived as a first value (true or 1) or has a first value (true or 1) and if the second syntax element (such as pic_ccalf_enabled_present_flag or pic_alf_enabled_present_flag) is derived as a second value (false or 0) or has a second value (false or 0), wherein the fifth syntax element (such as slice_ccalf_enabled_flag or slice_alf_enabled_flag) is obtained from a slice header.

It may be provided that the plurality of syntax elements (such as CC-ALF related syntax elements) further comprises a sixth set of syntax elements if the fifth syntax element (e.g. a fifth indicator, such as slice_ccalf_enabled_flag or slice_alf_enabled_flag) is derived as a first value (true or 1) or the fifth syntax element has a first value (true or 1), wherein the sixth set of syntax elements is obtained from a slice header or the sixth set of syntax elements is carried by slice header entries.

Further, it may be provided that the sixth set of syntax elements comprises:

| | |
|---|---|
| if( ChromaArrayType != 0) | |
| slice_cross_component_alf_cb_enabled_flag | u(1) |
| if(slice_cross_component__alf_cb_enabled_flag ) { | |
| slice_cross_component_alf_cb_aps_id | u(3) |
| } | |
| if( ChromaArrayType != 0) | |
| slice_cross_component_alf_cr_enabled_flag | u(1) |
| if( slice_cross_component_alf_cr_enabled_flag ) { | |
| slice_cross_component_alf_cr_aps_id | u(3) |
| } | |
| } | |

It may alternatively or additionally be provided that the sixth set of syntax elements comprises:

| | |
|---|---|
| if( ChromaArrayType != 0) | |
| slice_cross_component_alf_cb_enabled_flag | u(1) |
| if( slice_cross_component_alf_cb_enabled_flag ) { | |
| slice_cross_component_alf_cb_aps_id | u(3) |
| slice_cross_component_cb_filters_signalled_minus1 | ue(v) |
| } | |
| if( ChromaArrayType != 0) | |
| slice_cross_component_alf_cr_enabled_flag | u(1) |
| if( slice_cross_component_alf_cr_enabled_flag ) { | |
| slice_cross_component_alf_cr_aps_id | u(3) |
| slice_cross_component_cr_filters_signalled_minus1 | ue(v) |
| } | |

Likewise, it may be provided that the sixth set of syntax elements comprises:

| | |
|---|---|
| if( ChromaArrayType != 0) | |
| slice_cross_component_alf_cb_enabled_flag | u(1) |
| if( slice_cross_component_alf_cb_enabled_flag ) { | |
| slice_cross_component_cb_filters_signalled_minus1 | ue(v) |
| } | |
| if( ChromaArrayType != 0) | |
| slice_cross_component_alf_cr_enabled_flag | u(1) |
| if( slice_cross_component_alf_cr_enabled_flag ) { | |
| slice_cross_component_cr_filters_signalled_minus1 | ue(v) |
| } | |

In one embodiment, the plurality of syntax elements (such as CC-ALF related syntax elements) further comprises a seventh syntax element (e.g. a seventh indicator, such as pic_cross_component_alf_cb_aps_id) and an eighth syntax element (e.g. a eighth indicator, such as pic_cross_component_alf_cr_aps_id) if the first syntax element (such as sps_ccalf_enabled_flag or sps_alf_enabled_flag) is derived as a first value (true or 1) or has a first value (true or 1).

It can also be provided that the plurality of syntax elements (such as CC-ALF related syntax elements) further comprises a seventh syntax element (e.g. a seventh indicator, such as pic_cross_component_alf_cb_aps_id) and an eighth syntax element (e.g. an eighth indicator, such as pic_cross_component_alf_cr_aps_id) if the first syntax element (such as sps_ccalf_enabled_flag or sps_alf_enabled_flag) is derived as a first value (true or 1) or has a first value (true or 1) and if a ninth syntax element (such as pic_alf_enabled_present_flag) is derived as a first value (true or 1) or has a first value (true or 1).

In another embodiment, the plurality of syntax elements (such as CC-ALF related syntax elements) further comprises a seventh syntax element (e.g. a seventh indicator, such as pic_cross_component_alf_cb_aps_id), an eighth syntax element (e.g. a eighth indicator, such as pic_cross_component_alf_cr_aps_id) and the second syntax element (such as pic_ccalf_enabled_present_flag) if the first syntax element (such as sps_ccalf_enabled_flag or sps_alf_enabled_flag) is derived as a first value (true or 1) or has a first value (true or 1) and if a ninth syntax element (such as pic_alf_enabled_present_flag) is derived as a first value (true or 1) or has a first value (true or 1).

It may also be provided that the plurality of syntax elements (such as CC-ALF related syntax elements) further comprises a seventh syntax element (e.g. a seventh indicator, such as pic_cross_component_alf_cb_aps_id), an eighth syntax element (e.g. a eighth indicator, such as pic_cross_component_alf_cr_aps_id) and the ninth syntax element (such as pic_alf_enabled_present_flag) if the first syntax element (such as sps_ccalf_enabled_flag or sps_alf_enabled_flag) is derived as a first value (true or 1) or has a first value (true or 1).

In one embodiment, the CC-ALF is applied to perform filtering processing on one or more luma samples of a luma component of a current image block, to refine a chroma sample (such as each chroma sample) of a chroma component of the current image block.

The CC-ALF may be configured to refine each chroma component using luma sample values.

It may also be provided that the CC-ALF operates as part of the adaptive loop filter process.

In one embodiment, the image block comprises a luma block and chroma blocks, wherein a first chroma block is a first chroma component (such as Cb component) of the image block and a second chroma block is a second chroma component (such as Cr component) of the image block.

The present disclosure further refers to a method of decoding implemented by a decoding device, comprising parsing from a bitstream of a video signal one or more syntax elements (e.g. M CC-ALF related syntax elements, M is an integer and M>=1, such as pic_ccalf_enabled_flag, pic_cross_component_alf_cb_enabled_flag, or pic_cross_component_alf_cr_enabled_flag), wherein the one or more syntax elements indicate whether CC-ALF is enabled or not at a picture header level and corresponding CC-ALF related information, wherein the one or more syntax elements are obtained from a picture header level performing a filtering process (such as a cross-component filtering process) by applying a CC-ALF in response to the determination that CC-ALF is enabled.

This method may appropriately apply the CC-ALF during decoding while allowing for reducing the size of the bitstream

In one embodiment, the CC-ALF is applied to perform filtering processing on one or more luma samples of a luma component of a current image block, to refine a chroma sample (such as each chroma sample) of a chroma component of the current image block.

It can also be provided that the CC-ALF is configured to refine each chroma component using luma sample values.

In a further embodiment, the CC-ALF operates as part of the adaptive loop filter process.

Embodiments may further encompass that the image block comprises a luma block and chroma blocks, wherein a first chroma block is a first chroma component (such as Cb component) of the image block and a second chroma block is a second chroma component (such as Cr component) of the image block.

The present disclosure further provides a device for encoding video data, the device comprising a video data memory, and a video encoder, wherein the video encoder is configured for performing a filtering process (such as a cross-component filtering process) by applying a CC-ALF, generating a bitstream for the video signal by including a plurality of syntax elements (such as CC-ALF related syntax elements), wherein the plurality of syntax elements indicate the CC-ALF related information, wherein the plurality of CC-ALF related syntax elements is obtained from any one or more of a VPS level, an SPS level, a PPS level, a picture header, a slice header or a tile header, or wherein the plurality of CC-ALF related syntax elements is obtained from an SPS level and/or a picture header.

This device may realize an encoding that results in a bitstream having reduced size.

Furthermore, a device for decoding video data is provided, the device comprising a video data memory, and a video decoder, wherein the video decoder is configured for parsing a plurality of syntax elements from a bitstream of a video signal, wherein the plurality of syntax elements are obtained from any one or more of a VPS level, an SPS level, a PPS level, a picture header, a slice header or a tile header of the bitstream, or wherein the plurality of syntax elements are obtained from an SPS level and/or a picture header of the bitstream, determining CC-ALF related information based on one or more syntax elements from the plurality of syntax elements, and performing a filtering process (such as a Cross-Component filtering process) by applying a CC-ALF based on the CC-ALF related information.

This decoder may be able to perform reliable decoding while requiring a bitstream with reduced size to obtain the information pertaining to the filter to be applied during decoding.

The present disclosure further provides an encoder, the encoder comprising processing circuitry for carrying out the method according to any one of the above embodiments.

The present disclosure also refers to a decoder, the decoder comprising processing circuitry for carrying out the method according to any one of the above embodiments.

Furthermore, a computer program product comprising a program code for performing the method according to any one of the above embodiments is provided.

The present disclosure further pertains to a decoder, the decoder comprising one or more processors, and a non-transitory computer-readable storage medium coupled to the processors and storing programming for execution by the processors, wherein the programming, when executed by the processors, configures the decoder to carry out the method according to any one of the above embodiments.

Moreover, an encoder is provided in the present disclosure, the encoder comprising

one or more processors, and a non-transitory computer-readable storage medium coupled to the processors and storing programming for execution by the processors, wherein the programming, when executed by the processors, configures the encoder to carry out the method according to any one of the above embodiments.

Furthermore, a non-transitory recording medium is provided which includes an encoded bitstream decoded by an image decoding device, the bit stream being generated by dividing a frame of a video signal or an image signal into a plurality blocks, and including a plurality of syntax elements (such as CC-ALF related syntax elements), wherein the plurality of syntax elements indicates the CC-ALF related information,

wherein the plurality of syntax elements (such as CC-ALF related syntax elements) is obtained from any one or more of a VPS level, an SPS level, a PPS level, a picture header, a slice header or a tile header, or wherein the plurality of syntax elements (such as CC-ALF related syntax elements) is obtained from least one of an SPS level or a picture header.

The present disclosure also pertains to an apparatus, the apparatus comprising a non-transitory computer-readable medium having stored thereon instructions that, when executed by one or more processors, cause the one or more processors to perform operations to generate image data corresponding to a video bitstream, the image data comprising a plurality of pictures in the video bitstream including a picture comprising N slices, and a picture header associated with the N slices of the picture, wherein one or more of or each of the N slices comprise a plurality of blocks of samples that are entropy encoded, wherein CC-ALF filtering information or CC-ALF filter parameters is inherited by the N slices from the picture header or the N slices inherit the ALF filtering data from the picture header.

In line with any of the above embodiments, it may further be provided that

slice_cross_component_alf_cr_aps_id and slice_cross_component_alf_cb_aps_id values are same as the pic_cross_component_alf_cb_aps_id and pic_cross_component_alf_cr_aps_id.

In a further embodiment, pic_cross_component_alf_cb_aps_id and pic_cross_component_alf_cr_aps_id are obtained from the picture header.

It can also be provided that a CC-ALF related syntax element is obtained only once in the picture header associated with all the N slices.

In one embodiment, N is positive integer and larger than 1.

In one embodiment, a method for encoding of a video bitstream implemented by an encoding device is provided, the encoding method comprising generating a bitstream for the video signal by including a plurality of syntax elements (e.g. a ALF related syntax element, such as sps_alf_enabled_flag, and/or a CC-ALF related syntax element, such as sps_ccalf_enabled_flag), wherein the plurality of syntax elements comprises a CC-ALF enabled flag (such as sps_ccalf_enabled_flag), and wherein CC-ALF related parameters are conditionally signaled at least based on a value of the CC-ALF enabled flag (such as sps_ccalf_enabled_flag).

This may provide a bitstream comprising relevant information for the decoding but having reduced size.

Furthermore, a method for decoding of a video bitstream implemented by a decoding device is provided in line with the present disclosure, the decoding method comprising obtaining (S110) a plurality of syntax elements from the video bitstream, wherein the plurality of syntax elements comprises a CC-ALF enabled flag (such as sps_ccalf_enabled_flag), and wherein CC-ALF related parameters are conditionally signaled at least based on a value of the CC-ALF enabled flag (such as sps_ccalf_enabled_flag).

This method allows for performing reliable decoding even when the bitstream is reduced in size.

In one embodiment, in the case that one or more conditions are satisfied, the CC-ALF enabled flag (such as sps_ccalf_enabled_flag) is signaled an SPS level of the bitstream, wherein the one or more conditions comprise, when the value of a first flag (such as sps_alf_enabled_flag) which is signaled an SPS level of the bitstream is an enabling value (such as a first value, e.g. true or 1), and wherein the CC-ALF enabled flag indicate whether CC-ALF is enabled or not at a sequence level or SPS level.

It can also be provided that the syntax elements comprises a third flag (such as alf_present_in_ph_flag) and the third flag is signaled a PPS level of the bitstream, and wherein the third flag indicate whether one or more syntax elements for enabling ALF use is present in the PHs (picture headers) referring to the PPS or not.

It can also be provided that the third flag (alf_present_in_ph_flag) equal to 1 specifies the syntax elements for enabling ALF use may be present in the PHs (picture headers) referring to the PPS. the third flag (alf_present_in_ph_flag) equal to 0 specifies the syntax elements for enabling ALF use may be present in the slice headers referring to the PPS.

In one embodiment, it is provided that if the value of the first flag (such as sps_alf_enabled_flag) is an enabling value (such as a first value, e.g. true or 1) and the value of the third flag (alf_present_in_ph_flag) is an enabling value (such as a first value, e.g. true or 1), and if the value of the CC-ALF enabled flag (such as sps_ccalf_enabled_flag) is an enabling value (such as a first value, e.g. true or 1), the cross component adaptive loop filtering related parameters (such as, the syntax elements for enabling CC-ALF use) is signaled a picture_header level of the bitstream.

In a further embodiment, it is provided that, if the value of the first flag (such as sps_alf_enabled_flag) is an enabling value (such as a first value, e.g. true or 1) and the value of the third flag (alf_present_in_ph_flag) is a disabling value (such as a second value, e.g. false or 0), and

if the value of the CC-ALF enabled flag (such as sps_ccalf_enabled_flag) is an enabling value (such as a first value, e.g. true or 1), the cross component adaptive loop filtering related parameters (such as, the syntax elements for enabling CC-ALF use) is signaled a slice_header level of the bitstream.

In a further embodiment, it is provided that the CC-ALF enabled flag (such as sps_ccalf_enabled_flag) equal to 0 specifies that the CC-ALF is disabled, or the CC-ALF enabled flag (such as sps_ccalf_enabled_flag) equal to 1 specifies that the CC-ALF is enabled.

It can further be provided that the syntax elements comprises a second flag (such as no_ccalf_constraint_flag) equal to 1 specifies that the CC-ALF enabled flag (such as sps_ccalf_enabled_flag) is equal to 0, or the second flag (such as no_ccalf_constraint_flag) equal to 0 does not impose such a constraint.

In one embodiment, the method further comprises performing a filtering process (such as a CC-ALF process) on a reconstructed picture (such as, a reconstructed luma sample array S_{L}, a reconstructed chroma sample array S_{Cb} and/or, a reconstructed chroma sample array S_{Cr}), to obtain a filtered reconstructed picture (such as, a modified reconstructed luma sample array S′_{L}, a modified reconstructed chroma sample array S′_{Cb} and/or, a modified reconstructed chroma sample array S′_{Cr}).

The present disclosure further provides an encoded bitstream for the video signal by including a plurality of syntax elements (e.g. a ALF related syntax element, such as sps_alf_enabled_flag, and/or a CC-ALF related syntax element, such as sps_ccalf_enabled_flag), wherein the plurality of syntax elements comprises a CC-ALF enabled flag (such as sps_ccalf_enabled_flag), and wherein CC-ALF related parameters are conditionally signaled at least based on a value of the CC-ALF enabled flag (such as sps_ccalf_enabled_flag).

The bitstream may be reduced in size while providing information to be used in decoding when applying CC-ALF in a reliable way.

FIG. 12 shows an embodiment of an encoder 4000. The encoder 4000 may be implemented using any processing circuitry denoted here with 4001 to perform a method of encoding a video. Further, the processing circuitry 4001 may be adapted to apply a CC-ALF to refine a chroma component. The processing circuitry may be further adapted to generate a bitstream including a plurality of CC-ALF related syntax elements, wherein the plurality of CC-ALF related syntax elements indicate CC-ALF related information, wherein the plurality of CC-ALF related syntax elements is signaled at any one or more of an SPS level, a picture header, or a slice header.

The plurality of CC-ALF related syntax elements in this context comprises a first syntax element that indicates whether an ALF comprising the CC-ALF is enabled or not at a sequence level and the first syntax element is signaled at the SPS level, and a second syntax element that indicates whether the CC-ALF is enabled or not at a sequence level and the second syntax element is signaled at the SPS level.

The encoder may further comprise a receiver 4002 for receiving a video to be encoded and a transmitter 4003 for transmitting a bitstream comprising at least the plurality of syntax elements.

FIG. 13 shows an embodiment of a decoder 4100. The decoder 4100 may be implemented using any processing circuitry 4101 to perform a method of decoding a video. Further, the processing circuitry 4101 may be adapted to parse a plurality of CC-ALF, related syntax elements from a bitstream, wherein the plurality of CC-ALF related syntax elements is obtained from any one or more of an SPS level, a picture header, or a slice header.

Further, the plurality of CC-ALF related syntax elements comprises a first syntax element that indicates whether an ALF comprising the CC-ALF is enabled or not at a sequence level and the first syntax element is signaled at the SPS level, and a second syntax element that indicates whether the CC-ALF is enabled or not at a sequence level and the second syntax element is signaled at the SPS level.

The processing circuitry may be further adapted to perform a CC-ALF process using at least one of the plurality of CC-ALF related syntax elements.

Moreover, the decoder 4100 may comprise a receiver 4102 for receiving a bitstream. Additionally, the decoder may comprise a transmitter 4103 for outputting the decoded video for example to an output device not shown here.

Following is an explanation of the applications of the encoding method as well as the decoding method as shown in the above-mentioned embodiments, and a system using them.

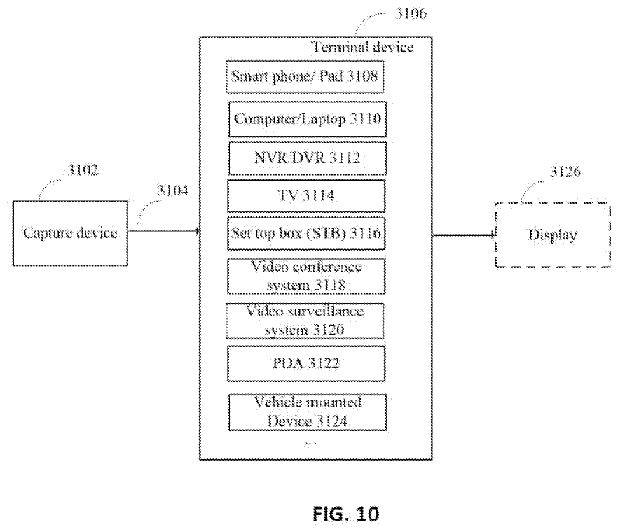

FIG. 10 is a block diagram showing a content supply system 3100 for realizing content distribution service. This content supply system 3100 includes capture device 3102, terminal device 3106, and optionally includes display 3126. The capture device 3102 communicates with the terminal device 3106 over communication link 3104. The communication link may include the communication channel 13 described above. The communication link 3104 includes but not limited to WI-FI, Ethernet, cable, wireless (third generation (3G)/fourth generation (4G)/fifth generation (5G)), Universal Serial Bus (USB), or any kind of combination thereof, or the like.

The capture device 3102 generates data, and may encode the data by the encoding method as shown in the above embodiments. Alternatively, the capture device 3102 may distribute the data to a streaming server (not shown in the Figures), and the server encodes the data and transmits the encoded data to the terminal device 3106. The capture device 3102 includes but not limited to camera, smart phone or IPAD, computer or laptop, video conference system, personal digital assistant (PDA), vehicle mounted device, or a combination of any of them, or the like. For example, the capture device 3102 may include the source device 12 as described above. When the data includes video, the video encoder 20 included in the capture device 3102 may actually perform video encoding processing. When the data includes audio (i.e., voice), an audio encoder included in the capture device 3102 may actually perform audio encoding processing. For some practical scenarios, the capture device 3102 distributes the encoded video and audio data by multiplexing them together. For other practical scenarios, for example in the video conference system, the encoded audio data and the encoded video data are not multiplexed. Capture device 3102 distributes the encoded audio data and the encoded video data to the terminal device 3106 separately.

In the content supply system 3100, the terminal device 310 receives and reproduces the encoded data. The terminal device 3106 could be a device with data receiving and recovering capability, such as smart phone or Pad 3108, computer or laptop 3110, network video recorder (NVR)/digital video recorder (DVR) 3112, TV 3114, set top box (STB) 3116, video conference system 3118, video surveillance system 3120, PDA 3122, vehicle mounted device 3124, or a combination of any of them, or the like capable of decoding the above-mentioned encoded data. For example, the terminal device 3106 may include the destination device 14 as described above. When the encoded data includes video, the video decoder 30 included in the terminal device is prioritized to perform video decoding. When the encoded data includes audio, an audio decoder included in the terminal device is prioritized to perform audio decoding processing.

For a terminal device with its display, for example, smart phone or Pad 3108, computer or laptop 3110, NVR/DVR 3112, TV 3114, PDA 3122, or vehicle mounted device 3124, the terminal device can feed the decoded data to its display. For a terminal device equipped with no display, for example, STB 3116, video conference system 3118, or video surveillance system 3120, an external display 3126 is contacted therein to receive and show the decoded data.

When each device in this system performs encoding or decoding, the picture encoding device or the picture decoding device, as shown in the above-mentioned embodiments, can be used.

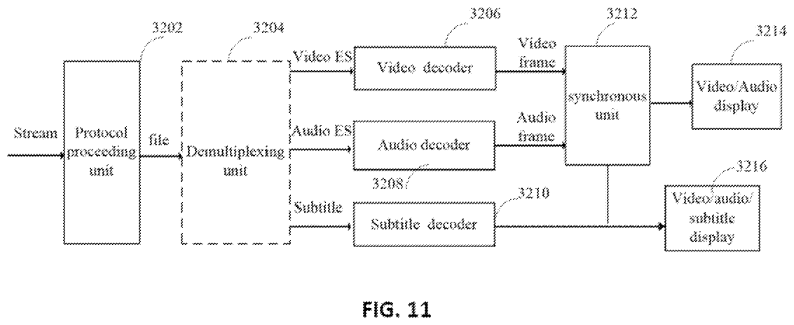

FIG. 11 is a diagram showing a structure of an example of the terminal device 3106. After the terminal device 3106 receives stream from the capture device 3102, the protocol proceeding unit 3202 analyzes the transmission protocol of the stream. The protocol includes but not limited to Real Time Streaming Protocol (RTSP), Hyper Text Transfer Protocol (HTTP), HTTP Live streaming protocol (HLS), MPEG-Dynamic Adaptive Streaming over HTTP (DASH), Real-time Transport Protocol (RTP), Real Time Messaging Protocol (RTMP), or any kind of combination thereof, or the like.

After the protocol proceeding unit 3202 processes the stream, stream file is generated. The file is outputted to a demultiplexing unit 3204. The demultiplexing unit 3204 can separate the multiplexed data into the encoded audio data and the encoded video data. As described above, for some practical scenarios, for example in the video conference system, the encoded audio data and the encoded video data are not multiplexed. In this situation, the encoded data is transmitted to video decoder 3206 and audio decoder 3208 without through the demultiplexing unit 3204.

Via the demultiplexing processing, video elementary stream (ES), audio ES, and optionally subtitle are generated. The video decoder 3206, which includes the video decoder 30 as explained in the above mentioned embodiments, decodes the video ES by the decoding method as shown in the above-mentioned embodiments to generate video frame, and feeds this data to the synchronous unit 3212. The audio decoder 3208, decodes the audio ES to generate audio frame, and feeds this data to the synchronous unit 3212. Alternatively, the video frame may store in a buffer (not shown in FIG. 11) before feeding it to the synchronous unit 3212. Similarly, the audio frame may store in a buffer (not shown in FIG. 11) before feeding it to the synchronous unit 3212.

The synchronous unit 3212 synchronizes the video frame and the audio frame, and supplies the video/audio to a video/audio display 3214. For example, the synchronous unit 3212 synchronizes the presentation of the video and audio information. Information may code in the syntax using time stamps concerning the presentation of coded audio and visual data and time stamps concerning the delivery of the data stream itself.

If subtitle is included in the stream, the subtitle decoder 3210 decodes the subtitle, and synchronizes it with the video frame and the audio frame, and supplies the video/audio/subtitle to a video/audio/subtitle display 3216.

The present disclosure is not limited to the above-mentioned system, and either the picture encoding device or the picture decoding device in the above-mentioned embodiments can be incorporated into other system, for example, a car system.

Mathematical Operators:

The mathematical operators used in this disclosure are similar to those used in the C programming language. However, the results of integer division and arithmetic shift operations are defined more precisely, and additional operations are defined, such as exponentiation and real-valued division. Numbering and counting conventions generally begin from 0, e.g., “the first” is equivalent to the 0-th, “the second” is equivalent to the 1-th, etc.

Arithmetic Operators:

The following arithmetic operators are defined as follows:
+ Addition
− Subtraction (as a two-argument operator) or negation (as a unary prefix operator)
* Multiplication, including matrix multiplication
x^{y} Exponentiation. Specifies x to the power of y. In other contexts, such notation is used for superscripting not intended for interpretation as exponentiation.
/ Integer division with truncation of the result toward zero. For example, 7/4 and −7/−4 are truncated to 1 and −7/4 and 7/−4 are truncated to −1.
÷ Used to denote division in mathematical equations where no truncation or rounding is intended.

$$\frac{x}{y}$$

Used to denote division in mathematical equations where no truncation or rounding is intended.

$${\sum }_{i = x}^{y} f ( i )$$

The summation of f(i) with i taking all integer values from x up to and including y.
x % y Modulus. Remainder of x divided by y, defined only for integers x and y with x>=0 and y>0.

Logical Operators

The following logical operators are defined as follows:
x && y Boolean logical “and” of x and y
x∥y Boolean logical “or” of x and y
! Boolean logical “not”
x?y:z If x is TRUE or not equal to 0, evaluates to the value of y, otherwise, evaluates to the value of z.

Relational Operators

The following relational operators are defined as follows:
> Greater than
>= Greater than or equal to
< Less than
<= Less than or equal to
== Equal to
!= Not equal to

When a relational operator is applied to a syntax element or variable that has been assigned the value “na” (not applicable), the value “na” is treated as a distinct value for the syntax element or variable. The value “na” is considered not to be equal to any other value.

Bit-Wise Operators

The following bit-wise operators are defined as follows:
& Bit-wise “and”. When operating on integer arguments, operates on a two's complement representation of the integer value. When operating on a binary argument that contains fewer bits than another argument, the shorter argument is extended by adding more significant bits equal to 0.
   | Bit-wise “or”. When operating on integer arguments, operates on a two's complement representation of the integer value. When operating on a binary argument that contains fewer bits than another argument, the shorter argument is extended by adding more significant bits equal to 0.
\hat{ } Bit-wise “exclusive or”. When operating on integer arguments, operates on a two's complement representation of the integer value. When operating on a binary argument that contains fewer bits than another argument, the shorter argument is extended by adding more significant bits equal to 0.
x>>y Arithmetic right shift of a two's complement integer representation of x by y binary digits. This function is defined only for non-negative integer values of y. Bits shifted into the most significant bits (MSBs) as a result of the right shift have a value equal to the MSB of x prior to the shift operation.
x<<y Arithmetic left shift of a two's complement integer representation of x by y binary digits. This function is defined only for non-negative integer values of y. Bits shifted into the least significant bits (LSBs) as a result of the left shift have a value equal to 0.

Assignment Operators:

The following arithmetic operators are defined as follows:
== Assignment operator
++ Increment, i.e., x++ is equivalent to x=x+1, when used in an array index, evaluates to the value of the variable prior to the increment operation.
−− Decrement, i.e., x−− is equivalent to x=x−1, when used in an array index, evaluates to the value of the variable prior to the decrement operation.
+= Increment by amount specified, i.e., x+=3 is equivalent to x=x+3, and x+=(−3) is equivalent to x=x+(−3).
−= Decrement by amount specified, i.e., x−=3 is equivalent to x=x−3, and x−=(−3) is equivalent to x=x−(−3).

Range Notation:

The following notation is used to specify a range of values:
x=y . . . z x takes on integer values starting from y to z, inclusive, with x, y, and z being integer numbers and z being greater than y.

Mathematical Functions:

The following mathematical functions are defined:

$$Abs ( x ) = \{ \begin{matrix}x & , & x >= 0 \\ - x & , & x < 0\end{matrix}$$

Asin(x) the trigonometric inverse sine function, operating on an argument x that is in the range of −1.0 to 1.0, inclusive, with an output value in the range of −π÷2 to π÷2, inclusive, in units of radians
Atan(x) the trigonometric inverse tangent function, operating on an argument x, with an output value in the range of −π÷2 to π÷2, inclusive, in units of radians

$$A tan 2 ( y , x ) = \{ \begin{matrix}A tan ( \frac{y}{x} ) & , & x > 0 \\ A tan ( \frac{y}{x} ) + π & , & x < 0 \& \& y >= 0 \\ A tan ( \frac{y}{x} ) - π & , & x < 0 \& \& y < 0 \\ + \frac{π}{2} & , & x == 0 \&\& y >= 0 \\ - \frac{π}{2} & , & otherwise\end{matrix}$$

Ceil(x) the smallest integer greater than or equal to X.

$$Clip {1}_{Y} ( x ) = Clip 3 ( 0 , ( 1 ≪ {BitDepth}_{Y} ) - 1 , x )$$

$$Clip {1}_{C} ( x ) = C lip 3 ( 0 , ( 1 ≪ {BitDepth}_{C} ) - 1 , x )$$

$$Clip 3 ( x , y , z ) = \{ \begin{matrix}x & , & z < x \\ y & , & z > y \\ z & , & otherwise\end{matrix}$$

Cos(x) the trigonometric cosine function operating on an argument x in units of radians.
Floor(x) the largest integer less than or equal to x.

$$GetCurrMsb ( a , b , c , d ) = \{ \begin{matrix}c + d & , & b - a >= d / 2 \\ c - d & , & a - b > d / 2 \\ c & , & otherwise\end{matrix}$$

Ln(x) the natural logarithm of x (the base-e logarithm, where e is the natural logarithm base constant 2.718 281 828 . . . ).
Log 2(x) the base-2 logarithm of x.
Log 10(x) the base-10 logarithm of x.

$$Min ( x , y ) = \{ \begin{matrix}x & , & x <= y \\ y & , & x > y\end{matrix}$$

$$Max ( x , y ) = \{ \begin{matrix}x & , & x >= y \\ y & , & x < y\end{matrix}$$

$$Round ( x ) = Sign ( x ) * Floor ( Abs ( x ) + 0 \text{.5} )$$

$$Sign ( x ) = \{ \begin{matrix}1 & , & x > 0 \\ 0 & , & x == 0 \\ - 1 & , & x < 0\end{matrix}$$

Sin(x) the trigonometric sine function operating on an argument x in units of radians
Sqrt(x)=\sqrt{x}
Swap(x, y)=(y, x)
Tan(x) the trigonometric tangent function operating on an argument x in units of radians

Order of Operation Precedence:

When an order of precedence in an expression is not indicated explicitly by use of parentheses, the following rules apply:

Operations of a higher precedence are evaluated before any operation of a lower precedence.

Operations of the same precedence are evaluated sequentially from left to right.

The table below specifies the precedence of operations from highest to lowest, a higher position in the table indicates a higher precedence.

For those operators that are also used in the C programming language, the order of precedence used in this Specification is the same as used in the C programming language.

TABLE
Operation precedence from highest (at top of table) to
lowest (at bottom of table)

operations (with operands x, y, and z)
″x++″, ″− −″
″!x″, ″−x″ (as a unary prefix operator)
x^{y}
${″}^{} x * {y}^{″} {,}^{″} x / {y}^{″} {,}^{″} x \div {y}^{″} , {}^{″} {\frac{x}{y}}^{″} , {}^{″} x \% {y}^{″}$
″x + y″, ″x − y″ (as a two-argument operator),
${″}^{} {\sum }_{i = x}^{y} {f ( i )}^{″}$
″x << y″, ″x >> y″
″x < y″, ″x <= y″ ″x > y″, ″x >= y″
″x = = y″, ″x != y″
″x & y″
″x | y″
″x && y″
″x | | y″
″x ? y : z″
″x . . . y″
″x = y″, ″x += y″, ″x −= y″

Text Description of Logical Operations:

In the text, a statement of logical operations as would be described mathematically in the following form:

if(condition 0)
statement 0

else if(condition 1)
statement 1

. . .

else /* informative remark on remaining condition */statement
n May be described in the following manner:

. . . as follows / . . . the following applies:
If condition 0, statement 0
Otherwise, if condition 1, statement 1
. . .
Otherwise (informative remark on remaining condition), statement n

Each “If . . . Otherwise, if . . . Otherwise, . . . ” statement in the text is introduced with “. . . as follows” or “ . . . the following applies” immediately followed by “If . . . ”. The last condition of the “If . . . Otherwise, if . . . Otherwise, . . . ” is always an “Otherwise, . . . ”. Interleaved “If . . . Otherwise, if . . . Otherwise, . . . ” statements can be identified by matching “ . . . as follows” or “ . . . the following applies” with the ending “Otherwise, . . . ”.

In the text, a statement of logical operations as would be described mathematically in the following form:

if(condition 0a && condition 0b)
statement 0

else if(condition 1a∥condition 1b)
statement 1

. . .

else
statement n

May be described in the following manner:

. . . as follows / . . . the following applies:

If all of the following conditions are true, statement 0:
condition 0a
condition 0b

Otherwise, if one or more of the following conditions are true, statement 1:
condition 1a
condition 1b

. . .

Otherwise, statement n

In the text, a statement of logical operations as would be described mathematically in the following form:

if(condition 0)
statement 0 if(condition 1)
statement 1

May be described in the following manner:

When condition 0, statement 0

When condition 1, statement 1

Although embodiments of the disclosure have been primarily described based on video coding, it should be noted that embodiments of the coding system 10, encoder 20 and decoder 30 (and correspondingly the system 10) and the other embodiments described herein may also be configured for still picture processing or coding, i.e. the processing or coding of an individual picture independent of any preceding or consecutive picture as in video coding. In general only inter-prediction units 244 (encoder) and 344 (decoder) may not be available in case the picture processing coding is limited to a single picture 17. All other functionalities (or tools or technologies) of the video encoder 20 and video decoder 30 may equally be used for still picture processing, e.g. residual calculation 204/304, transform 206, quantization 208, inverse quantization 210/310, (inverse) transform 212/312, partitioning 262/362, intra-prediction 254/354, and/or loop filtering 220, 320, and entropy coding 270 and entropy decoding 304.

Embodiments, e.g. of the encoder 20 and the decoder 30, and functions described herein, e.g. with reference to the encoder 20 and the decoder 30, may be implemented in hardware, software, firmware, or any combination thereof. If implemented in software, the functions may be stored on a computer-readable medium or transmitted over communication media as one or more instructions or code and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limiting, such computer-readable storage media can comprise RAM, ROM, electrically erasable programmable ROM (EEPROM), compact-disc (CD) ROM (CD-ROM) or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes CD, laser disc, optical disc, DVD, floppy disk and BLU-RAY disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, ASICs, FPGAs, or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

1. A method of encoding implemented by an encoding device, the method comprising:
applying a cross component adaptive loop filter (CC-ALF) to refine a chroma component; and
generating a bitstream comprising a plurality of adaptive loop filter (ALF)-related syntax elements indicating ALF-related information,
wherein the ALF-related syntax elements are signaled at any one or more of a sequence parameter set (SPS) level, a picture header, or a slice header, and
wherein the ALF-related syntax elements comprise:
a first syntax element that is signaled at the SPS level and that indicates whether an ALF is enabled at a first sequence level; and
a second syntax element that is signaled at the SPS level and that indicates whether the CC-ALF is enabled at a second sequence level.

2. The method of claim 1, wherein when the second syntax element indicates that the CC-ALF is enabled, the ALF-related syntax elements further comprise a third syntax element that is signaled in the picture header and that indicates whether the CC-ALF is enabled for a current picture comprising a plurality of slices.

3. The method of claim 1, wherein when the second syntax element indicates that the CC-ALF is enabled, the ALF-related syntax elements further comprise a third syntax element that is signaled in the picture header and indicates whether a CC-ALF for a chroma blue-difference (Cb) color component is enabled for a current picture of a video sequence associated with the bitstream.

4. The method of claim 3, wherein the CC-ALF is enabled for the current picture when the third syntax element has a first value of 1, and wherein the CC-ALF is disabled for the current picture when the third syntax element has a second value of 0.

5. The method of claim 1, wherein when the second syntax element indicates that the CC-ALF is enabled, the ALF related syntax elements further comprise a third syntax element that is signaled in the picture header and that specifies whether a second CC-ALF for a chroma red-difference (Cr) colour component is enabled for a current picture of a video sequence associated with the bitstream.

6. A method of decoding implemented by a decoding device, wherein the method comprises:
parsing, from a bitstream, a plurality of adaptive loop filter (ALF)-related syntax elements, wherein the ALF-related syntax elements are from any one or more of a sequence parameter set (SPS) level, a picture_header, or a slice header, and wherein the ALF-related syntax elements comprise:
a first syntax element that is signaled at the SPS level and that indicates whether an ALF is enabled at a first sequence level; and
a second syntax element that is signaled at the SPS level and that indicates whether a cross component ALF (CC-ALF) is enabled at a second sequence level; and
performing a CC-ALF process using at least one of the ALF-related syntax elements.

7. The method of claim 6, wherein when the second syntax element indicates that the CC-ALF is enabled, the ALF-related syntax elements further comprise a third syntax element indicating whether the CC-ALF is enabled for a current picture comprising a plurality of slices, and wherein the method further comprises obtaining, from the picture header, the third syntax element.

8. The method of claim 6, wherein when the second syntax element indicates that the CC-ALF is enabled, the ALF-related syntax elements further comprise a third syntax element indicating whether the CC-ALF is enabled for a chroma blue-difference (Cb) color component for a current picture of a video sequence, and wherein the method further comprises obtaining, from the picture header, the third syntax element.

9. The method of claim 8, wherein the CC-ALF is enabled for the current picture when the third syntax element has a first value of 1, and wherein the CC-ALF is disabled for the current picture when the third syntax element has a second value of 0.

10. The method of claim 9, wherein when the third syntax element is enabled for the current picture, the ALF-related syntax elements further comprise a fourth syntax element indicating a parameter set that is associated with Cb colour components of all slices in the current picture, and wherein the method further comprises obtaining, from the picture header, the fourth syntax element.

11. The method of claim 6, wherein when the second syntax element indicates that the CC-ALF is enabled, the ALF related syntax elements further comprise a third syntax element specifying whether the CC-ALF is enabled for a chroma red-difference (Cr) colour component for a current picture of a video sequence associated with the bitstream, and wherein the method further comprises obtaining, from the picture header, the third syntax element.

12. The method of claim 11, wherein the CC-ALF is enabled for the current picture when the third syntax element has a first value of 1, and wherein the CC-ALF is disabled for the current picture when the third syntax element has a second value of 0.

13. The method of claim 11, wherein when the third syntax element indicates that the CC-ALF is enabled for the current picture, the ALF related syntax elements further comprise a fourth syntax element indicating a parameter set that is associated with Cr colour components of all slices in the current picture, and wherein the method further comprises obtaining, from the picture header, the fourth syntax element.

14. The method of claim 8, wherein when the third syntax element indicates that the CC-ALF is enabled for the current picture, the method further comprises obtaining a fourth syntax element, a fifth syntax element, a sixth syntax element, a seventh syntax element, an eighth syntax element, and a ninth syntax element.

15. The method of claim 6, wherein when the second syntax element indicates that the CC-ALF is enabled, the ALF-related syntax elements further comprise a third syntax element indicating whether a second CC-ALF for a chroma blue-difference (Cb) colour component is enabled for a current slice of a current picture of a video sequence associated with the bitstream, and wherein the method further comprises obtaining, from the slice header, the third syntax element.

16. The method of claim 6, further comprising:
obtaining the second syntax element when the first syntax element has a first value; and
conditionally obtaining, based on a second value of the first syntax element, the second syntax element.

17. A device for encoding video data comprising:
a video data memory configured to store instructions; and
a video encoder coupled to the video data memory, wherein the instructions cause the video encoder to be configured to:
apply a cross component adaptive loop filter (CC-ALF) to refine a chroma component; and
generate a bitstream including a plurality of adaptive loop filter (ALF) related syntax elements indicating ALF-related information, and wherein the ALF-related syntax elements are signaled at any one or more of a sequence parameter set (SPS) level, a picture header, or a slice header and comprise:
a first syntax element that is signaled at the SPS level and that indicates whether an ALF is enabled at a first sequence level; and
a second syntax element that is signaled at the SPS level and that indicates whether the CC-ALF is enabled at a second sequence level.

18. A device for decoding video data comprising:
a video data memory configured to store instructions; and
a video decoder coupled to the video data memory, wherein the instructions cause the video decoder to be configured to:
parse, from a bitstream, a plurality of adaptive loop filter (ALF)-related syntax elements, wherein the ALF-related syntax elements are from any one or more of a sequence parameter set (SPS) level, a picture_header, or a slice header, and wherein the ALF-related syntax elements comprise:
a first syntax element that is signaled at the SPS level and that indicates whether an ALF is enabled at a first sequence level; and
a second syntax element that is signaled at the SPS level and that indicates whether a cross component adaptive loop filter (CC-ALF) is enabled at a second sequence level; and
perform a CC-ALF process using at least one of the ALF-related syntax elements.

19. A computer program product comprising computer-executable instructions that are stored on a non-transitory computer-readable storage medium and that, when executed by a processor, cause a computing device to:
parse, from a bitstream, a plurality of adaptive loop filter (ALF) related syntax elements, wherein the ALF-related syntax elements are from any one or more of a sequence parameter set (SPS) level, a picture_header, or a slice header, and wherein the ALF-related syntax elements comprise:
a first syntax element that is signaled at the SPS level and that indicates whether an ALF is enabled at a first sequence level; and
a second syntax element that is signaled at the SPS level and that indicates whether a cross component ALF (CC-ALF) is enabled at a second sequence level; and perform a CC-ALF process using at least one of the ALF-related syntax elements.

20. A computer program product comprising computer-executable instructions that are stored on a non-transitory computer-readable medium and that, when executed by a processor, cause an apparatus to:
apply a cross component adaptive loop filter (CC-ALF) to refine a chroma component; and
generate a bitstream comprising a plurality of adaptive loop filter (ALF) related syntax elements indicating ALF-related information,
wherein the ALF-related syntax elements are signaled at any one or more of a sequence parameter set (SPS) level, a picture header, or a slice header, and
wherein the ALF-related syntax elements comprise:
a first syntax element that is signaled at the SPS level and that indicates whether an ALF is enabled at a first sequence level; and
a second syntax element that is signaled at the SPS level and that indicates whether the CC-ALF is enabled at a second sequence level.
